(19) United States
(12) Patent Application Publication
(10) Pub. No.: US 2026/0036719 A1
(43) Pub. Date: Feb. 5, 2026

(54) REFLECTIVE POLARIZER BONDED LENS, HEAD-MOUNTED DISPLAY, AND METHOD FOR PRODUCING REFLECTIVE POLARIZER BONDED LENS

(71) Applicant: ASAHI KASEI KABUSHIKI KAISHA, Tokyo (JP)

(72) Inventors: Akito NAKAI, Tokyo (JP); Yutaka TADA, Tokyo (JP); Yuta YAMAHATA, Tokyo (JP); Masaharu SUGIMURA, Tokyo (JP)

(73) Assignee: ASAHI KASEI KABUSHIKI KAISHA, Tokyo (JP)

(21) Appl. No.: 19/283,248

(22) Filed: Jul. 29, 2025

(30) Foreign Application Priority Data
Jul. 31, 2024 (JP) 2024-125188

(51) Int. Cl. G02B 1/08; G02B 27/01; G02B 27/28

(52) U.S. Cl. CPC G02B 1/08; G02B 27/0172; G02B 27/288

(57) ABSTRACT

This disclosure is directed to providing a reflective polarizer bonded lens and head-mounted display including the same, in which at least one of delamination and cracking of the reflective polarizer is suppressed even after a reliability test under a severe high temperature and humidity condition. The solution is a reflective polarizer bonded lens including a resin lens having first and second surfaces on opposite sides; a reflective polarizer bonded to at least one of the first surface and the second surface; an adhesive layer between the resin lens and the reflective polarizer; and a silane coupling reagent layer provided at least one of between the resin lens and the adhesive layer, and between the adhesive layer and the reflective polarizer. The glass transition temperature (Tg) of the resin composition forming the resin lens is 115° C. to 160° C.

### TECHNICAL FIELD

The present disclosure relates to a reflective polarizer bonded lens, a head-mounted display including the same, and a method for producing a reflective polarizer bonded lens.

### BACKGROUND

In recent years, the development of devices for virtual reality (hereinafter referred to as “VR”) and augmented reality (hereinafter referred to as “AR”) has been actively pursued. Specifically, examples of VR head-mounted displays include devices that display images generated by a computer or captured by a stereo camera, from displays for each eye arranged near the eyes, and use a magnifying optical system disposed between the displays and the eyes so that the images near the field of view are magnified beyond that of the human eye, allowing the user to feel as if they are present within the visual space. Similarly, in AR head-mounted displays, an image is introduced into a transparent waveguide using mirrors, diffraction lattices, or holographic elements, then guided by total internal reflection, and finally output toward the eyes of the user by disrupting the total internal reflection using mirrors, diffraction lattices, or holographic elements arranged accordingly. In such devices, the real world can be viewed through the transparent waveguide (see-through), while image light is superimposed on the real world by the optical system and can be observed.

These devices are required to be comfortable to wear for the observer without causing discomfort during image viewing, and there is a demand for reducing the overall weight, size, and thickness of the device while providing highly immersive image displays.

In particular, to enhance the sense of immersion, especially in the case of VR head-mounted displays, the field of view of the image is important. The magnifying optical system is required to be thin and have a strong magnification so that the device does not become bulky, while expanding the image to near the field of view of the user.

As such an optical system, for example, an eyepiece optical system using polarization to fold the optical path has been proposed, as disclosed in PTLs 1 to 3.

A basic configuration of such an eyepiece optical system is illustrated in FIG. 1 as a conceptual diagram. The eyepiece optical system has the configuration including an image display device 11, a circular polarizer 12 (for example, a bond of a linear polarizing plate and a quarter-wave plate), a half mirror 13, a lens 14, a quarter-wave plate 15, and a reflective polarizer 16 that has a polarization-separating function (e.g., an optical element that reflects an S-wave perpendicular to the incident plane and transmits a P-wave parallel to the incident plane), arranged from the left side in FIG. 1. Here, light emitted from the image display device 11 is converted into circular polarized light (e.g., left-handed circular polarized light when viewed in the direction of propagation of light) by the circular polarizer 12 and passes through the half mirror 13. After passing through the lens 14, a quarter wave phase difference is imparted to the light by the quarter-wave plate 15, converting it into linearly polarized light. At this time, by aligning the transmission axis of the reflective polarizer 16 perpendicular to the axis of this linearly polarized light, the light is reflected by the reflective polarizer 16 and proceeds backward along the optical path. It is then converted again into circular polarized light (e.g., left-handed circular polarized light when viewed in the direction of propagation) by the quarter-wave plate 15. It passes through the lens, is reflected again by the half mirror (e.g., converted into right-handed circular polarized light when viewed in the direction of propagation), and after passing through the lens for the third time, it is converted into linearly polarized light by the quarter-wave plate. At this point, the polarization axis is aligned to transmit through the reflective optical element, and the user visually perceives the image as a virtual image after the light passes through the reflective polarizer 16. By adopting such a configuration (hereinafter referred to as the “pancake lens configuration”), the optical system becomes a folded optical path system, enabling increased magnification by the lens and allowing the application of a thin optical system to the head-mounted display.

### CITATION LIST

### Patent Literature

PTL 1: U.S. Pat. No. 6,563,638 A
PTL 2: JP 6386210 B
PTL 3: JP 2020-85956 A
PTL 4: U.S. Pat. No. 10,409,067 A
PTL 5: JP 2021-92767 A
PTL 6: JP H10-10465 A
PTL 7: JP 2020-95205 A
PTL 8: JP 2024-4491 A

### SUMMARY

In this optical system, however, the light passes through the lens three times, which triples the effect of the birefringence of the lens and makes it more difficult to precisely control the polarization axis. In this case, light that should be linearly polarized becomes elliptically polarized due to phase differences, resulting in phenomena such as ghosting and/or flare when images that should be reflected by the reflective polarizer are transmitted. Furthermore, after undergoing two reflections, light that is originally intended to be transmitted may be reflected again, which can lead to reduced contrast and other problems. Therefore, such defects are problematic.

In particular, when resin lenses are used instead of glass to reduce the weight of head-mounted displays, it has been demonstrated (for example, in PTLs 3 and 5) that orientation birefringence caused by the alignment of the main chain during injection molding of the resin, and photoelastic effects caused by residual internal stress or externally applied stress, rotate the polarization axis of the image light, leading to significant problems such as ghosting, flare, and a decrease in contrast.

Accordingly, in order to suppress such problems, the development of low-birefringence resins has been demanded. PTLs 4 to 6 report that low-birefringence resins in which both orientation birefringence and photoelasticity are extremely reduced by strictly controlling the monomer composition ratio are suitable as lens materials for head-mounted displays.

By using such resins, ghosting and flare, as well as contrast degradation, can be suppressed, and correction of monochromatic and chromatic aberrations in virtual images can be achieved by combining multiple lenses. In particular, by using aspheric lenses, which are difficult to manufacture from glass, monochromatic aberrations of virtual images can be efficiently corrected. For example, the effectiveness of aspheric lenses in aberration correction is exemplified in PTL 7.

Moreover, in order to improve the magnification of the optical system and suppress contrast degradation and ghosting caused by reflections at the air interface, it is effective for both the retardation plate and the reflective optical element to be bonded onto the lens surface.

When manufacturing a reflective polarizer bonded lens using a resin, the resin substrate and the polarization separation film are often bonded using an adhesive. Reflective polarizer bonded lenses are superior to glass lenses in terms of reducing the weight of image display devices, but they have the drawback of high water absorption. Under high-temperature and high-humidity environments, the resin substrate and polarization separation film may deform due to moisture absorption, and differences in dimensional changes during absorption may cause delamination at the interface of the adhesive layer. Reflective polarizer bonded lenses that have undergone such delamination suffer from a significant decrease in optical performance (such as polarization separation ability and transmittance).

Furthermore, in order to improve the magnification of the optical system and suppress contrast degradation and ghosting caused by reflections at the air interface, it is effective for both the retardation plate and the reflective optical element to be bonded onto the lens surface.

PTL 8 reports that by using a resin lens composed of a thermoplastic resin that has sufficiently high heat resistance, a small photoelastic coefficient, and includes aryl groups (functional or substituent groups derived from aromatic hydrocarbons) or alicyclic groups in the main or side chain, and by bonding a reflective optical element onto a surface that is planar or convex in a region including the optical axis of the lens, it is possible to control the ratio Tp530/Tc530≥150, where Tp530 is the transmittance of light parallel to the transmission axis of the reflective polarizer and Tc530 is the transmittance of light perpendicular to the transmission axis, when light parallel to the optical axis of the lens is incident. This enables the resolution of issues such as flare, ghosting, and contrast degradation even in pancake lens configurations. However, it has been reported that in lamination to lenses with high curvature, after reliability tests (under the environment of 60° C. and 90% RH for 500 hours) or cold heat cycle tests are conducted, delamination of the reflective polarizer, whitening of delaminated areas, wrinkling, and bubbles of the reflective polarizer were observed.

The present disclosure has been made in view of the aforementioned problem, and it is directed to providing a reflective polarizer bonded lens and a head-mounted display including the same, in which at least one delamination or cracking of the reflective polarizer is suppressed even after a reliability test under a severe high-temperature and high-humidity environment.

Furthermore, the present disclosure is directed to providing a method for producing a reflective polarizer bonded lens in which at least one delamination or cracking of the reflective polarizer is suppressed even after a reliability test under a severe high-temperature and high-humidity environment. As a result of diligent research, the inventors have completed the following invention.

Specifically, the present disclosure is as follows.

[1] A reflective polarizer bonded lens comprising:
a resin lens having a first surface and a second surface on opposite sides;
a reflective polarizer bonded to at least one of the first surface and the second surface;
an adhesive layer provided between the resin lens and the reflective polarizer; and
a silane coupling reagent layer provided at least one of between the resin lens and the adhesive layer, and between the adhesive layer and the reflective polarizer,
wherein a glass transition temperature (Tg) of the resin composition that forms the resin lens is 115° C. to 160° C.

[2] The reflective polarizer bonded lens according to [1], wherein the resin lens has an absolute value of a photoelastic coefficient of 10× 10-12 Pa⁻¹ or less.

[3] The reflective polarizer bonded lens according to [1] or [2], wherein the resin lens is made of a thermoplastic resin composition having an aryl group or an alicyclic group in a main chain or side chain thereof.

[4]

The reflective polarizer bonded lens according to any one of [1] to [3], wherein the surface at which the resin lens and the reflective polarizer are bonded is a convex or concave surface in a region including an optical axis, and an absolute value of a reference radius of curvature R is 10 mm or more and 500 mm or less.

[5] The reflective polarizer bonded lens according to any one of [1] to [4], wherein the resin composition includes a methacrylic resin.

[6] The reflective polarizer bonded lens according to [5], wherein the methacrylic resin includes a methacrylic resin having a structural unit with a cyclic structure.

[7] The reflective polarizer bonded lens according to [6], wherein the structural unit includes at least one structural unit selected from the group consisting of a structural unit derived from an N-substituted maleimide monomer, a glutarimide-based structural unit, an aromatic vinyl structural unit, an alicyclic vinyl structural unit, and a lactone ring structural unit.

[8] The reflective polarizer bonded lens according to [7], wherein the structural unit includes a structural unit derived from an N-substituted maleimide monomer.

[9] The reflective polarizer bonded lens according to any one of [1] to [4], wherein the resin lens is made of a resin composition including a cyclic olefin copolymer that is a copolymer of ethylene or an α-olefin and a cyclic olefin.

[10] The reflective polarizer bonded lens according to [9], wherein a proportion of the ring skeleton structural unit derived from the cyclic olefin in the main chain of the cyclic olefin copolymer is 36 mol % or more and 50 mol % or less.

[11] The reflective polarizer bonded lens according to [9] or [10], wherein the structural unit derived from the cyclic olefin in the cyclic olefin copolymer is a structural unit derived from at least one compound selected from bicyclo[2.2.1]-2-heptene and tetracyclo[4.4.0.1^{2,5}.1^{7,10}]-3-dodecene.

[12] The reflective polarizer bonded lens according to any one of [1] to [4], wherein the resin lens is made of a resin composition including a hydrogenated product of a ring-opening polymer of a norbornene-based monomer.

[13] The reflective polarizer bonded lens according to [12], wherein the resin composition including the hydrogenated product of the ring-opening polymer of the norbornene-based monomer contains 20 to 100 mol % of structural units derived from the norbornene-based monomer, and optionally, 0 to 80 mol % of structural units derived from another monomer copolymerizable with the norbornene-based monomer.

[14] The reflective polarizer bonded lens according to [13], wherein the structural units derived from the norbornene-based monomer include 15 to 50 wt % of structural units derived from a tetracyclododecene-based monomer, 50 to 90 wt % of structural units derived from a methanotetrahydrofluorene-based monomer, and 1 to 15 wt % of structural units derived from a norbornene monomer, provided that a sum of the structural units derived from each monomer is 100 wt % or less.

[15] The reflective polarizer bonded lens according to any one of [1] to [14], wherein the resin composition that forms the resin lens has a flexural strength of 65 MPa or more.

[16] The reflective polarizer bonded lens according to any one of [1] to [15], wherein the reflective polarizer has only one reflective surface that contributes to polarization separation.

[17] The reflective polarizer bonded lens according to any one of [1] to [16], wherein the adhesive layer is an adhesive layer made of an adhering agent that contains no silane coupling reagent.

[18] A head-mounted display comprising the reflective polarizer bonded lens according to any one of [1] to [17].

[19] A method for producing a reflective polarizer bonded lens in which a reflective polarizer is bonded to a resin lens,
the resin lens being a resin lens made of a resin composition having a glass transition temperature (Tg) of 115° C. to 160° C.,
the resin lens having a first surface and a second surface on opposite sides, the method comprising:
forming a silane coupling reagent layer on at least one of the resin lens and the reflective polarizer;
providing an adhesive layer on at least one of the resin lens and the reflective polarizer; and
bonding the reflective polarizer to the resin lens.

[20] The method for producing a reflective polarizer bonded lens according to [19], wherein resin lens is produced by injection molding.

[21] The method for producing a reflective polarizer bonded lens according to [19] or [20], wherein the bonding the reflective polarizer to the resin lens is performed, based on a glass transition temperature (Tg_{film}) of a substrate film forming the reflective polarizer, at a temperature from Tg_{film}−40° C. to Tg_{film}+120° C.

According to the present disclosure, it is possible to provide a reflective polarizer bonded lens and a head-mounted display including the same, in which at least one delamination or cracking of the reflective polarizer is suppressed even after a reliability test under a severe high-temperature and high-humidity environment.

According to the present disclosure, it is possible to provide a method for producing a reflective polarizer bonded lens in which at least one delamination or cracking of the reflective polarizer is suppressed even after a reliability test under a severe high-temperature and high-humidity environment.

### BRIEF DESCRIPTION OF THE DRAWINGS

In the accompanying drawings:

FIG. 1 is a conceptual diagram of an optical system having a pancake lens configuration;

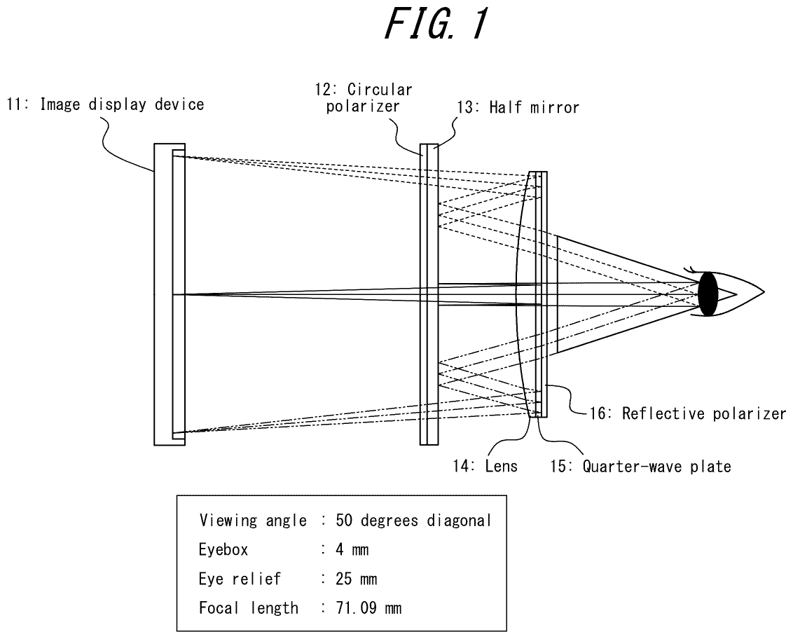

FIG. 2 is a schematic diagram of a reflective polarizer bonded lens;

FIG. 3 is a partial cross-sectional conceptual diagram of a wire grid polarizing plate used as a reflective polarizer;

FIG. 4 is a conceptual diagram illustrating an outline of an experimental apparatus for evaluating the occurrence of double images and flare in an image, using an optical system with a pancake lens configuration that employs the reflective polarizer bonded lens of the present disclosure; and

FIG. 5 illustrates a modified example of the experiment illustrated in FIG. 4 and illustrates a method of displaying an image during contrast evaluation.

### DETAILED DESCRIPTION

The following provides a detailed description of an embodiment of the present disclosure (hereinafter, referred to as “present embodiment”). However, the present disclosure is not limited by the description given below, and may be implemented with various changes or modifications that are within the essential scope thereof.

### <Reflective Polarizer Bonded Lens>

The reflective polarizer bonded lens of the present embodiment includes:
a resin lens having a first surface and a second surface on opposite sides;
a reflective polarizer bonded to at least one of the first surface and the second surface;
an adhesive layer provided between the resin lens and the reflective polarizer; and
a silane coupling reagent layer provided at least one of between the resin lens and the adhesive layer, and between the adhesive layer and the reflective polarizer,
wherein the glass transition temperature (Tg) of the resin composition that forms the resin lens is 115° C. to 160° C.

In the above reflective polarizer bonded lens, at least one of delamination and cracking of the reflective polarizer is suppressed even after a reliability test under a severe high-temperature and high-humidity environment.

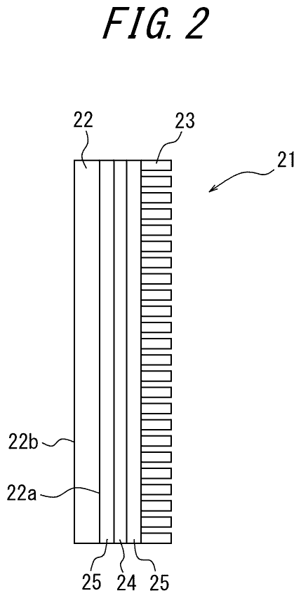

The reflective polarizer bonded lens 21 of the present embodiment will be described with reference to FIG. 2. In FIG. 2, the reflective polarizer bonded lens 21 is configured such that a reflective polarizer 23 is bonded to a first surface 22a of a resin lens 22 having the first surface 22a and a second surface 22b on opposite sides. An adhesive layer 24 is provided between the resin lens 22 and the reflective polarizer 23. In addition, silane coupling reagent layers 25 are provided between the resin lens 22 and the adhesive layer 24, and between the adhesive layer 24 and the reflective polarizer 23.

It should be noted that the reflective polarizer 23 is bonded to the first surface 22a of the resin lens 22 in FIG. 2, but the reflective polarizer 23 may alternatively be bonded to the second surface 22b of the resin lens 22. Also, silane coupling reagent layers 25 are provided both between the resin lens 22 and the adhesive layer 24 and between the adhesive layer 24 and the reflective polarizer 23 in FIG. 2. However, the silane coupling reagent layer 25 may be provided only between the resin lens 22 and the adhesive layer 24, or only between the adhesive layer 24 and the reflective polarizer 23. Furthermore, for the same of simplification, the surface shape of the resin lens 22 is illustrated as a flat surface. However, the surface of the resin lens 22 may be a convex or concave surface.

The reflective polarizer bonded lens of the present embodiment may be a reflective polarizer bonded lens including, in addition to the above-described reflective polarizer and resin lens, other members such as functional coating layers (e.g., a waveplate, retardation coating, half mirror, antireflection coating, etc.). The number of the above-described other members may be one or more than one.

In the reflective polarizer bonded lens of the present embodiment, one or more transparent layers may be disposed between the resin lens and the silane coupling reagent layer and/or between the adhesive layer and the silane coupling reagent layer. That is, the structure may have a configuration of resin lens/transparent layer/silane coupling reagent layer and/or adhesive layer/transparent layer/silane coupling reagent layer.

Examples of the transparent layer include, for instance, a hard coat layer and an anchor coat layer. The thickness of these transparent layers is not particularly limited, but may be, for example, in the range of 0.01 to 10 μm.

In the reflective polarizer bonded lens of the present embodiment, when the reflective polarizer is bonded only to one side of the resin lens, it is also possible to form a functional layer (such as a hard coat layer, anti-glare layer, or anti-reflection layer) by further performing surface functionalization treatments such as a hard coat treatment, anti-reflection treatment, transparent conductive treatment, electromagnetic shielding treatment, and gas barrier treatment on the surface of the resin lens opposite to the bonded surface. The thickness of these functional layers is not particularly limited but may be in the range of 0.01 to 10 μm, for example.

The hard coat layer provided to the surface of the reflective polarizer bonded lens can be formed by applying a coating solution in which silicone-based curable resin, organic polymer composite inorganic fine particle-containing curable resin, an acrylate, such as a urethane acrylate, epoxy acrylate, and multifunctional acrylate, and a photopolymerization initiator are dissolved or dispersed in an organic solvent, onto the resin lens of the reflective polarizer bonded lens of the present embodiment using a conventionally known coating method, drying, and then curing it by light.

Furthermore, before application of a hard coating layer, a method for improving the adhesiveness may also be used in which an easy adhesion layer, a primer layer, an anchor layer, or the like, containing inorganic fine particles is applied, followed by formation of the hard coating layer, for example.

The anti-glare layer provided to the surface of the reflective polarizer bonded lens can be formed by inking fine particles such as silica, melamine resin, or acrylic resin, applying it onto another functional layer using a conventionally known coating method, and curing it thermally or by light.

Examples of the anti-reflection layer to be applied on the surface of the reflective polarizer bonded lens include a thin film of an inorganic substance such as a metal oxide, a fluoride, a silicide, a boride, a nitride, and a sulfide; and a single layer or a stack of multiple layers of resins having different refractive indices such as an acrylic resin and a fluororesin. Alternatively, a stack of thin layers including composite fine particles of an inorganic compound and an organic compound can also be used.

A mirror or half-mirror (such as a semi-transparent reflective surface having a ratio of the reflectance to the transmittance of other than 50:50, e.g, a transmittance of 15% and a reflectance of 85%, for example) may also be provided on the surface of the resin lens. Any suitable method can be used, but for example, it can be formed by coating a thin layer of a metal (such as silver or aluminum) onto the resin lens. When coating a thin metal layer, since light absorption by the metal occurs, another method such as forming a mirror by depositing a thin dielectric coating on the surface of the resin lens may also be used. Additionally, methods of coating a metal and coating a dielectric material can be combined.

The reflectance and transmittance of light can be controlled by the thickness and/or number of layers of the coating layer, and in methods using dielectric deposition, it is also possible to design the coating to reflect only light of a specific wavelength.

The reflective polarizer bonded lens of the present embodiment is, but not limited to, preferably used in image display devices having an eyepiece optical system that guides light from an image display element toward the eyes of the observer.

### —Appearance—

The reflective polarizer bonded lens of the present embodiment preferably has no wrinkles visible in appearance and no bubbles or delaminated portions present at the bonding interface (e.g., the interface between the reflective polarizer and the lens). The presence of such defective parts may cause defects during image viewing.

—Appearance after Reliability Test—

The reflective polarizer bonded lens of the present embodiment preferably has no wrinkles visible in appearance after a reliability test, and defects such as bubble inclusion or whitening due to delamination at the interface between the reflective polarizer and the resin lens do not occur. The appearance after a reliability test can be evaluated by the method in the examples described later.

### [Resin Lens]

The reflective polarizer bonded lens of the present embodiment includes a resin lens having a first surface and a second surface on opposite sides.

The resin lens used in the reflective polarizer bonded lens of the present embodiment (hereinafter sometimes simply referred to as “resin lens”) is preferably made of a thermoplastic resin composition having an aryl group or an alicyclic group in the main chain or side chain.

### —Resin Composition—

While appropriate forms of the resin composition that forms the resin lens will be described later, the resin composition preferably contains a resin including at least one of the polar groups selected from the group consisting of carbonyl groups, sulfonyl groups, amino groups, and hydroxyl groups. By including a resin containing such polar groups in the resin composition, delamination is less likely to occur after the reflective polarizer is bonded, thereby ensuring strong adhesion.

### —Shape—

The shape of the resin lens is not particularly limited. It is preferable that the surface of the resin lens on which the reflective polarizer is bonded is a flat surface or a convex or concave surface in a region including the optical axis within the effective diameter. As long as the reflective polarizer can be bonded well without wrinkles or bubbles, the surface may also have protrusions or recesses for fixing to a housing.

The lens shape may be spherical, aspherical, or a free-form surface, as long as it falls within the effective diameter. The lens shape may also be cylindrical, forming a curved surface only in one axis.

### —Dimensions—

The size of the resin lens is not particularly limited. However, from the viewpoint of ease of handling during the bonding process, it is preferable that the size of the resin lens is Φ10 mm to Φ100 mm. The size of the resin lens is more preferably Φ20 mm to Φ80 mm, and even more preferably ¢25 mm to −60 mm.

### Radius of Curvature—

The shape of the surface of the resin lens, to which the reflective polarizer is bonded, within the effective diameter can be expressed using the radius of curvature R (unit: mm). The resin lens having a first surface and a second surface on opposite sides, each defined with a radius of curvature R. When drawing a circle with a radius of curvature R from the curvature center located outside the lens, the circumference of the circle partially defines the lens surface shape. At this time, the line connecting the curvature center of the first surface and the curvature center of the second surface is defined as the optical axis of the lens. If the curvature radius is defined such that the first surface side of the optical axis is negative and the second surface side is positive, then when the first surface has a convex shape on the first surface side or the second surface has a concave shape on the second surface side, the radius of curvature is expressed as a positive number, and when the first surface has a concave shape on the first surface side or the second surface has a convex shape on the second surface side, the radius of curvature is expressed as a negative number. In the present disclosure, the radius of curvature R defining the lens shape is not particularly limited. Except in cases where the bonding surface is flat (absolute value of radius of curvature R=infinite), the absolute value of the radius of curvature R is preferably 10 mm or more and 500 mm or less. More preferably, the absolute value of the radius of curvature R is 20 mm or more and 300 mm or less, particularly preferably 30 mm or more and 200 mm or less, and most preferably 40 mm or more and 100 mm or less. By adopting a shape within this range, it becomes possible to bond the reflective polarizer well without defects such as wrinkles or bubbles, with a high yield.

In the reflective polarizer bonded lens of the present embodiment, it is particularly preferable that the bonding surface between the resin lens and the reflective polarizer is a convex or concave surface in a region including the optical axis and that the absolute value of the reference radius of curvature R is 10 mm or more and 500 mm or less.

It is preferable that the lens shape excludes regions such as lens flanges or molded parts for degassing or handling that are not expressed by the curvature radius. Regions where curvature changes drastically (such as points where the second derivative of the curve representing the lens shape is zero) should be avoided because they are prone to bubble inclusion during bonding of the reflective polarizer and are likely to cause delamination during a reliability test.

Further, when considering the intended use of the present embodiment as a pancake lens, it is preferable that the absolute value of the radius of curvature of the surface of the resin lens, to which the reflective polarizer is bonded, is small in order to increase magnification. The absolute value of the radius of curvature is preferably, for example, 100 mm or less. However, if the absolute value of the radius of curvature is too small, bonding of the reflective polarizer becomes difficult, and correction of aberrations in the optical system also becomes difficult; thus, it is preferable to design it appropriately considering the balance.

When the surface of the resin lens, to which the reflective polarizer is bonded, is flat, it is effective for avoiding undesired stress on the reflective polarizer bonded to the resin lens and other elements such as a quarter wave plate (quarter wave film) that gives a quarter phase difference for a specific wavelength and a coating that gives a quarter phase difference when used together.

When the surface of the resin lens, to which the reflective polarizer is bonded, is aspherical, the surface shape can be a rotationally symmetric aspherical surface in which the sag amount z of the surface follows the following formula I:

$$z = \frac{{cr}^{2}}{1 + \sqrt{1 - ( 1 + k ) {c}^{2} {r}^{2}}} + {Dr}^{4} + {Er}^{6} + {Fr}^{8} + {Gr}^{10} + {Hr}^{12} + {Ir}^{14} + … \qquad ( formula I )$$

in the formula I, c, k, D, E, F, G, H, and I are constants, z (unit: mm) is the distance from the vertex of the surface (in the direction parallel to the optical axis), and r (unit: mm) represents the distance in the radial direction from the vertex. The parameter k is referred to as the conic constant. Also, c is the reciprocal 1/R (unit: mm⁻¹) of the reference radius of curvature R.

—Phase Difference within Effective Diameter—

The resin lens, as a resin lens alone, preferably has an average absolute value of the phase difference within the effective diameter of 10 nm or less, more preferably 7 nm or less, and even more preferably 5 nm or less. By bonding such a resin lens to the reflective polarizer, it is possible to view clear and high-resolution images without ghosting (double images), flare, reduction in contrast, or the like.

Here, the effective diameter of the resin lens refers to the area where the image can be viewed when the lens is incorporated into the housing of a head-mounted display, and is represented as the diameter of a circle centered on the optical axis of the lens. Therefore, parts such as flanges for assembly into the housing are excluded. When the viewable area of images is not a perfect circle, the minor axis is regarded as the effective diameter. If there is no clearly defined effective diameter, the area excluding parts such as flanges that do not correspond to the lens surface and including 80% or more of the projected area of the lens is regarded as the effective area. The projected area refers to the area (i.e., parallel projected area) of the shape of the entire or partial region of the resin lens projected onto a horizontal plane when the resin lens is placed statically on a horizontal plane and irradiated with parallel light rays from a point at infinity directly above in the vertical direction (gravity direction). The phase difference within the effective diameter of the resin lens can specifically be measured by the method described in the Examples below.

The method of obtaining such a resin lens can involve applying the preferred resin composition and preferred molding conditions described later to obtain a resin lens within the above range. Additionally, other methods include cutting off the surrounding region near the large gate where the birefringence of the resin lens is significant, and performing manufacturing using a molded article obtained by solidifying a monomer poured into a mold through photo-curing or thermal curing reactions. However, the method of cutting the region around the gate is not preferable because it narrows the range of adjustment during optical system assembly. For example, it becomes difficult to adjust the alignment when bonding the lens under strict control so that the polarization transmission axis of the reflective polarizer is aligned at a predetermined position. Furthermore, the method of producing a lens through curing reactions has difficulty in achieving shape precision, and from an economic perspective, it has the drawback of a long cycle time required to obtain a single lens.

### —Glass Transition Temperature—

It is preferable that the resin lens has a glass transition temperature (Tg) of 115° C. or higher and 160° C. or lower.

Having a glass transition temperature of 115° C. or higher ensures heat resistance against heat generated by the electronic devices in the head-mounted display and also provides favorable adhesion properties in processes where heat is applied during bonding with the reflective polarizer, without causing dimensional changes. In addition, if the heat resistance temperature is low, the amount of dimensional change under high temperature conditions becomes large, and thus the glass transition temperature of 115° C. or higher is preferable also from the viewpoint of suppressing photoelastic birefringence caused by tension at the bonding interface due to the difference in dimensional change between the bonded optical element film and the resin lens. The glass transition temperature (Tg) is more preferably 120° C. or higher, even more preferably 125° C. or higher, and most preferably 130° C. or higher.

On the other hand, when the glass transition temperature (Tg) is 160° C. or lower, melt processing at an extremely high temperatures can be avoided to thereby reduce thermal decomposition of the resin or the like, enabling the provision of favorable products. The glass transition temperature (Tg) is more preferably 155° C. or lower, even more preferably 150° C. or lower, and further preferably 140° C. or lower from the viewpoint of achieving the effects described above more reliably.

Note that the glass transition temperature (Tg) can be determined by making measurements in accordance with JIS K 7121. Specifically, it can be measured with the method in the examples described later.

The glass transition temperature of the above resin lens can be adjusted within the above range by producing a molded article from the preferred resin composition described later in the present disclosure, and the glass transition temperature can be increased by incorporating a cyclic structure into the main chain of the resin composition.

### —Photoelastic Coefficient CR—

The absolute value |CR| of the photoelastic coefficient CR of the resin lens is preferably 10.0×10⁻¹² Pa⁻¹ or less, more preferably 5.0×10⁻¹² Pa⁻¹ or less, further preferably 3.0×10⁻¹² Pa⁻¹ or less, and particularly preferably 1.0×10⁻¹² Pa⁻¹ or less.

The photoelastic coefficient is described in various documents (see, for example, Review of Chemistry, No. 39, 1998 (published by Publishing Center of the Chemical Society of Japan)), and can be defined by the following formulae (i-a) and (i-b). The closer the value of the photoelastic coefficient CR to zero, the smaller the change in birefringence caused by external force becomes.

$$CR = \vert Δ n \vert / σ R \qquad ( i - a )$$

$$\vert Δ n \vert = \vert nx - ny \vert \qquad ( i - b )$$

In the formulas, CR is the photoelastic coefficient; σR is the tensile stress; |Δn| is the absolute value of the birefringence; nx is the refractive index in the tensile direction; and ny is the refractive index in a direction in the plane orthogonal to the tensile direction.

If the absolute value |CR| of the photoelastic coefficient CR of the resin lens is 10.0×10⁻¹² Pa⁻¹ or less, the photoelastic birefringence caused by dimensional changes due to stresses occurring during lens fixation or environmental changes such as temperature can be sufficiently small, and a resin lens that provides a clear image can be obtained. Moreover, if the absolute value |CR| of the photoelastic coefficient is large, when a reflective polarizer is used in a bonded lens, differences in expansion and contraction between the resin lens and the reflective polarizer due to environmental changes such as temperature and humidity occur, which in turn causes internal stress and birefringence. As mentioned above, birefringence leads to ghosting and contrast deterioration, which are undesirable.

Note that the photoelastic coefficient CR is measured by cutting the resin lens and processing it into a pressed film using a vacuum compression molding machine. Specifically, it can be determined by the method in the examples described later.

The absolute value of the photoelastic coefficient of the above molded article can be adjusted within the above range by producing a molded article from the preferred resin composition described later in the present disclosure. It is preferable to appropriately adjust the copolymer composition ratio of a monomer having a positive photoelastic coefficient and a monomer having a negative photoelastic coefficient when producing a homopolymer. Although it is also possible to relieve stress strain by annealing, for sufficiently relieving the stress, it is necessary to perform heat treatment from the temperature of Tg−25° C. to near Tg, and the surface shape may change in this process, resulting in defocusing, etc., which is not preferable. Therefore, it is preferable to mold a lens from a resin composition with a small photoelastic coefficient.

—Difference in Saturated Water Absorption Rate between Resin Lens and Reflective Polarizer—

Moreover, when the transparent substrate forming the reflective polarizer has a high saturated water absorption rate, it is preferable to use a resin composition forming the resin lens that also has a high saturated water absorption rate. The absolute value of the difference between water absorption rate (resin lens) and water absorption rate (reflective polarizer) is preferably within the range of 0.1% to 3.0%, more preferably 0.1% to 2.0%, further preferably 0.1% to 1.5%, and particularly preferably 0.1% to 1.0%, where the saturated water absorption rate of the resin composition that forms the resin lens is defined as water absorption rate (resin lens) and the saturated water absorption rate of the transparent substrate forming the reflective polarizer is defined as water absorption rate (reflective polarizer). By forming the reflective polarizer bonded lens of the present disclosure with a combination within this range, defects such as delamination at the bonded surface due to differences in expansion rates caused by water absorption in high-temperature, high-humidity tests can be suppressed.

### [Reflective Polarizer]

As the reflective polarizer to be bonded to the reflective polarizer bonded lens of the present embodiment, an element having a polarization beam splitter (PBS) function, which is a polarization splitting mirror, can be used. As the reflective polarizer in the present embodiment, for example, a polarizer formed by bonding thin films with different birefringence, a wire grid polarizer of a structural birefringence type using a sub-wavelength structure, or an element composed of cholesteric liquid crystal that separates right circular and left circular polarized light can be used. Industrial examples of a reflective polarizer formed by laminating thin films with different birefringence (hereinafter also referred to as laminated-type reflective polarizer) include multilayer birefringent films such as APF, IQP-S, IQP-E, and DBEF manufactured by 3M Corporation. As wire grid polarizers, wire grid reflective polarizers (WGF®, WGF is a registered trademark in Japan, other countries, or both) manufactured by Asahi Kasei Corporation and ProFlux PPL02 (manufactured by Moxtek Inc.) can be used. As elements composed of cholesteric liquid crystals, NIPOCS APCF (manufactured by Nitto Denko Corporation), etc., can be used.

Among reflective polarizers, the wire grid reflective polarizer (WGF® manufactured by Asahi Kasei Corporation) or IQP-E (manufactured by 3M Corporation) is preferable. Although the bonding process to curved surfaces is described later, WGF is particularly preferable because it has a function of polarization separation that does not rely on stretching. These are less prone to degradation in polarization properties even when tension is applied to the substrate film due to bonding to a lens. In the case of laminated-type reflective polarizers, before bonding to a substrate with a curved surface, a process is required in which the film is deformed in advance into a rotationally asymmetric shape by considering the difference in shrinkage ratio along two orthogonal axes. However, with wire grid films, such pretreatment is unnecessary, and they can be directly bonded to the substrate. Furthermore, since the reflective surface that contributes to polarization separation is only one, unlike multilayer reflection-based polarization separation, they have excellent resolution performance when reflecting images, making them particularly suitable for use in the present embodiment.

The wire grid reflective polarizer has a configuration having a support substrate (e.g., using a film as the base substrate) and numerous resin protrusions arranged on the surface of the support substrate with a pitch less than the wavelength of visible light (about 100 nm), on which metal wires (e.g., aluminum) are held. The wire grid reflective polarizer has the characteristic that light vibrating parallel to the metal wires is reflected, while light vibrating perpendicular to them is transmitted. Therefore, it has the characteristic that the polarization direction of reflection/transmission can be selected depending on the orientation of the metal wires

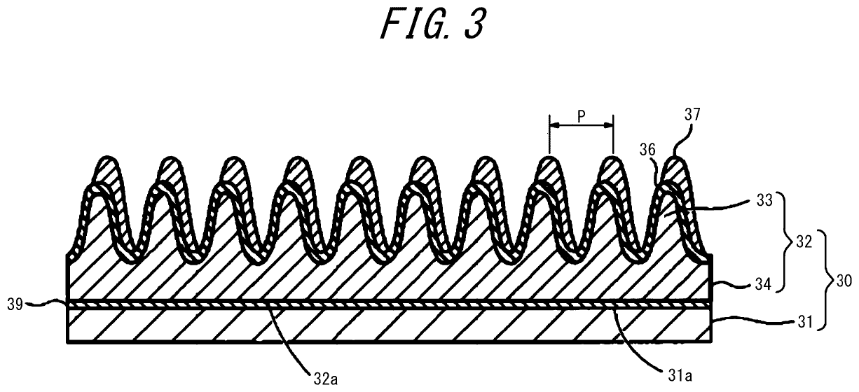

The wire grid polarizer will be described. FIG. 3 is a cross-sectional view of a wire grid polarizer.

The wire grid reflective polarizer is configured to have a support substrate (substrate film) 31 and a resin substrate 32 provided on the surface 31a of the support substrate 31 via a bonding layer 39. In other words, the surface 31a of the support substrate 31 and the surface 32a of the resin substrate 32 are bonded together via the bonding layer 39.

As illustrated in FIG. 3, a plurality of lattice-shaped protruding portions 33 are provided on the resin substrate 32. Also, as illustrated in FIG. 3, the resin substrate 32 is integrally formed from a substrate layer 34 of a predetermined thickness and the lattice-shaped protruding portions 33.

The support substrate 31 only needs to be substantially transparent in the target wavelength range, and although inorganic materials such as glass or resin materials may be used, it is preferable to use a film (resin material) because roll-to-roll processing can be used as the manufacturing method and it has good conformability to curved surfaces.

Examples of resins that can be used as the support substrate 31 include amorphous thermoplastic resins such as polymethyl methacrylate resin, polycarbonate resin, polystyrene resin, cycloolefin resin (COP), crosslinked polyethylene resin, polyvinyl chloride resin, polyarylate resin, polyphenylene ether resin, modified polyphenylene ether resin, polyetherimide resin, polyethersulfone resin, polysulfone resin, polyetherketone resin, and crystalline thermoplastic resins such as polyethylene terephthalate (PET) resin, polyethylene naphthalate resin, polyethylene resin, polypropylene resin, polybutylene terephthalate resin, aromatic polyester resin, polyacetal resin, and polyamide resin, as well as triacetate resin (TAC). Specifically, TD80UL and ZRD60SL manufactured by Fujifilm Corporation, and KC6UA manufactured by Konica Minolta, Inc. can be suitably used as the support substrate 31.

As the resin substrate 32, for example, thermoplastic resins similar to those used for the support substrate 31 can be used, and ultraviolet (UV)-curable resins or thermosetting resins such as acrylic, epoxy, and urethane types can also be used. Furthermore, a UV-curable resin or thermosetting resin may be used in combination with the above thermoplastic resin or triacetate resin, or used alone to form the substrate. As methods for applying the UV-curable resin, gravure coating using a gravure roll, slot-die coating, knife coating, inkjet coating, and spray coating using a potential difference can be mentioned. Also, to cure the resin, it is possible to use a light source that emits visible light of about 405 nm, taking into account absorption by the added ultraviolet absorber, or a light source that emits electron beams.

The protruding and recessed structure having the lattice-shaped protruding portions 33 formed on the surface of the resin substrate 32 preferably has a rectangular shape in a cross-section perpendicular to the extending direction of the protruding and recessed structure. A rectangular shape refers to a repeating structure of depressed and protruding portions, including trapezoidal, rectangular, and square shapes. Moreover, the contour of the protruding and recessed structure in cross-section, if considered as a function, may include curved portions where the curvature gently changes before and after the inflection point, like a parabola, and shapes having constrictions in the protruding portions may also be included. Depending on the shape of the protruding and recessed structure, it becomes easy to form vertically continuous metal wires on the side surfaces of the protruding portions and the bottom of the recessed portions on the substrate surface, while keeping a spacing between the metal wires by the oblique deposition method described later. When metal wires are formed by an oblique deposition method, the metal wires 37 are provided to be biased toward one side surface of the lattice-shaped protruding portions 33. Therefore, the pitch of the protruding and recessed structure and the pitch (pitch P) of the metal wires 37 become approximately the same.

The pitch of the protruding and recessed structure (i.e., the pitch P between lattice-shaped protruding portions 33) (see FIG. 3) is not particularly limited but is preferably set to exhibit polarization separation characteristics. In general, the smaller the pitch of the metal wires 37 in a wire grid polarizing plate, the better the polarization separation characteristics over a broad bandwidth. When the metal wires 37 are in contact with air (of which refractive index is 1.0), practically sufficient polarization separation characteristics can be obtained by setting the pitch of the metal wires 37 to ⅓ to ¼ or less of the wavelength of the target light. Therefore, in consideration of using light in the visible light region, the pitch of the metal wires 37 and the pitch of the protruding and recessed structure of the resin substrate 32 are preferably 150 nm or less, more preferably 130 nm or less, still more preferably 120 nm or less, and most preferably 100 nm or less. The lower limit of the pitch of the metal wires 37 and the protruding and recessed structure of the resin substrate 32 is not particularly limited, but from the viewpoint of ease of manufacturing, 50 nm or more is preferable, 60 nm or more is more preferable, and 80 nm or more is still more preferable.

Note that, in the wire grid reflective polarizer, it is preferable that the metal wires 37 are provided to be biased toward one side surface of the lattice-shaped protruding portions 33 of the protruding and recessed structure. Therefore, the extending direction of the protruding and recessed structure and the extending direction of the metal wires 37 are substantially parallel. Also, it is sufficient that the protruding and recessed structure and the metal wires 37 extend substantially in a given direction; each of the recessed portions, protruding portions, and metal wires does not have to extend strictly in parallel.

As illustrated in FIG. 3, a metal layer (metal wires 37) is formed via a dielectric layer 36 on at least a part of the surface of each lattice-shaped protruding portion 33. The dielectric layer 36 may be omitted. In such a case, the metal layer (metal wires 37) is formed directly on the surface of the lattice-shaped protruding portions 33.

To improve adhesion between the resin substrate 32 and the metal wires 37, a dielectric layer 36 with high adhesion to the resin substrate 32 and the metal wires 37 may be interposed between them. This improves adhesion between the resin substrate 32 and the metal wires 37 and prevents the delamination of the metal wires 37. The dielectric layer 36 only needs to be substantially transparent in the visible light region. As preferable dielectrics, for example, oxides, nitrides, halides, and carbides of silicon (Si), or their composites (dielectrics in which other elements, elements or compounds are mixed with the dielectric material alone), or oxides, nitrides, halides, and carbides of metals such as aluminum (Al), chromium (Cr), yttrium (Y), zirconium (Zr), tantalum (Ta), titanium (Ti), barium (Ba), indium (In), tin (Sn), zinc (Zn), magnesium (Mg), calcium (Ca), cerium (Ce), copper (Cu) can be used. There are no particular limitations on the method of laminating dielectric materials, and for example, physical vapor deposition methods such as vacuum deposition, sputtering, and ion plating may be suitably used.

The metal constituting the metal layer (metal wires 37) preferably has high light reflectivity in the visible light region and high adhesion to the material constituting the dielectric layer 36. The metal wires 37 can be formed using conductive materials such as aluminum, silver, copper, platinum, gold, or alloys mainly composed of these metals. The metal wires 37 are preferably composed of aluminum, silver, or their alloys. From a cost perspective, it is more preferable that the metal wires 37 are composed of aluminum or its alloys. In particular, aluminum is preferable because it can reduce absorption loss in the visible light region. There are no limitations on the method of fabricating the metal wires 37. Methods for fabricating the metal wires 37 include, for example, a method using electron beam lithography or a method using mask patterning by interference exposure and dry etching, or a method of fabrication using oblique deposition. From the viewpoint of productivity, the method for forming the metal wires 37 is preferably the oblique deposition method.

The oblique deposition method is a technique in which, in a cross-sectional view perpendicular to the extending direction of the protruding and recessed structure (hereinafter referred to as “cross-sectional view”), the deposition source is positioned in a direction inclined with respect to the vertical direction of the surface of the substrate, and metal is deposited onto the substrate while maintaining a predetermined angle. The deposition angle is determined depending on the cross-sectional shape of the protruding portions of the protruding and recessed structure and the metal wires 37 to be formed. In general, a range of 5 degrees to 45 degrees is preferable, and 5 degrees to 35 degrees is more preferable. Furthermore, gradually decreasing or increasing the deposition angle while considering the projection effect of the metal being deposited is preferable for controlling the height and other cross-sectional aspects of the metal wires 37. If the surface of the support substrate 31 is curved, the deposition may be performed from a direction inclined with respect to the normal direction of the surface of the resin substrate 32. The shape of the deposition source is not limited as long as it can sufficiently deposit the region to be deposited, and it can be selected from intermittent point shapes or continuous line shapes. When the deposition source is point-shaped, it is possible to perform deposition from an oblique direction relative to the extending direction of the protruding and recessed structure. This results in an apparent widening of the interval between the protruding and recessed structure and allows deposition to reach the bottom of the recessed portions, which is preferable.

Specifically, the center of the deposition source is placed in a direction forming an angle of 5 degrees or more and less than 45 degrees relative to the vertical direction at the center of the region to be deposited on the surface of the resin substrate 32, which has a protruding and recessed structure extending approximately parallel in a specific direction at a predetermined pitch on the surface thereof, to form the metal wires 37 on the protruding and recessed structure. More preferably, the center of the deposition source is placed in a direction forming an angle of 5 degrees or more and less than 35 degrees relative to the vertical direction at the center of the region to be deposited on the surface of the resin substrate 32. In this way, it becomes possible to selectively form the metal wires 37 on one of the side surfaces of the lattice-shaped protruding portions 33 of the protruding and recessed structure on the surface of the resin substrate 32. In the case where the substrate is conveyed during deposition, the deposition may be performed such that the center of the region to be deposited and the center of the deposition source at a given moment satisfy the above conditions.

The amount of metal deposition (average thickness) is preferably about 50 nm to 300 nm. Here, the term “average thickness” refers to the thickness of the deposited film when deposition is performed perpendicularly onto a smooth glass substrate surface, and is used as an indicator for the amount of metal deposition.

As illustrated in FIG. 3, a bonding layer or adhesive layer 39 may be interposed for improving the adhesion between the support substrate 31 and the resin substrate 32 or for adjusting the refractive index. For example, a dielectric layer such as silica or alumina may be formed with a thin film thickness between the support substrate 31 and the resin substrate 32, or the surface 31a of the support substrate 31 may be subjected to corona discharge treatment, atmospheric pressure plasma treatment, vacuum plasma treatment, or ultraviolet treatment to impart functional groups or fine protruding and recessed shapes, thereby forming a modified layer.

The thickness of the wire grid reflective polarizer 30 is not particularly limited but is, for example, about 50 μm to 200 μm. A smaller thickness allows for higher conformability to the curved surface of the lens, thereby significantly improving the yield in the bonding process to the resin lens surface. Specifically, the thickness of the wire grid reflective polarizer 30 is preferably 50 to 150 μm, more preferably 50 to 130 μm. Moreover, by removing the support substrate 31 and forming the wire grid reflective polarizer 30 with the resin substrate 32 and the metal layer (metal wires 37), the thickness can be reduced to about 0.5 μm to 50 μm.

Before the adhesion process, surface treatment such as corona treatment applied to the surface of the support substrate 31 (which does not have metal wires 37) is effective for improving adhesive strength. If the lattice-shaped protruding portions 33 are made of COP, to prevent detachment of the metal wires 37 from the protruding and recessed structure, it is preferable to adjust the processing conditions such that the discharge amount, calculated from the discharge electrode length, substrate film conveyance speed, and discharge power, is equivalent to 10 to 120 W·min/m².

In the reflective polarizer bonded lens of the present embodiment, the reflective polarizer may have multiple reflective surfaces involved in polarization separation, but it is preferable to have only one reflective surface that contributes to polarization separation, as illustrated in the wire grid polarizing plate in FIG. 3.

### [Adhesive Layer]

The reflective polarizer bonded lens of the present embodiment has an adhesive layer between the resin lens and the reflective polarizer.

The size and shape of the adhesive layer are not particularly limited, but from the viewpoint of obtaining uniform in-plane thickness and sufficient adhesion strength, for example, the average thickness is preferably 0.01 to 500 μm, more preferably 0.5 to 100 μm, and still more preferably 1.0 to 10 μm.

The adhesive layer may cover the entire adhesive surface of the resin lens (the surface facing the reflective polarizer) or may cover only a part of the surface. Also, the adhesive layer may cover the entire adhesive surface of the reflective polarizer (the surface facing the resin lens substrate) or may cover only a part of the surface.

In the reflective polarizer bonded lens of the present embodiment, the adhesive layer preferably has a peel area ratio of 15% or less, more preferably 10% or less, and still more preferably 5% or less, when exposed to an environment of a temperature of 85° C. and a relative humidity of 85% for 500 hours. If the peel area ratio of the adhesive layer under an environment of a temperature of 85° C. and a relative humidity of 85% for 500 hours is within the above range, it becomes more effective in suppressing degradation of optical performance in high temperature and humidity environments, thereby tending to yield clearer images.

The method for measuring the peel area can be conducted according to the method described in the Examples below.

In the reflective polarizer bonded lens of the present embodiment, it is preferable that the adhesive layer is an adhesive layer composed of an adhesive that contains no silane coupling reagent.

### —Adhering Agent and Adhesive—

As the material used for bonding and adhesion processing in the adhesive layer, various adhesives and adhering agents can be used, but from the viewpoint of workability, it is preferable to use one in a solid sheet form, and the use of an adhering agent is preferable. Here, an adhering agent refers to a material that has viscosity in a semi-solid state without curing a liquid, and which adheres to a surface with only slight pressure.

As a specific material for the adhesive layer, a double-sided tape covered on both sides with release paper can be used. Any material having transparency that allows transmission of light of the target wavelength can be used without problem. For example, products, such as CS9861US, CS9862UA, and HJ-9150W manufactured by Nitto Denko Corporation; MO-T015, MO-3005, MO-3006 and MO-3014 manufactured by Lintec Corporation; and 5405X-75 manufactured by Sekisui Chemical CO., Ltd., can be suitably used. When a wire grid polarizing plate, of which support substrate 21 is a film is adhered, it is necessary to consider expansion and contraction of the film due to changes in ambient temperature. To accommodate tension at the bonding interface arising from differences in shrinkage and expansion between the substrate on the bonding side (e.g., lens) and the wire grid polarizing plate, a bonding material having flexibility is effective. Preferred examples include bonding materials made of the above-mentioned acrylic resins and silicone-based resin adhesives. When heat resistance is considered, an adhering agent mainly composed of a silicone-based resin (hereinafter referred to as “silicone-based adhering agent”) is preferable. When considering transparency, adhesive strength, and procurement cost, an adhering agent mainly composed of acrylic resin (hereinafter referred to as “acrylic adhering agent”) is preferable. Furthermore, having hydroxyl groups in the resin structure of the adhering agent is more preferable from the viewpoint of suppressing degradation in polarization characteristics.

The thickness of the material in the adhesive layer is preferably 50 μm or more from the viewpoint of keeping handleability and flexibility. On the other hand, if the adhesive material is too thick, it becomes difficult to maintain mirror surface quality (or surface accuracy according to the design shape); thus, 100 μm or less is preferable.

Moreover, it is preferable to use an adhering agent with strong adhesive strength. By using a material with strong adhesion, delamination can be suppressed even in high-temperature and high-humidity environments. As a material with strong adhesion, a material having an adhesive strength of 1.5 N/25 mm or more, preferably 5.0 N/25 mm or more, with respect to glass may be used.

Additives may also be added to the adhering agent. Additives include refractive index modifiers, tackifiers, fillers, pigments, diluents, and also ultraviolet absorbers, antioxidants, light stabilizers, antistatic agents, etc., which improve the stability of the adhering agent.

### [Silane Coupling Reagent Layer]

The reflective polarizer bonded lens of the present embodiment includes a silane coupling reagent layer at least one of between the resin lens and the adhesive layer, and between the adhesive layer and the reflective polarizer.

When a plurality of silane coupling reagent layers are provided, all the silane coupling reagent layers may be formed of the same material, or each may be formed of different materials.

By including at least one silane coupling reagent layer, the reflective polarizer bonded lens of the present embodiment can firmly bond the resin substrate and the adhesive layer, thereby suppressing the degradation of optical performance under high-temperature and high-humidity environments and enabling the acquisition of a clear image.

The silane coupling reagent layer can be formed by chemically vapor-depositing a silane coupling reagent onto at least one of the resin lens, the adhesive layer, and the reflective polarizer. For example, using a vacuum plasma apparatus, water or oxygen gas is supplied into the reaction chamber to hydrophilize at least one surface of the lens, the adhesive layer, and the reflective polarizer, and then a silane coupling reagent is reacted to form a silane coupling reagent layer.

A silane coupling reagent is a compound having an organic functional group that reacts with an organic substance and a hydrolyzable group (e.g., alkoxy group) that reacts with an inorganic substance in the molecule, and is used at the interface between organic and inorganic materials to improve the interaction between the two materials. On the other hand, when a silane coupling reagent is used to improve the interfacial interaction between organic materials, it is necessary to react the hydrolyzable group of the silane coupling reagent with the organic material; hence, the processing conditions are often limited. For example, JP 4065962 B and JP 5733392 B disclose examples of processing silane coupling reagents on epoxy resins and cyclic olefin resins, but the processes include a step of heating the resin substrate at high temperatures and a step of irradiating with vacuum ultraviolet light of short wavelength, which limits the range of applicable resins. In particular, methacrylic resin compositions generally have low heat resistance and are prone to degradation under ultraviolet light; thus, treatment of methacrylic resin compositions with a silane coupling reagent is preferably carried out under mild conditions.

As the silane coupling reagent for forming the silane coupling reagent layer, a known silane coupling reagent can be used, but it is preferable to use an alkoxysilane having at least one alkoxy group. As for the number of alkoxy groups, two or three (i.e., dialkoxysilane or trialkoxysilane) are preferable, and silane coupling reagents having three alkoxy groups are particularly preferable. The carbon number of the alkoxy group is preferably 1 to 4, more preferably 1 to 3.

Specific examples of silane coupling reagents for forming the silane coupling reagent layer include 3-(trimethoxysilyl) propyl methacrylate, 3-3-[tris(trimethylsiloxy) silyl] propyl methacrylate, [diethoxy(methyl) silyl]propyl methacrylate, 3-[dimethoxy(methyl) silyl]propyl methacrylate, (triethoxysilyl)methyl methacrylate, 3-[dimethoxy(methyl) silyl]propyl acrylate, 3-(methyldimethylsilyl) propyl acrylate, 3-(trimethoxysilyl) propyl acrylate, [dimethoxy(methyl) silyl]methyl methacrylate, vinyltrimethoxysilane, vinyltriethoxysilane, dimethylethoxyvinylsilane, allyltrimethoxysilane, allyltriethoxysilane, vinyltris(2-methoxyethoxy) silane, dimethoxymethylvinylsilane, trimethoxy (7-octen-1-yl) silane, 3-aminopropyltriethoxysilane, trimethoxy[3-(phenylamino) propyl]silane, 3-(2-aminoethylamino) propyltrimethoxysilane, 3-(2-aminoethylamino) propyldimethoxymethylsilane, 3-aminopropyldimethoxymethylsilane, 3-(ethoxydimethylsilyl) propan-1-amine, [3-(6-aminohexylamino) propyl]trimethoxysilane, 3-aminopropyldiethoxymethylsilane, 3-(methylamino) propyltriethoxysilane, 3-aminopropyltrimethoxysilane, trimethoxy[3-(methylamino) propyl]silane, 3-glycidyloxypropyltrimethoxysilane, 3-glycidyloxypropyldimethoxymethylsilane, triethoxy (3-glycidyloxypropyl) silane, and diethoxy (3-glycidyloxypropyl)methylsilane. These may be used alone or in combination of two or more. From the viewpoint of good reactivity with acrylic adhesives, it is preferable to use a silane coupling reagent having a (meth)acryloyl group.

As methods for forming the silane coupling reagent layer, conventionally known liquid phase methods and vapor phase methods can be used. For example, in the liquid phase method, a silane coupling reagent layer is formed by bringing the substrate into contact with an organic solution containing the silane coupling reagent for a certain period of time. On the other hand, the vapor phase method is a method in which a silane coupling reagent layer is formed by bringing the substrate into contact with vapor containing the silane coupling reagent without using a solvent. For example, by using a vacuum plasma apparatus and supplying water, oxygen gas, etc., into the reaction chamber, hydrophilic functional groups can be introduced onto the surface of the substrate, and then reacted with a silane coupling reagent to form a silane coupling reagent layer. Unlike the liquid phase method, the vapor phase method does not use solvents, which helps suppress damage to the substrate due to dissolution, etc., by the solvent. In addition, since the amount of waste liquid can be reduced and environmental impact is small, it is preferable to form the silane coupling reagent layer by the vapor phase method.

As for the plasma treatment used to form the silane coupling reagent layer, conventionally known treatment methods can be used. For example, atmospheric pressure plasma treatment can be used in which a plasma is generated by applying a voltage between metal electrodes facing each other across a dielectric, and a process gas such as oxygen or nitrogen is irradiated onto the generated plasma to irradiate the substrate with plasma. It is also possible to use vacuum plasma treatment in which the substrate is placed between opposing metal electrodes through a dielectric inside a sealed chamber and the surface of the substrate is directly exposed to plasma for treatment.

For resins such as methacrylic resin compositions that are prone to molecular chain scission due to plasma irradiation, it is possible to perform treatment with less damage to the substrate by using a remote plasma method in which process gas containing plasma is irradiated onto the substrate, as in atmospheric pressure plasma treatment. On the other hand, a direct plasma method such as vacuum plasma treatment, where the substrate is directly exposed to plasma, provides higher processing efficiency and allows processing in a sealed environment, thereby reducing the risk of contamination by impurities during processing. Furthermore, since the hydrophilization process of the substrate and the formation of the silane coupling reagent layer can be performed in a single reactor, it is preferable to form the silane coupling reagent layer using a vacuum plasma method.

The gas used for plasma treatment is not particularly limited as long as it can introduce hydroxyl groups onto the surface of the treated substrate, and conventionally known gases such as nitrogen, argon, oxygen, and water vapor can be used.

The electric energy during discharge treatment for plasma processing is preferably 60 W·min to 1500 W·min, more preferably 100 W·min to 1000 W·min, and even more preferably 120 W·min to 800 W·min. When the electric energy during discharge treatment is 60 W·min or more, the hydrophilization treatment of the substrate can be sufficiently performed, and the silane coupling reagent layer can be efficiently formed. As a result, the durability of the adhesive layer of the reflective polarizer bonded lens tends to become favorable even under high-temperature and high-humidity environments. On the other hand, when the electric energy during discharge treatment is 1500 W·min or less, the formation of a brittle layer near the surface due to deterioration of the resin lens by plasma treatment is reduced, and the durability of the adhesive layer of the reflective polarizer bonded lens tends to become favorable even under high-temperature and high-humidity environments. Therefore, it is preferable that the electric energy during the discharge treatment is within the above range.

The various conditions for forming the silane coupling reagent layer (for example, the pressure and gas flow rate during vacuum plasma treatment) may be set as appropriate and are not particularly limited.

As a method for confirming the formation of the silane coupling reagent layer, known methods such as measurement of the contact angle of water before and after formation of the silane coupling reagent layer, X-ray photoelectron spectroscopy (XPS), time-of-flight secondary ion mass spectrometry (TOF-SIMS), and infrared spectroscopy may be used. When confirming the presence of the silane coupling reagent layer after forming the adhesive layer on the silane coupling reagent layer, surface analysis can be performed by exposing the adhesive interface using mechanical peeling such as polishing or etching, chemical peeling using a solvent, or physical peeling by degrading the adhesive through heating or cooling.

### (Resin Composition)

Hereinafter, the resin composition that forms the resin lens of the reflective polarizer bonded lens of the present embodiment will be described.

The resin lens of the reflective polarizer bonded lens of the present embodiment is composed of a resin composition. The resin contained in the resin lens is not particularly limited as long as it is a resin having both low birefringence properties and heat resistance properties that do not impair the function of the reflective polarizer, but as a resin capable of achieving highly low birefringence properties, it is preferable to contain a methacrylic resin. In other words, it is preferable that the resin lens is made of a resin composition containing a methacrylic resin, i.e., a methacrylic resin composition.

It is also preferable that the resin lens is composed of a cyclic polyolefin-based resin composition. More preferably, the resin lens is made of a resin composition containing a cyclic olefin copolymer that is a copolymer of ethylene or an α-olefin and a cyclic olefin.

### ((Methacrylic Resin Composition))

The methacrylic resin composition contains a methacrylic resin. Additionally, the methacrylic resin composition may optionally contain an additive in addition to the methacrylic resin, and may also contain a thermoplastic resin other than the methacrylic resin, a rubbery polymer, and the like.

### —Methacrylic Resin—

Hereinafter, the methacrylic resin contained in the methacrylic resin composition will be described.

The methacrylic resin is not particularly limited, but examples include resins mainly comprising structural units derived from methyl methacrylate. Examples includes homopolymers of methyl methacrylate or copolymers of methyl methacrylate and one or more copolymerizable monomers such as methyl acrylate, ethyl acrylate, n-propyl acrylate, isopropyl acrylate, butyl acrylate, acrylonitrile, acrylic acid, methacrylic acid, vinylpyridine, vinylmorpholine, vinylpyrrolidone, tetrahydrofurfuryl acrylate, N,N-dimethylaminoethyl acrylate, N,N-dimethylacrylamide, 2-hydroxyacrylate, 2-(hydroxymethyl)ethyl acrylate, ethylene glycol monoacrylate, glycerin monoacrylate, maleic anhydride, N-cyclohexylmaleimide, N-phenylmaleimide, styrene, or α-methylstyrene. In addition, the methacrylic resin may include heat-resistant methacrylic resins having structural units derived from methyl methacrylate and having a lactone ring or glutarimide in the main chain, and methacrylic resins with low moisture absorption properties. These may be used alone or in a blend of two or more.

In the methacrylic resin forming the resin lens of the reflective polarizer bonded lens of the present embodiment, by appropriately adjusting the ratio between structural units (X) having a cyclic structure in the main chain and structural units derived from methacrylic acid ester monomers, it is possible to reduce birefringence caused by orientation and residual stress during molding and obtain a resin lens for head-mounted displays with an average absolute value of phase difference within the effective diameter of 10 nm or less. Moreover, by appropriately adjusting the above ratio, sufficient heat resistance can be imparted to the methacrylic resin. From these viewpoints, the content of structural units derived from methacrylic acid ester monomers, is preferably 50 to 97 mass %, more preferably 55 to 97 mass %, further preferably 55 to 95 mass %, still more preferably 60 to 93 mass %, and particularly preferably 60 to 90 mass %, based on 100 mass % of the methacrylic resin.

Note that the content of the structural units derived from methacrylic acid ester monomers can be determined by ¹H-NMR and ¹³C-NMR measurements. For example, ¹H-NMR and ¹³C-NMR measurements can be made using CDCl₃ or DMSO-d₆ as a measurement solvent at a measurement temperature of 40° C.

From the viewpoint of transparency and heat resistance, it is preferable that the methacrylic resin of the present embodiment contains methacrylic resin having structural units with cyclic structures.

As the structural units having the cyclic structure, at least one structural unit selected from the group consisting of structural units derived from N-substituted maleimide monomers, glutarimide-based structural units, aromatic vinyl structural units, alicyclic vinyl structural units, and lactone ring structural units is preferably included. In the case of methacrylic resins that undergo a cyclization step to introduce cyclic structures into the main chain, residual carboxylic acid side chains may cause a very high moi sture absorption rate, which adversely affects the adhesion of antireflection coatings and mirror coatings and the bonding with the reflective polarizer. Therefore, methacrylic resins having structural units derived from N-substituted maleimide monomers or hydrogenated aromatic ring structures are more preferable. In addition, without blending with other thermoplastic resins, from the viewpoint of ease in precisely controlling optical properties such as intrinsic birefringence and photoelastic coefficient, structural units of which cyclic structure includes structural units derived from an N-substituted maleimide monomer are particularly preferably contained.

——Structural Units Derived from N-Substituted Maleimide Monomer——

Next, the structural unit derived from an N-substituted maleimide monomer will be described.

The structural unit derived from an N-substituted maleimide monomer may be at least one structural unit selected from the group consisting of a structural unit represented by the following general formula (1) and a structural unit represented by the following general formula (2), and is preferably formed from both a structural unit represented by the following general formula (1) and a structural unit represented by the following general formula (2).

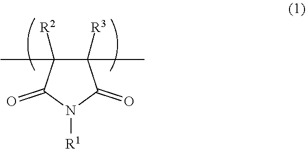

In the general formula (1), R¹ represents an arylalkyl group having 7 to 14 carbon atoms or an aryl group having 6 to 14 carbon atoms, and R² and R³ each represent, independently of one another, a hydrogen atom, an oxygen atom, a sulfur atom, an alkyl group having 1 to 12 carbon atoms, or an aryl group having 6 to 14 carbon atoms.

Note that in a case in which R² or R³ is an aryl group, R² or R³ may include a halogen atom as a substituent.

Moreover, R¹ may be substituted with a substituent such as a halogen atom, an alkyl group having 1 to 6 carbon atoms, an alkoxy group having 1 to 6 carbon atoms, a nitro group, or a benzyl group.

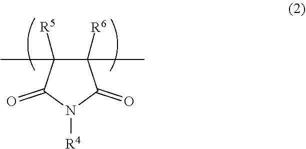

In the general formula (2), R⁴ represents a hydrogen atom, a cycloalkyl group having a carbon number of 3 to 12, or an alkyl group having 1 to 12 carbon atoms, and R⁵ and R⁶ each represent, independently of one another, a hydrogen atom, an oxygen atom, a sulfur atom, an alkyl group having 1 to 12 carbon atoms, or an aryl group having 6 to 14 carbon atoms.

In the above general formula (1), the arylalkyl group having 7 to 14 carbon atoms is not particularly limited, but examples include benzyl, phenylethyl, phenylpropyl, naphthylmethyl, naphthylethyl, and naphthylpropyl groups.

In the above general formulas (1) and (2), the aryl group having 6 to 14 carbon atoms is not particularly limited, but examples include phenyl, tolyl, xylyl, naphthyl, biphenyl, anthracenyl, and phenanthryl groups.

In the above general formulas (1) and (2), the alkyl group having 1 to 12 carbon atoms may be linear or branched and is not particularly limited, but examples include methyl, ethyl, n-propyl, isopropyl, n-butyl, sec-butyl, isobutyl, tert-butyl, 2-methylbutyl, n-pentyl, 2-pentyl, 3-pentyl, 2,2-dimethylpropyl, n-hexyl, heptyl, n-octyl, 1,1,3,3-tetramethylbutyl, 2-ethylhexyl, nonyl, decyl, undecyl, and dodecyl groups.

In the above general formula (1), examples of the halogen atoms include, for example, fluorine, chlorine, bromine, and iodine.

In the above general formula (1), the alkoxy group having 1 to 6 carbon atoms is not particularly limited, but examples include methoxy, ethoxy, n-butoxy, and methoxyethoxy groups.

In the above general formula (2), the cycloalkyl group having 3 to 12 carbon atoms is not particularly limited, but examples include cyclopropyl, cyclopropylmethyl, cyclobutyl, cyclopentyl, cyclohexyl, cyclohexylmethyl, trimethylcyclohexyl, thujyl, norbornyl, bornyl, norcaryl, caryl, menthyl, norpinyl, pinyl, 1-adamantyl, and 2-adamantyl groups.

Below are specific examples of monomers forming the structural units represented by the general formulas (1) and (2).

Examples of monomers (N-arylmaleimides and N-aromatic substituted maleimides) forming the structural unit represented by the general formula (1) include N-phenylmaleimide, N-benzylmaleimide, N-(2-chlorophenyl) maleimide, N-(4-chlorophenyl) maleimide, N-(4-N-(2-methylphenyl) maleimide, N-(2,6-bromophenyl) Maleimide, dimethylphenyl) maleimide, N-(2-ethylphenyl) maleimide, N-(2-methoxyphenyl) maleimide, N-(2-nitrophenyl) maleimide, N-(2,4,6-trimethylphenyl) maleimide, N-(4-benzylphenyl) maleimide, N-(2,4,6-tribromophenyl) maleimide, N-naphthylmaleimide, N-anthracenylmaleimide, 3-methyl-1-phenyl-1H-pyrrole-2,5-dione, 3,4-dimethyl-1-phenyl-1H-pyrrole-2,5-dione, 1,3-diphenyl-1H-pyrrole-2,5-dione, and 1,3,4-triphenyl-1H-pyrrole-2,5-dione.

Of these monomers, N-phenylmaleimide and N-benzylmaleimide are preferable in terms of providing the resultant methacrylic resin with excellent heat resistance and optical properties such as birefringence.

One ester monomer may be used alone, or two or more ester monomers may be used in combination.

Examples of monomers represented by the general formula (2) include N-methylmaleimide, N-ethylmaleimide, N—N-n-propylmaleimide, isopropylmaleimide, N-s-butylmaleimide, N-isobutylmaleimide, N-s-butylmaleimide, N-t-butylmaleimide, N-n-pentylmaleimide, N-n-hexylmaleimide, N-n-heptylmaleimide, N-n-octylmaleimide, N-laurylmaleimide, N-cyclopentylmaleimide, N-cyclohexylmaleimide, 1-cyclohexyl-3-methyl-1H-pyrrole-2,5-dione, 1-cyclohexyl-3,4-dimethyl-1H-pyrrole-2,5-dione, 1-cyclohexyl-3-phenyl-1H-pyrrole-2,5-dione, and 1-cyclohexyl-3,4-diphenyl-1H-pyrrole-2,5-dione.

Of these monomers, N-methylmaleimide, N-ethylmaleimide, N-isopropylmaleimide, and N-cyclohexylmaleimide are preferable in terms of providing the resultant methacrylic resin with excellent weather resistance, and N-cyclohexylmaleimide is particularly preferable in terms of providing excellent low water absorbency demanded of optical materials in recent years.

One of these monomers may be used alone, or two or more of these monomers may be used in combination.

The methacrylic resin in the methacrylic resin composition is particularly preferably obtained using a structural unit represented by the general formula (1) and a structural unit represented by the general formula (2), in combination, in order to exhibit a high level of control on birefringence properties.

The molar ratio (X1/X2) of the content (X1) of the structural unit represented by the general formula (1) relative to the content (X2) of the structural unit represented by the general formula (2) is preferably greater than 0 and not greater than 15, and more preferably greater than 0 and not greater than 10. When the molar ratio (X1/X2) is within any of the ranges set forth above, the reflective polarizer bonded lens of the present embodiment can exhibit good heat resistance and good photoelastic properties while maintaining transparency, and without yellowing or loss of environmental resistance.

The content of the structural unit derived from an N-substituted maleimide monomer is preferably in the range of 5 mass % to 40 mass % and more preferably in the range of 5 mass % to 35 mass %, relative to 100 mass % of the methacrylic resin. When the content of the structural unit derived from the N-substituted maleimide monomer is within this range, the methacrylic resin exhibits a more sufficient improvement in heat resistance, and also provides more favorable improvements in weather resistance, low water absorption, and optical properties. Restricting the content of the structural unit derived from an N-substituted maleimide monomer to 40 mass % or less is effective for preventing a decrease in physical properties of the methacrylic resin caused by a large amount of monomer remaining unreacted due to reduced reactivity of monomer components in the polymerization reaction.

Also, by appropriately adjusting the content of structural unit derived from an N-substituted maleimide monomer within this range, it is possible to reduce birefringence caused by orientation and residual stress during molding and obtain a reflective polarizer bonded lens having an average absolute value of in-plane phase difference of 10 nm or less. The optimal content of structural unit derived from the N-substituted maleimide monomer varies depending on the type of N-substituted maleimide, but for example, when methyl methacrylate is used as the methacrylic acid ester monomer, and N-phenylmaleimide and N-cyclohexylmaleimide are used as the N-substituted maleimide monomers, it is preferable that the contents of structural units derived from methyl methacrylate, structural units derived from N-phenylmaleimide, and structural units derived from N-cyclohexylmaleimide within the ranges of 79 to 83 mass %, 6 to 8 mass %, and 11 to 13 mass %, respectively.

The methacrylic resin that includes the structural unit derived from an N-substituted maleimide monomer may further include structural units derived from other monomers that are copolymerizable with the methacrylic acid ester monomer and the N-substituted maleimide monomer to the extent that the objectives of the present disclosure are not impeded.

Examples of other copolymerizable monomers that can be used include aromatic vinyls; unsaturated nitriles; acrylic acid esters including a cyclohexyl group, a benzyl group, or an alkyl group having a carbon number of 1 to 18; glycidyl compounds; and unsaturated carboxylic acids.

Examples of the aromatic vinyls include styrene, α-methylstyrene, and divinylbenzene.

Examples of the unsaturated nitriles include acrylonitrile, methacrylonitrile, and ethacrylonitrile.

Examples of the acrylic acid esters include methyl acrylate, ethyl acrylate, propyl acrylate, isopropyl acrylate, and butyl acrylate.

An example of the glycidyl compounds includes glycidyl(meth)acrylate.

Examples of the unsaturated carboxylic acids include acrylic acid, methacrylic acid, itaconic acid, maleic acid, and fumaric acid, and half-esterified products and anhydrides thereof.

The methacrylic resin may include only one type of structural unit derived from another copolymerizable monomer, or may include two or more types of structural units derived from other copolymerizable monomers.

The content of structural units derived from such other copolymerizable monomers relative to 100 mass % of the methacrylic resin is preferably 0 mass % to 10 mass %, more preferably 0 mass % to 9 mass %, and even more preferably 0 mass % to 8 mass %.

It is preferable for the content of structural units derived from other monomers to be within any of the ranges set forth above in terms that molding properties and mechanical properties of the resin can be enhanced without losing the intended effects of introducing a cyclic structure.

Note that the content of the structural unit derived from an N-substituted maleimide monomer and the content of the structural unit derived from other copolymerizable monomers can be determined by 1H-NMR and ¹³C-NMR measurements. For example, ¹H-NMR and ¹³C-NMR measurements can be made using CDCl₃ or DMSO-d₆ as a measurement solvent at a measurement temperature of 40° C.

### ——Glutarimide-Based Structural Unit——

An examples of the methacrylic resin including the glutarimide-based structural unit includes, for example, a methacrylic resin including a glutarimide-based structural unit described in JP 2006-249202 A, JP 2007-009182 A, JP 2007-009191 A, JP 2011-186482 A, or JP 2012-114718 A, and may be formed by a method described in the same publication.

A glutarimide-based structural unit forming the methacrylic resin may be formed after resin polymerization.

Specifically, the glutarimide-based structural unit may be represented by the following general formula (3).

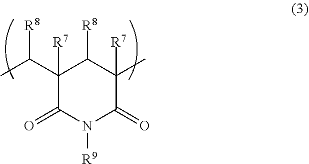

In the above general formula (3), it is preferable that R⁷ and R⁸ are each, independently of one another, a hydrogen atom or a methyl group, and R⁹ is a hydrogen atom, a methyl group, a butyl group, or a cyclohexyl group, and more preferable that R⁷ is a methyl group, R⁸ is a hydrogen atom, and R⁹ is a methyl group.

The methacrylic resin may include a single type of glutarimide-based structural unit or may include two or more types of glutarimide-based structural units.

The content of the glutarimide-based structural unit in the methacrylic resin having a glutarimide-based structural unit is preferably in the range of 3 mass % to 70 mass %, and more preferably in the range of 3 mass % to 60 mass %, relative to 100 mass % of the methacrylic resin.

It is preferable for the content of the glutarimide-based structural unit to be within any of the ranges set forth above in terms that a resin having good molding properties, heat resistance, and optical properties can be obtained.

By appropriately adjusting the content of the glutarimide-based structural unit within this range, birefringence caused by orientation and residual stress during molding can be reduced, and a reflective polarizer bonded lens having an average absolute value of in-plane phase difference of 5 nm or less can be obtained. The optimal content of the glutarimide-based structural unit varies depending on the type of substituents R⁷ to R⁹ in general formula (3); for example, when R⁷ and R⁸ are hydrogen atoms and R⁹ is a methyl group, if the content of the glutarimide-based structural unit is within the range of 3 to 10 mass %, birefringence caused by orientation and residual stress during molding can be reduced, and a reflective polarizer bonded lens having an average absolute value of in-plane phase difference of 10 nm or less can be obtained.

The content of the glutarimide-based structural unit in the methacrylic resin can be determined by a method described in the previously mentioned patent literature.

The methacrylic resin including the glutarimide-based structural unit may further include an aromatic vinyl monomer unit as necessary.

Examples of aromatic vinyl monomers that can be used include, but are not specifically limited to, styrene and α-methylstyrene. The aromatic vinyl monomer is preferably styrene.

The content of the aromatic vinyl unit in the methacrylic resin including the glutarimide-based structural unit is not specifically limited. Nevertheless, the content of the aromatic vinyl unit relative to 100 mass % of the methacrylic resin is preferably 0 mass % to 20 mass %.

It is preferable for the content of the aromatic vinyl unit to be in any of the ranges set forth above in terms that both heat resistance and excellent photoelastic properties can be obtained.

For example, in the case of obtaining a resin by glutarimide-modifying a methyl methacrylate-styrene copolymer produced by copolymerizing methyl methacrylate as the methacrylic acid ester monomer and styrene as the aromatic vinyl monomer, by adjusting within the ranges of 65 to 90 mass % for structural units derived from methyl methacrylate, 5 to 15 mass % for structural units derived from styrene, and 5 to 20 mass % for glutarimide-based structural units, birefringence caused by orientation and residual stress during molding can be reduced, and a reflective polarizer bonded lens having an average absolute value of in-plane phase difference of 10 nm or less can be obtained.

### ——Aromatic Vinyl Structural Unit——

The aromatic vinyl structural units are not particularly limited, but structural units derived from styrene or α-methylstyrene may be mentioned, with those derived from styrene being preferable.

### ——Alicyclic Vinyl Structural Unit——

The alicyclic vinyl structural units can be formed by the methods described, for example, in JP 2006-291184 A, JP 2014-77043 A, and JP 2014-77044 A.

### ——Lactone Ring Structural Unit—

The methacrylic resin including the lactone ring structural unit can be formed, for example, by a method described in JP 2001-151814 A, JP 2004-168882 A, JP 2005-146084 A, JP 2006-96960 A, JP 2006-171464 A, JP 2007-63541 A, JP 2007-297620 A, JP 2010-180305 A, or other publications.

A lactone ring structural unit included in the methacrylic resin may be formed after resin polymerization.

A lactone ring structural unit in the present embodiment is preferably a six-membered ring since this provides the cyclic structure with excellent stability.

The lactone ring structural unit that is a six-membered ring is, for example, particularly preferably a structure represented by the following general formula (4).

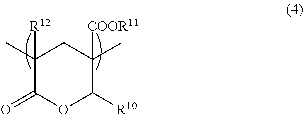

In the above general formula (4), R¹⁰, R¹¹, and R¹² are each, independently of one another, a hydrogen atom or an organic residue having 1 to 20 carbon atoms.

Examples of the organic residue include saturated aliphatic hydrocarbon groups (alkyl groups, etc.) having 1 to 20 carbon atoms such as a methyl group, an ethyl group, and a propyl group; unsaturated aliphatic hydrocarbon groups (alkenyl groups, etc.) having a carbon number of 2 to 20 such as an ethenyl group and a propenyl group; aromatic hydrocarbon groups (aryl groups, etc.) having 6 to 20 carbon atoms such as a phenyl group and a naphthyl group; and groups in which at least one hydrogen atom of any of these saturated aliphatic hydrocarbon groups, unsaturated aliphatic hydrocarbon groups, and aromatic hydrocarbon groups is substituted with at least one group selected from the group consisting of a hydroxy group, a carboxyl group, an ether group, and an ester group.

The lactone ring structural unit may be formed, for example, by copolymerizing an acrylic acid-based monomer having a hydroxy group and a methacrylic acid ester monomer such as methyl methacrylate to introduce a hydroxy group and an ester group or carboxyl group into the molecular chain, and then causing dealcoholization (esterification) or dehydration condensation (hereinafter, also referred to as a “cyclocondensation reaction”) between the hydroxy group and the ester group or carboxyl group.

Examples of acrylic acid-based monomers having a hydroxy group that can be used in polymerization include 2-(hydroxymethyl)acrylic acid, 2-(hydroxyethyl)acrylic acid, alkyl 2-(hydroxymethyl)acrylates (for example, methyl 2-(hydroxymethyl)acrylate, ethyl 2-(hydroxymethyl)acrylate, isopropyl 2-(hydroxymethyl)acrylate, n-butyl 2-(hydroxymethyl)acrylate, and t-butyl 2-(hydroxymethyl)acrylate), and alkyl 2-(hydroxyethyl)acrylates. Moreover, 2-(hydroxymethyl)acrylic acid and alkyl 2-(hydroxymethyl)acrylates that are monomers having a hydroxyalkyl moiety are preferable, and methyl 2-(hydroxymethyl)acrylate and ethyl 2-(hydroxymethyl)acrylate are particularly preferable.

The content of the lactone ring structural unit in the methacrylic resin including the lactone ring structural unit is preferably 5 mass % to 40 mass %, and more preferably 5 mass % to 35 mass %, relative to 100 mass % of the methacrylic resin.

When the content of the lactone ring structural unit is within any of the ranges set forth above, effects resulting from the introduction of a cyclic structure, such as improved solvent resistance and improved surface hardness, can be exhibited while maintaining molding properties. By appropriately adjusting the content of the glutarimide-based structural unit within this range, birefringence caused by orientation and residual stress during molding can be reduced, and a reflective polarizer bonded lens having an average absolute value of in-plane phase difference of 10 nm or less can be obtained.

The content of the lactone ring structure in the methacrylic resin can be determined by a method described in the previously mentioned patent literature.

The methacrylic resin including the lactone ring structural unit may include structural units derived from other monomers that are copolymerizable with the above-described methacrylic acid ester monomer and acrylic acid-based monomer having a hydroxy group.

Examples of such other copolymerizable monomers include monomers having a polymerizable double bond such as styrene, vinyltoluene, α-methylstyrene, α-hydroxymethylstyrene, α-hydroxyethylstyrene, acrylonitrile, methacrylonitrile, methallyl alcohol, ethylene, propylene, 4-methyl-1-pentene, vinyl acetate, 2-hydroxymethyl-1-butene, methyl vinyl ketone, N-vinylpyrrolidone, and N-vinylcarbazole.

One of these other monomers (structural units) may be included, or two or more of these other monomers may be included.

The content of structural units derived from such other copolymerizable monomers relative to 100 mass % of the methacrylic resin is preferably 0 mass % to 20 mass %, more preferably less than 10 mass % from the viewpoint of the weather resistance, and even more preferably less than 7 mass %.

The methacrylic resin in the present embodiment may include one type of structural unit or two or more types of structural units derived from the other copolymerizable monomers described above.

### ——Methacrylic Resin Containing Hydrogenated Aromatic Ring Structural Unit——

Aside from methacrylic resins having structural units with cyclic structures in the main chain and structural units derived from methacrylic acid ester monomers, methacrylic resins having hydrogenated aromatic ring structural units may be mentioned as methacrylic resins having low birefringence properties satisfying the present embodiment.

As a method for producing a methacrylic resin having hydrogenated aromatic ring structural units, a method is used in which a copolymer of an aromatic vinyl compound and a (meth)acrylate is hydrogenated in the presence of a hydrogenation catalyst and a reaction solvent to produce a nucleus-hydrogenated polymer.

Polymerization of monomers containing an aromatic vinyl compound and a (meth)acrylate may be carried out using known methods, but industrially, radical polymerization is preferable due to its simplicity. Radical polymerization can be carried out by any of the known methods such as bulk polymerization, solution polymerization, emulsion polymerization, or suspension polymerization; however, in order to avoid the inclusion of moisture during the hydrogenation reaction, it is preferable to produce the polymer by bulk or solution polymerization. In the production method in the present embodiment, the polymerization process may, for example, be any of a batch polymerization process, a semi-batch polymerization process, and a continuous polymerization process.

The method for producing a methacrylic resin containing hydrogenated aromatic ring structural units may be as described in JP 2006-291184 A, JP 2014-77043 A, and JP 2014-77044 A.

Hereinafter, one example of a method for producing a methacrylic resin containing hydrogenated aromatic ring structural units, obtained by hydrogenating a copolymer of an aromatic vinyl compound and a (meth)acrylate, will be specifically described.

As the aromatic vinyl compound used for polymerization, specific examples include styrene, α-methylstyrene, vinyltoluene, hydroxymethylstyrene, α-hydroxyethylstyrene, p-hydroxystyrene, alkoxystyrene, and chlorostyrene, with styrene being preferable. It is also possible to copolymerize two or more aromatic vinyl compounds. In particular, using styrene having a substituent at the α-position is preferable because it enhances the heat resistance of the resin.

As for the solvent used for polymerization, it must be stable under the reaction conditions, and in addition, the copolymer (copolymer of the aromatic vinyl compound and (meth)acrylate, and the nucleus-hydrogenated polymer in which the aromatic ring has been hydrogenated) before and after hydrogenation must be highly soluble in the solvent, and the hydrogen must also dissolve well, enabling the reaction to proceed rapidly. Also, assuming solvent volatilization after the reaction, it is important that the solvent has a high flash point. Solvents satisfying these requirements include hydrocarbon compounds such as n-pentane, n-hexane, n-octane, and cyclohexane; ether compounds such as 1,4-dioxane, tetrahydrofuran, ethylene glycol dimethyl ether, and diethylene glycol dimethyl ether; amide compounds such as dimethylformamide and dimethylacetamide; and ester compounds, with ether compounds and ester compounds being particularly suitable. Among ether compounds, tetrahydrofuran is especially preferable. One of these solvents may be used individually, or two or more of these solvents may be used together.

Among ester compounds, carboxylic acid ester compounds are preferable. The carboxylic acid ester compounds include aliphatic ester compounds, and compounds represented by the following general formula (5) are preferable. In the following general formula (5), R₁ is an alkyl group having 1 to 6 carbon atoms, and R₂ is an alkyl group having 1 to 6 carbon atoms. Examples of R₁ and R₂ include methyl, ethyl, propyl, isopropyl, butyl, isobutyl, pentyl, hexyl, and cyclohexyl groups. Examples of ester compounds include methyl acetate, ethyl acetate, n-butyl acetate, pentyl acetate, methyl propionate, ethyl propionate, n-propyl propionate, n-butyl propionate, n-butyl butyrate, isobutyl butyrate, n-butyl n-butyrate, n-valeryl methyl ester, and n-hexanoic acid methyl ester, with methyl acetate, ethyl acetate, methyl propionate, isobutyl butyrate, and n-butyl butyrate being particularly preferable.

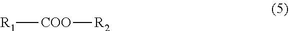

The concentration of the copolymer (copolymer of the aromatic vinyl compound and the (meth)acrylate and the nucleus-hydrogenated polymer in which the aromatic ring is hydrogenated) in the solution during the hydrogenation reaction is usually 1 to 50 wt %, preferably 3 to 30 wt %, and more preferably 5 to 25 wt %. If the concentration of the copolymer is too high, it is undesirable due to reduced reaction speed and handling difficulties caused by increased viscosity. If the concentration is too low, productivity and cost-efficiency become unfavorable.

The water content in the polymer solution before the hydrogenation reaction is 0.5 wt % or less, preferably 0.2 wt % or less, and more preferably 0.05 wt % or less. If the water content exceeds 0.5 wt %, the produced nucleus-hydrogenated polymer (pellet or powder) may become discolored, which is undesirable for optical materials.

During the polymerization reaction, if necessary, a polymerization initiator and a chain transfer agent may be added, but since sulfur inhibits the hydrogenation reaction, it is desirable to minimize sulfur content.

The polymerization initiator is not specifically limited as long as it has no sulfur-containing functional group, any of the polymerization initiators disclosed in relation to the production method of the methacrylic resin including the structural unit derived from an N-substituted maleimide monomer.

One of these polymerization initiators may be used individually, or two or more of these polymerization initiators may be used together.

These polymerization initiators may be added at any stage so long as the polymerization reaction is in progress.

The amount of polymerization initiator that is added can be set as appropriate depending on the combination of monomers, reaction conditions, and so forth, without any specific limitations. However, when the total amount of monomer used in polymerization is taken to be 100 mass %, the amount of polymerization initiator may be 0.05 mass % to 1 mass %.

Preferably, the polymerization initiator and the chain transfer agent may be added in the polymerization step using, for example, the method described in the above-mentioned method of preparing the methacrylic resin including the structural unit derived from an N-substituted maleimide monomer.

The concentration of dissolved oxygen in the polymerization solution may be, for example, a value disclosed in the above-mentioned method of preparing the methacrylic resin including the structural unit derived from an N-substituted maleimide monomer.

The chain transfer agent is not necessarily required. When used, it is preferable to use, for example, tetrahalomethanes such as carbon tetrachloride, carbon tetrabromide, or carbon tetraiodide, or dimers of styrene compounds such as 2,4-diphenyl-4-methyl-1-pentene. Generally used mercaptan-based chain transfer agents are not preferable because they introduce sulfur functional groups at the polymer chain ends, which inhibit the hydrogenation reaction of aromatic rings.

One of these may be used alone, or two or more of these may be used in combination.

These chain transfer agents may be added at any stage, without any specific limitations, so long as the polymerization reaction is in progress.

No specific limitations are placed on the amount of chain transfer agent that is added other than being in a range that enables the desired degree of polymerization under the adopted polymerization conditions. However, when the total amount of monomer used in polymerization is taken to be 100 mass %, the amount of the chain transfer agent is preferably 0.05 mass % to 1 mass %.

In general, if no mercaptan-based chain transfer agent is used, the thermal decomposition resistance of the raw polymer decreases; however, in methacrylic resins containing hydrogenated aromatic ring structural units, physical properties such as decomposition temperature depend only on the degree of hydrogenation, and the use of sulfur-based chain transfer agents does not affect the decomposition temperature if the hydrogenation degree is the same.

The catalyst (hydrogenation catalyst) used for the hydrogenation reaction may be any catalyst having hydrogenation activity and is not particularly limited. Specific examples include nickel, ruthenium, rhodium, palladium, and platinum. Among them, palladium supported on a carrier is particularly preferable because it provides a high reaction rate and ensures that the solvent does not undergo side reactions and is retained before and after the reaction. In general, catalyst supports include activated carbon, alumina (Al₂O₃), silica (SiO₂), silica-alumina (SiO₂-Al₂O₃), diatomaceous earth, and zirconium oxide. There are no limitations on the catalyst support used in the present disclosure, but activated carbon, alumina, or zirconium oxide is preferable.

The supported amount of palladium metal on the carrier is typically in the range of 0.01 to 50 wt %, preferably 0.05 to 20 wt %, and more preferably 0.1 to 10 wt %. From an economic standpoint, it is preferable to minimize the amount of palladium used, which is an expensive metal, but when activated carbon or zirconium oxide is used as the carrier, palladium can be supported with high dispersion, and since the reaction rate per unit of palladium is extremely high, a sufficient reaction rate can be maintained even when the supported amount of palladium is within the range of 0.1 to 1.0% by weight. When measuring the dispersion of palladium, a known method such as the carbon monoxide pulse adsorption method is used.

As the precursor of palladium, known salts or complexes such as palladium chloride, palladium nitrate, and palladium acetate can be used. When impregnating the precursor onto the carrier, the precursor is dissolved in a solution, and examples of combinations of precursor and solvent include palladium chloride/hydrochloric acid aqueous solution, palladium chloride/sodium chloride aqueous solution, palladium nitrate/water, palladium nitrate/hydrochloric acid aqueous solution, palladium acetate/hydrochloric acid aqueous solution, and palladium acetate/organic solvent.

Preferred conditions for the hydrogenation reaction include a temperature of 60 to 250° C., a hydrogen pressure of 3 to 30 MPa, and a reaction time of 3 to 20 hours. If the reaction temperature is too low, the reaction rate slows down; if it is too high, undesirable side reactions such as polymer degradation or solvent hydrogenolysis may occur, which is undesirable. Also, when the hydrogen pressure is too low, the reaction rate slows down, and conversely, increasing the hydrogen pressure requires a high-pressure-resistant reactor, which is not economically preferable.

By separating the hydrogenation catalyst and volatile components (such as solvents) from the polymer solution after the hydrogenation reaction, a core hydrogenated polymer can be obtained.

Separation of the catalyst can be performed by known methods such as filtration or centrifugation. In consideration of coloring, impact on mechanical properties, etc., it is necessary to minimize the concentration of residual catalyst metal in the polymer, preferably 10 ppm or less, and more preferably 1 ppm or less.

After catalyst separation, to purify the polymer by separating volatile components such as solvents from the obtained core hydrogenated polymer solution, it is preferable, from the viewpoint of reducing fluorescence intensity, to perform devolatilization by the devolatilization method described in the preparation method of the methacrylic resin having the structural unit derived from an N-substituted maleimide monomer, followed by pelletizing.

In the case of copolymers of aromatic vinyl compounds and (meth)acrylates, the composition of structural units of the copolymer does not necessarily match the composition of the monomers charged, and is determined by the amount of monomers actually incorporated into the copolymer through the polymerization reaction. If the polymerization rate is 100%, the ratio of structural units in the copolymer matches the charged monomer composition ratio, but in practice, it is often manufactured at a polymerization rate of 50 to 80%, and because monomers with high reactivity are more likely to be incorporated into the copolymer, a discrepancy arises between the charged monomer composition and the copolymer structural unit composition, hence it is necessary to appropriately adjust the charged monomer composition ratio.

In the structural units of the copolymer of aromatic vinyl compounds and (meth)acrylates used in the hydrogenation reaction of the present disclosure, the molar ratio (A/B) of the structural units derived from (meth)acrylate monomers (A mol) to the structural units of aromatic vinyl compound monomers (B mol) is preferably 0.25 or more and 4.0 or less. If the molar ratio (A/B) is less than 0.25, mechanical strength is poor and practical utility may be compromised. If the molar ratio (A/B) exceeds 4.0, the number of aromatic rings subject to hydrogenation is small, and the performance enhancement effect such as improvement in glass transition temperature by the hydrogenation reaction may be insufficient.

The content of structural units derived from such other copolymerizable monomers relative to 100 mass % of the methacrylic resin is preferably 0 mass % to 20 mass %, more preferably less than 10 mass % from the viewpoint of the weather resistance, and even more preferably less than 7 mass %.

The methacrylic resin in the present embodiment may include one type of structural unit or two or more types of structural units derived from the other copolymerizable monomers described above.

### —Production Method of Methacrylic Resin—

The following describes a production method of the methacrylic resin of the present embodiment.

In the production method of the methacrylic resin, a batch, semi-batch, or continuous process can be employed for polymerization. Here, a batch process is a process in which all raw materials are charged into the reactor, then the reaction is started and proceeded, and after completion, the product is recovered. Also, a semi-batch process is a process in which either raw material charging or product recovery is performed concurrently while the reaction is ongoing. Furthermore, a continuous process is a process in which both raw material charging and product recovery are performed concurrently while the reaction is ongoing. As a production method of the methacrylic resin, from the viewpoint of precisely controlling the copolymer composition, a semi-batch process in which part of the raw materials are added after the start of the reaction is preferable.

Although a continuous process can also be used, it is preferably not used as a production method of the methacrylic resin for the reasons described below. The continuous process is advantageous in that the difference in the monomer compositions among fractions with different molecular weights in the methacrylic resin can be reduced when a polymerization reaction is carried out in a single complete mixing reactor. However, unreacted monomers would remain in a large amount after polymerization, which tends to adversely affect the color tone. The amount of unreacted monomers, on the other hand, can be reduced by using a plug flow reactor. However, the difference in monomer compositions among fractions with different molecular weights in the methacrylic resin tends to increase. In a case where a plurality of complete mixing reactors are used or a combination of a complete mixing reactor and a plug flow reactor connected in series is used, the amount of unreacted monomers can also be reduced. However, the difference in monomer compositions among the fractions with different molecular weights tends to increase.

As the polymerization method of the methacrylic resin, there is no particular limitation, and examples include emulsion polymerization, solution polymerization, radical polymerization, anionic polymerization, and cationic polymerization.

There is no particular limitation on the polymerization solvent, and examples include aromatic hydrocarbons such as toluene, xylene, ethylbenzene, isopropylbenzene; esters such as methyl isobutyrate; ketones such as methyl isobutyl ketone, butyl cellosolve, methyl ethyl ketone, cyclohexanone; and polar solvents such as dimethylformamide and 2-methylpyrrolidone.

Moreover, an alcohol such as methanol, ethanol, or isopropanol may be used in combination as the polymerization solvent to the extent that dissolution of the polymerized product during polymerization is not impaired.

The amount of the solvent during polymerization is not particularly limited as long as the polymerization proceeds and precipitation of the copolymer or the used monomer does not occur during production and the solvent can be easily removed, but for example, it is preferably 10 to 200 parts by mass, more preferably 25 to 200 parts by mass, even more preferably 50 to 200 parts by mass, and still more preferably 50 to 150 parts by mass, when the total amount of the monomers to be blended is 100 parts by mass.

The polymerization initiator may be any initiator commonly used in radical polymerization and examples thereof include organic peroxides such as cumene hydroperoxide, diisopropylbenzene hydroperoxide, di-t-butyl peroxide, lauroyl peroxide, benzoyl peroxide, t-butylperoxy isopropyl carbonate, t-amyl peroxy-2-ethylhexanoate, t-amyl peroxyisononanoate, and 1,1-di(t-butylperoxy)cyclohexane; and azo compounds such as 2,2′-azobis(isobutyronitrile), 1,1′-azobis(cyclohexanecarbonitrile), 2,2′-azobis(2,4-dimethylvaleronitrile), and dimethyl-2,2′-azobisisobutyrate.

One of these may be used alone, or two or more of these may be used in combination.

These polymerization initiators may be added at any stage so long as the polymerization reaction is in progress.

The amount of the polymerization initiator added when the total amount of monomers used in polymerization is taken to be 100 parts by mass may be 0.01 parts by mass to 1 part by mass, and is preferably 0.05 parts by mass to 0.5 parts by mass.

The chain transfer agent may be a chain transfer agent that is commonly used in radical polymerization and examples thereof include mercaptan compounds such as n-butyl mercaptan, n-octylmercaptan, n-decyl mercaptan, n-dodecyl mercaptan, and 2-ethylhexyl thioglycolate; halogen compounds such as carbon tetrachloride, methylene chloride, and bromoform; and unsaturated hydrocarbon compounds such as α-methylstyrene dimer, α-terpinene, dipentene, and terpinolene.

One of these may be used alone, or two or more of these may be used in combination.

These chain transfer agents may be added at any stage, without any specific limitations, so long as the polymerization reaction is in progress.

The amount of the chain transfer agent added when the total amount of monomers used in polymerization is taken to be 100 parts by mass may be 0.01 parts by mass to 1 part by mass, and is preferably 0.05 parts by mass to 0.5 parts by mass.

No specific limitations are placed on the method by which a polymerized product is collected from the polymerization solution obtained through solution polymerization. Examples of methods that can be adopted include a method in which the polymerization solution is added into an excess of a poor solvent in which the polymerized product obtained through polymerization does not dissolve, such as a hydrocarbon solvent or an alcohol solvent, treatment (emulsifying dispersion) is subsequently performed using a homogenizer, and unreacted monomers are separated from the polymerization solution by pre-treatment such as liquid-liquid extraction or solid-liquid extraction; and a method in which the polymerization solvent and unreacted monomers are separated by a step referred to as a devolatilization step to collect the polymerized product.

The devolatilization step is a step in which volatile contents such as the polymerization solvent, residual monomers, and reaction by-products are removed under heated and reduced pressure conditions.

Examples of devices that can be used in the devolatilization step include devolatilization devices comprising a tubular heat exchanger and a devolatilization tank; thin film evaporators such as WIPRENE and EXEVA produced by Kobelco Eco-Solutions Co., Ltd., and Kontro and Diagonal-Blade Kontro produced by Hitachi, Ltd.; and vented extruders having sufficient residence time and surface area for exhibiting devolatilization capability.

Moreover, it is possible to adopt a devolatilization step or the like in which a devolatilization device that is a combination of two or more of these devices is used.

From a viewpoint of improving the color tone, it is preferable to use a devolatilization device having a heat exchanger and a decompression vessel as main components thereof without any rotating part in the structure thereof.

Specifically, it is possible to employ a devolatilization apparatus which is configured from a devolatilization tank in a configuration where a decompression unit is attached to a decompression vessel which is sized to be suitable for devolatilization and is provided with a heat exchanger disposed in the upper part thereof, and a discharge device such as a gear pump for discharging a polymerized product after devolatilization.

In this devolatilization apparatus, a polymerization solution is preheated by feeding it to the heat exchanger such as a multi-tube heat exchanger, a plate-fin heat exchanger, and a flat plate heat exchanger having a flat plate channel and a heater, disposed in the upper part of the decompression vessel, and then is fed to the devolatilization tank that is heated under a reduced pressure to separate the copolymer from the polymerization solvent, the mixture of unreacted raw materials, polymerization by-products, and the like. A devolatilization device which does not have any rotating part as described above is preferably used because a methacrylic resin having a good color tone can be obtained.

The treatment temperature in the devolatilization device is preferably 150° C. to 350° C., more preferably 170° C. to 300° C., and even more preferably 200° C. to 280° C. By setting the treatment temperature to be equal to or higher than the lower limit temperature, residual volatile components can be suppressed, and by setting the treatment temperature to be equal to or lower than the upper limit temperature, coloration and decomposition of the resulting methacrylic resin can be suppressed.

### —Additive—

The resin composition forming the resin lens of the reflective polarizer bonded lens of the present embodiment may contain various additives, as long as they do not significantly impair the effects of the present disclosure.

Examples of the additive include, but are not particularly limited to, antioxidants; light stabilizers such as hindered amine based light stabilizers; ultraviolet absorbers; release agents; thermoplastic resins other than methacrylic resins; softeners and plasticizers such as paraffinic process oils, naphthenic process oils, aromatic process oils, paraffin, organic polysiloxanes, and mineral oils; flame retardants; antistatic agents; reinforcers such as organic fibers, inorganic fillers such as pigments including iron oxide, glass fibers, carbon fibers, and metal whiskers; organophosphorus compounds such as phosphite esters, phosphonites, and phosphate esters; and mixtures of any of the preceding examples.

### ——Antioxidant——

The resin composition forming the resin lens of the reflective polarizer bonded lens of the present embodiment preferably contains an antioxidant that suppresses deterioration and discoloration during molding or use.

Examples of the antioxidant include, but are not limited to, hindered phenol-based antioxidants, phosphorus-based antioxidants, and sulfur-based antioxidants. In the resin composition of the present embodiment, in order to highly control distortion and warping on the surface of the molded article, it is essential to maintain the resin at a high temperature in the mold cavity and provide an appropriate cooling time. When exposed to a long thermal history, it is necessary to increase the amount of heat stabilizer to obtain the desired thermal stability, but from the viewpoint of suppressing bleed-out of the heat stabilizer and preventing adhesion to the mold, it is preferable to use a combination of multiple types of heat stabilizers, such as at least one selected from phosphorus-based antioxidants and sulfur-based antioxidants, and a hindered phenol-based antioxidant.

These antioxidants may be used alone or in combination of two or more.

Examples of the hindered phenol-based antioxidant include, but are not specifically limited to, pentaerythritol tetrakis[3-(3,5-di-tert-butyl-4-hydroxyphenyl)propionate], thiodiethylene bis[3-(3,5-di-tert-butyl-4-hydroxyphenyl)propionate], octadecyl-3-(3,5-di-tert-butyl-4-hydroxyphenyl)propionate, 3,3′,3″,5,5′,5″-hexa-tert-butyl-a, a′, a″-(mesitylene-2,4,6-triyl)tri-p-cresol, 4,6-bis(octylthiomethyl)-o-cresol, 4,6-bis(dodecylthiomethyl)-o-cresol, ethylenebis(oxyethylene)bis[3-(5-tert-butyl-4-hydroxy-m-tolyl) propionate], hexamethylene bis[3-(3,5-di-tert-butyl-4-1,3,5-tris(3,5-di-tert-butyl-4-hydroxybenzyl)-hydroxyphenyl)propionate], 1,3,5-triazine-2,4,6 (1H,3H,5H)-trione, 1,3,5-tris[(4-tert-butyl-3-hydroxy-2,6-xylene)methyl]-1,3,5-triazine-2,4,6 (1H,3H,5H)-trione, 2,6-di-tert-butyl-4-(4,6-bis(octylthio)-1,3,5-triazin-2-ylamine) phenol, 2-[1-(2-hydroxy-3,5-di-tert-pentylphenyl)ethyl]-4,6-di-tert-pentylphenyl acrylate, and 2-tert-butyl-4-methyl-6-(2-hydroxy-3-tert-butyl-5-methylbenzyl)phenyl acrylate.

In particular, among these, pentaerythritol tetrakis[3-(3,5-di-tert-butyl-4-hydroxyphenyl)propionate], octadecyl-3-(3,5-di-t-butyl-4-hydroxyphenyl)propionate, and 2-[1-(2-hydroxy-3,5-di-tert-pentylphenyl)ethyl]-4,6-di-tert-pentylphenyl acrylate are preferable.

Also, a commercially available phenol-based antioxidant may be used as the hindered phenol-based antioxidant for the above-described antioxidant. Examples of such commercially available phenol-based antioxidants include, but are not specifically limited to, Irganox 1010; pentaerythritol tetrakis[3-(3,5-di-t-butyl-4-hydroxyphenyl)propionate]; produced by BASF), Irganox 1076 (octadecyl-3-(3,5-di-t-butyl-4-hydroxyphenyl)propionate; produced by BASF), Irganox 1330 (3,3′,3″,5,5′,5″-hexa-t-butyl-α,α′,α″-(mesitylene-2,4,6-triyl)tri-p-cresol; produced by BASF), Irganox 3114 (1,3,5-tris(3,5-di-t-butyl-4-hydroxybenzyl)-1,3,5-triazine-2,4,6 (1H,3H,5H)-trione; produced by BASF), Irganox 3125 (produced by BASF), ADK STAB AO-60 (pentaerythritol tetrakis[3-(3,5-di-t-butyl-4-hydroxyphenyl)propionate]; produced by Adeka Corporation), ADK STAB AO-80 (3,9-bis {2-[3-(3-t-butyl-4-hydroxy-5-methylphenyl)propionyloxy]-1,1-dimethylethyl}-2,4,8,10-tetraoxaspiro[5.5]undecane; produced by Adeka Corporation), Sumilizer BHT (produced by Sumitomo Chemical Co., Ltd.), Cyanox 1790 (produced by Cytec Solvay Group), Sumilizer GA-80 (produced by Sumitomo Chemical Co., Ltd.), Sumilizer GS (2-[1-(2-hydroxy-3,5-di-tert-pentylphenyl)ethyl]-4,6-di-tert-pentylphenyl)acrylate; produced by Sumitomo Chemical Co., Ltd.), Sumilizer GM (2-tert-butyl-4-methyl-6-(2-hydroxy-3-tert-butyl-5-methylbenzyl)phenyl acrylate; produced by Sumitomo Chemical Co., Ltd.), and vitamin E (produced by Eisai Co., Ltd.).

Among these commercially available phenol-based antioxidants, Irganox 1010, ADK STAB AO-60, ADK STAB AO-80, Irganox 1076, Sumilizer GS, and the like are preferable in terms of thermal stability imparting effect in the resin.

One of these may be used alone, or two or more of these may be used in combination.

Phosphorus-based antioxidants that can be used as the heat stabilizer may be, but are not limited to, tris(2,4-di-t-butylphenyl)phosphite, bis(2,4-bis(1,1-dimethylethyl)-6-methylphenyl)ethyl ester phosphorous acid, tetrakis(2,4-di-t-butylphenyl)(1,1-biphenyl)-4,4′-diyl bisphosphonite, bis(2,4-di-t-butylphenyl)pentaerythritol diphosphite, bis(2,6-di-t-butyl-4-methylphenyl)pentaerythritol diphosphite, bis(2,4-dicumylphenyl)pentaerythritol diphosphite, tetrakis(2,4-t-butylphenyl)(1,1-biphenyl)-4,4′-diyl bisphosphonite, di-t-butyl-m-cresyl-phosphonite, and 4-[3-[(2,4,8,10-tetra-tert-butyldibenzo[d,f][1,3,2]dioxaphosphepin)-6-yloxy]propyl]-2-methyl-6-tert-butylphenol.

Furthermore, commercially available phosphorus-based antioxidants may be used as the phosphorus-based antioxidant. Examples of such commercially available phosphorus-based antioxidants include, but are not limited to, Irgafos 168 (tris(2,4-di-t-butylphenyl)phosphite; produced by Irgafos 12 (tris[2-[[2,4,8,10-tetra-t-BASF), butyldibenzo[d,f][1,3,2]dioxaphosphepin-6-yl]oxy]ethyl]amine; produced by BASF), Irgafos 38 (bis(2,4-bis(1,1-dimethylethyl)-6-methylphenyflethyl phosphite, produced by BASF), ADK STAB 329K (ADK STAB-229K, produced by Adeka Corporation), ADK STAB PEP-36 (ADK STAB PEP-36, produced by Adeka Corporation), ADK STAB PEP-36A (ADK STAB PEP-36A, produced by Adeka Corporation), ADK STAB PEP-8 (ADK STAB PEP-8, produced by Adeka Corporation), ADK STAB HP-10 (ADK STAB HP-10, produced by Adeka Corporation), ADK STAB 2112 (ADK STAB 2112, produced by Adeka Corporation), ADK STAB 1178 (ADK STAB 1178, produced by Adeka Corporation), ADK STAB 1500 (ADK STAB 1500, produced by Adeka Corporation), Sandstab P-EPQ (produced by Cryant Corporation), Weston 618 (produced by GE Corporation), Weston 619G (produced by GE Corporation), Ultranox 626 (produced by GE Corporation), Sumilizer GP (4-[3-[(2,4,8,10-tetra-tert-butyldibenzo[d,f][1,3,2]dioxaphosphepin)-6-iloxy]propyl]-2-methyl-6-tert-butylphenol, produced by Sumitomo Chemical Co., Ltd.), HCA (9,10-dihydro-9-oxa-10-phosphaphenanthrene-10-oxide, produced by Sanko Co., Ltd.), and so forth.

Among these commercially available phosphorus-based antioxidants, from a viewpoint of an effect of imparting thermal stability in the resin and an effect of using in combination with various antioxidants, Irgafos 168, ADK STAB PEP-36, ADK STAB PEP-36A, ADK STAB HP-10, and ADK STAB 1178 are preferable, and ADK STAB PEP-36 and ADK STAB PEP-36A are particularly preferable.

One phosphorus-based antioxidant may be used alone, or two or more phosphorus-based antioxidants may be used in combination.

Examples of sulfur-based antioxidants that can be used as the antioxidant include, but are not specifically limited to, 2,4-bis(dodecylthiomethyl)-6-methylphenol (Irganox 1726 produced by BASF), Irganox 1520L (produced by BASF), 2,2-bis[[3-(dodecylthio)-1-oxopropoxy]methyl]propane-1,3-diyl bis[3-(dodecylthio)propionate](ADK STAB AO-412S produced by Adeka Corporation), 2,2-bis[[3-(dodecylthio)-1-oxopropoxy]methyl]propane-1,3-diyl bis[3-(dodecylthio) propionate](KEMINOX PLS produced by Chemipro Kasei Kaisha, Ltd.), and di(tridecyl)-3,3′-thiodipropionate (AO-503 produced by Adeka Corporation).

Among these commercially available sulfur-based antioxidants, ADK STAB AO-412S and KEMINOX PLS are preferable from a viewpoint of an effect of imparting thermal stability in the resin, an effect of using in combination with various antioxidants, and handleability.

One of these sulfur-based antioxidants may be used alone, or two or more of these sulfur-based antioxidants may be used in combination.

Although the content of the antioxidant can be any amount that enables an effect of thermal stability improvement to be obtained, an excessive content may lead to problems such as bleed-out during processing. Accordingly, the content of the thermal stabilizer per 100 parts by mass of the methacrylic resin is preferably 5 parts by mass or less, more preferably 3 parts by mass or less, even more preferably 1 part by mass or less, further preferably 0.8 parts by mass or less, even further preferably 0.01 parts by mass to 0.8 parts by mass, and particularly preferably 0.01 parts by mass to 0.5 parts by mass.

### ——Hindered Amine-Based Light Stabilizer ——

The resin composition forming the resin lens of the reflective polarizer bonded lens of the present embodiment may contain an hindered amine-based light stabilizer.

The hindered amine-based light stabilizer is not specifically limited, but is preferably a compound including three or more cyclic structures. Here, it is preferable that the cyclic structures are at least one selected from the group consisting of aromatic rings, aliphatic rings, aromatic heterocycles, and nonaromatic heterocycles; and in a case in which one compound includes two or more cyclic structures, these cyclic structures may be either identical to or different from each other.

Specific examples of the hindered amine-based light stabilizer include, but are not limited to, bis(1,2,2,6,6-pentamethyl-4-piperidyl) [[3,5-bis(1,1-dimethylethyl)-4-hydroxyphenyl]methyl]butylmalonate; a mixture of bis(1,2,2,6,6-pentamethyl-4-piperidyl) sebacate and methyl-1,2,2,6,6-pentamethyl-4-piperidyl sebacate; bis(2,2,6,6-tetramethyl-4-piperidyl) sebacate; N,N′-bis(2,2,6,6-tetramethyl-4-piperidyl)-N,N′-diformylhexamethylenediamine; polycondensates of dibutylamine, 1,3,5-triazine, and N,N′-bis(2,2,6,6-tetramethyl-4-piperidyl-1,6-hexamethylenediamine with N-(2,2,6,6-tetramethyl-4-piperidyl)butylamine; poly[{6-(1,1,3,3-tetramethylbutyl)amino-1,3,5-triazine-2,4-diyl}{(2,2,6,6-tetramethyl-4-piperidyl)imino}hexamethylene {(2,2,6,6-tetramethyl-4-piperidy)imino}]; tetrakis(1,2,2,6,6-pentamethyl-4-piperidyl)butane-1,2,3,4-tetracarboxylate; tetrakis(2,2,6,6-tetramethyl-4-piperidyl)butane-1,2,3,4-tetracarboxylate; reactants of 1,2,2,6,6-pentamethyl-4-piperidiol and β,β,β′,β′-tetramethyl-2,4,8,10-tetraoxaspiro[5.5]undecane-3,9-diethanol; reactants of 2,2,6,6-tetramethyl-4-piperidiol and β,β,β′,β′-tetramethyl-2,4,8,10-tetraoxaspiro[5.5]undecane-3,9-diethanol; bis(1-undecanoxy-2,2,6,6-tetramethylpiperidine-4-il) carbonate; 1,2,2,6,6-pentamethyl-4-piperidyl methacrylate; and 2,2,6,6-tetramethyl-4-piperidyl methacrylate.

Among these, preferable examples include bis(1,2,2,6,6-pentamethyl-4-piperidyl) [[3,5-bis(1,1-dimethylethyl)-4-hydroxyphenyl]methyl]butylmalonate; polycondensates of dibutylamine, 1,3,5-triazine, and N,N′-bis(2,2,6,6-tetramethyl-4-piperidyl-1,6-hexamethylenediamine with N-(2,2,6,6-tetramethyl-4-piperidyl)butylamine; poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; reactants of 1,2,2,6,6-pentamethyl-4-piperidiol and β,β,β′,β′-tetramethyl-2,4,8,10-tetraoxaspiro[5.5]undecane-3,9-diethanol; and reactants of 2,2,6,6-tetramethyl-4-piperidiol and β,β,β′,β′-tetramethyl-2,4,8,10-tetraoxaspiro[5.5]undecane-3,9-diethanol, which include three or more cyclic structures.

Although the content of the hindered amine-based light stabilizer can be any amount that enables an effect of light stability improvement to be obtained, an excessive content may lead to problems such as bleed-out during processing. Accordingly, the content of the hindered amine based light stabilizer per 100 mass % of the methacrylic resin is preferably 5 mass % or less, more preferably 3 mass % or less, even more preferably 1 mass % or less, further preferably 0.8 mass % or less, even further preferably 0.01 mass % to 0.8 mass %, and particularly preferably 0.01 mass % to 0.5 mass %.

### ——Ultraviolet Absorber ——

The resin composition forming the resin lens of the reflective polarizer bonded lens of the present embodiment may contain an ultraviolet absorber.

Although no specific limitations are placed on ultraviolet absorbers that can be used, an ultraviolet absorber having a maximum absorption wavelength in the range of 280 nm to 380 nm is preferable. Examples of ultraviolet absorbers that can be used include benzotriazole compounds, benzotriazine compounds, benzophenone compounds, oxybenzophenone compounds, benzoate compounds, phenolic compounds, oxazole compounds, cyanoacrylate compounds, and benzoxazinone compounds.

These ultraviolet absorbers may be used alone or in combination of two or more.

Particularly from a viewpoint of compatibility with resins and volatility during heating, the ultraviolet absorber is preferably a benzotriazole compound having a molecular weight of 400 or more or a benzotriazine compound, and from a viewpoint of inhibiting decomposition of the ultraviolet absorber under heating during extrusion, the ultraviolet absorber is particularly preferably a benzotriazine compound.

The amount of the ultraviolet absorber is not specifically limited so long as the disclosed effects can be exhibited without impairing heat resistance, damp heat resistance, thermal stability, and molding properties. Nevertheless, the amount of the ultraviolet absorber relative to 100 parts by mass of the methacrylic resin is preferably 0.1 to 5 parts by mass, more preferably 0.2 to 4 parts by mass, even more preferably 0.25 to 3 parts by mass, and still more preferably 0.3 to 3 parts by mass. When the amount of the ultraviolet absorber is within one of the ranges set forth above, an excellent balance of ultraviolet light absorption performance, molding properties, and so forth can be obtained.

### ——Release Agent ——

The resin composition forming the resin lens of the reflective polarizer bonded lens of the present embodiment may contain a release agent. Examples of the release agent include, but are not limited to, fatty acid esters, fatty acid amides, fatty acid metal salts, hydrocarbon-based lubricants, alcohol-based lubricants, polyalkylene glycols, carboxylic acid esters, and paraffin-based mineral oils of and hydrocarbons.

These release agents may be used alone or in combination of two or more.

Fatty acid esters that can be used as the release agent are not specifically limited, and may be conventionally known ones.

Examples of the fatty acid ester include ester compounds of a fatty acid having 12 to 32 carbon atoms such as lauric acid, palmitic acid, heptadecanoic acid, stearic acid, oleic acid, arachidic acid, behenic acid, etc., and a monovalent aliphatic alcohol such as palmityl alcohol, stearyl alcohol, behenyl alcohol, etc., or a multivalent aliphatic alcohol such as glycerin, pentaerythritol, dipentaerythritol, sorbitan, etc.; and complex ester compounds of a fatty acid, a polybasic organic acid, and a monovalent aliphatic alcohol or a multivalent aliphatic alcohol.

Examples of such a fatty acid ester include cetyl palmitate, butyl stearate, stearyl stearate, stearyl citrate, glycerin monocaprylate, glycerin monocaprate, glycerin monolaurate, glycerin monopalmitate, glycerin dipalmitate, glycerin monostearate, glycerin distearate, glycerin tristearate, glycerin monooleate, glycerin dioleate, glycerin trioleate, glycerin monolinoleate, glycerin monobehenate, glycerin mono(12-hydroxy) stearate, glycerin di(12-hydroxy) stearate, glycerin tri(12-hydroxy) stearate, glycerin diacetomonostearate, glycerin citric acid fatty acid ester, pentaerythritol adipic acid stearic acid ester, montanic acid partially saponified ester, pentaerythritol tetrastearate, dipentaerythritol hexastearate, and sorbitan tristearate.

One fatty acid ester may be used alone, or two or more fatty acid ester based lubricants may be used in combination.

Examples of commercially available products include RIKEMAL series, Poem series, Rikester series, and Rikemaster series produced by Riken Vitamin Co., Ltd., Excel series, Rheodol series, Exceparl series, and Coconad series produced by Kao Corporation. Specific examples include RIKEMAL S-100, RIKEMAL H-100, Poem V-100, RIKEMAL B-100, RIKEMAL HC-100, RIKEMAL S-200, Poem B-200, Rikester EW-200, Rikester EW-400, Excel S-95, and Rheodol MS-50.

Although the content of the release agent can be any amount as long as an effect as a release agent can be obtained, and an excessive content may lead to problems such as bleed-out and extrusion defects due to screw slippage during processing. Accordingly, the content of the release agent is preferably 5 parts by mass or less, more preferably 3 parts by mass or less, even more preferably 1 parts by mass or less, further preferably 0.8 parts by mass or less, even further preferably 0.01 to 0.8 parts by mass, particularly preferably 0.01 to 0.5 parts by mass per 100 parts by mass of the methacrylic resin. When added in an amount within the above-mentioned range, a decrease in transparency due to the addition of the mold release agent can be suppressed, and mold release defects during injection molding also tend to be reduced.

### ——Other Thermoplastic Resins ——

The resin composition forming the reflective polarizer bonded lens of the present embodiment may also contain other thermoplastic resins (hereinafter also simply referred to as “other thermoplastic resins”) for the purpose of adjusting birefringence or improving flexibility, without impairing the object of the present disclosure.

Examples of other thermoplastic resins include polyacrylates such as polybutyl acrylate; styrene polymers such as polystyrene, styrene-methyl methacrylate copolymer, styrene-butyl acrylate copolymer, styrene-acrylonitrile copolymer, and acrylonitrile-butadiene-styrene block copolymer; acrylic rubber particles having a three- or four-layer structure described in JP S59-202213 A, JP S63-27516 A, JP S51-129449 A, and JP S52-56150 A; rubbery polymers disclosed in JP S60-17406 B and JP H8-245854 A; and methacrylic rubber-containing graft copolymer particles obtained by multi-step polymerization described in WO 2014/002491 A1.

Among these, from a viewpoint of obtaining good optical properties and mechanical properties, it is preferable to use a styrene-acrylonitrile copolymer or rubber-containing graft copolymer particles having a grafted portion in a surface layer thereof with a chemical composition that is compatible with the methacrylic resin including the structural unit (X) having a cyclic structure.

The average particle diameter of acrylic rubber particles, methacrylic rubber-containing graft copolymer particles, or a rubbery polymer such as described above is preferably 0.03 to 1 μm, and more preferably 0.05 to 0.5 μm from a viewpoint of improving impact strength, optical properties, and so forth of a molded article obtained using the composition of the present embodiment.

The content of other thermoplastic resin relative to 100 parts by mass of the methacrylic resin is 0 to 50 parts by mass, and more preferably 0 to 25 parts by mass.

### ((Cycloolefin-Based Resin Composition))

As the resin composition that forms the resin lens of the reflective polarizer bonded lens of the present embodiment, a cycloolefin-based resin composition is also preferable. Note that the cyclopolyolefin-based resin composition refers to a resin composition containing cycloolefins, and examples thereof include, for example, a homopolymer of a cycloolefin monomer or a copolymer or terpolymer of cycloolefin monomers and other monomers copolymerizable with the cycloolefins.

As the cycloolefin monomer, any cyclic hydrocarbon having an ethylene-type unsaturated bond and a bicyclic ring can be used, and in particular, hydrocarbons having a norbornene skeleton (bicyclo[2.2.1]-2-heptene) are preferable. As the cyclic olefin, specific examples include: bicyclo[2.2.1]-2-heptene (norbornene) and derivatives thereof; tricyclo[4.3.0.1^{2,5}]-3-decene and derivatives thereof; tricyclo[4.4.0.1^{2,5}]-3-undecene and derivatives thereof; tetracyclo[4.4.0.1^{2,5}.1^{7,10},]-3-dodecene (tetracyclododecene) and derivatives thereof; pentacyclo[6.5.1.1^{3,6}.0^{2,7}.0^{9,13}]-4-pentadecene and derivatives thereof; pentacyclo[7.4.0.1^{2,5}.1^{9,12}.0^{8,13}]-3-pentadecene and derivatives thereof; pentacyclo[6.5.1.1^{3,6}.0^{2,7}.0^{9,13}]-4,10-pentadecadiene and derivatives thereof; pentacyclo[8.4.0.1^{2,5}.1^{9,12}.0^{8,13}]-3-hexadecene and derivatives thereof; and tetracyclo[9.2.1.0^{2,10}.0^{3,8}]tetradeca-3,5,7,12-tetraene (methanotetrahydrofluorene) and derivatives thereof, but are not limited thereto. The cyclic olefin may have a polar group such as an ester group, a carboxyl group, or a carboxylic acid anhydride group as a substituent. Among these, it is preferable that the cyclic olefin is at least one selected from bicyclo[2.2.1]-2-heptene and tetracyclo[4.4.0.1^{2,5}.1^{7,10}]-3-dodecene.

In the present disclosure, the term “norbornene-based monomer” refers to a monomer having a norbornene skeleton, and includes, for example, norbornene and derivatives thereof, tetracyclododecene-based monomers, and methanotetrahydrofluorene-based monomers. Here, the term “tetracyclododecene-based monomer” refers to tetracyclododecene and derivatives thereof. Also, the term “methanotetrahydrofluorene-based monomer” refers to methanotetrahydrofluorene and monomers thereof.

Examples of other monomers that can be copolymerized with the cyclic olefin include α-olefins such as ethylene, propylene, 1-butene, 1-pentene, 3-methyl-1-butene, 1-hexene, and 4-methyl-1-pentene; and non-conjugated dienes such as 1,4-hexadiene, 4-methyl-1,4-hexadiene, 5-methyl-1,4-hexadiene, and 1,7-octadiene. Among these, α-olefins are preferable as other monomers that can be copolymerized with the cyclic olefin.

It is preferable that the resin lens is made of a resin composition containing a cyclic olefin copolymer. It is more preferable that the resin lens is made of a resin composition containing a cyclic olefin copolymer which is a copolymer of ethylene or an α-olefin and a cyclic olefin.

Examples of the α-olefin include propylene, 1-butene, 1-pentene, 4-methyl-1-pentene, 1-hexene, 1-octene, 1-decene, and 1-dodecene.

Examples of the cyclic olefin include cyclic olefins such as bicyclo[2.2.1]-2-heptene described above.

In the resin composition containing a cyclic olefin copolymer, the proportion of the ring skeleton structural units in the main chain derived from the cyclic polyolefin in the cyclic olefin copolymer is preferably 36 mol % or more and 50 mol % or less.

In the resin composition containing a cyclic olefin copolymer, it is preferable that the structural units derived from the cyclic olefin in the cyclic polyolefin copolymer are structural units derived from at least one compound selected from bicyclo[2.2.1]-2-heptene and tetracyclo[4.4.0.1^{2,5}.1^{7,10}]-3-dodecene.

It is also preferable that the resin lens is made of a resin composition containing a hydrogenated product of a ring-opening polymer of a norbornene-based monomer.

When the resin lens is made of a resin composition containing a hydrogenated product of a ring-opening polymer of a norbornene-based monomer, it is more preferable that the resin composition contains 20 to 100 mol % of structural units derived from the norbornene-based monomer and optionally 0 to 80 mol % of structural units derived from other monomers that can be copolymerized with the norbornene-based monomer.

Further, when the resin lens is made of a resin composition containing a hydrogenated product of a ring-opening polymer of a norbornene-based monomer, it is preferable that the structural units derived from the norbornene-based monomer include 15 to 50 wt % of structural units derived from a tetracyclododecene-based monomer, 50 to 90 wt % of structural units derived from a methanotetrahydrofluorene-based monomer, and 1 to 15 wt % of structural units derived from a norbornene monomer (when the sum of the structural units derived from each monomer is 100 wt % or less).

### (Properties, etc. of Resin Composition)

In the resin composition that forms the resin lens of the reflective polarizer bonded lens according to the present embodiment, the content of residual solvent (residual solvent content) is preferably less than 1000 ppm by mass, more preferably less than 800 ppm by mass, and even more preferably less than 700 ppm by mass.

Here, the “residual solvent” refers to a polymerization solvent (except for alcohols) that is used in polymerization and a solvent used to prepare a solution by redissolution of the resin obtained in the polymerization. Specific examples of the polymerization solvent include aromatic hydrocarbons such as toluene, xylene, ethylbenzene, and isopropylbenzene; ketones such as methyl isobutyl ketone, Butyl cellosolve, methyl ethyl ketone, and cyclohexanone; and polar solvents such as dimethylformamide and 2-methylpyrrolidone. Examples of the solvent used for redissolution include toluene, methyl ethyl ketone, and methylene chloride.

In the resin composition that forms the resin lens of the reflective polarizer bonded lens according to the present embodiment, the content of residual alcohols (residual alcohol content) is preferably less than 500 ppm by mass, more preferably less than 400 ppm by mass, and even more preferably less than 350 ppm by mass. Here, the “residual alcohols” refer to alcohols that are by-produced through cyclization condensation, and specific examples thereof include aliphatic alcohols such as methanol, ethanol, and isopropanol.

The residual solvent content and the residual alcohol content can be measured by gas chromatography.

### —Glass Transition Temperature—

The glass transition temperature (Tg) of the resin composition that forms the resin lens of the reflective polarizer bonded lens according to the present embodiment is preferably 115° C. to 160° C. The glass transition temperature (Tg) is more preferably 115° C. to 155° C., even more preferably 115° C. to 150° C., and most preferably 120° C. to 150° C.

The glass transition temperature can be measured by the midpoint method according to JIS K 7121. By setting the glass transition temperature of the above-described resin composition to 115° C. or higher, heat resistance can be ensured even under heat generation from electronic devices of a head-mounted display and under high-temperature environments such as some outdoor or in-vehicle conditions; moreover, even in processes where heat is applied during bonding of the reflective polarizer, dimensional changes are prevented, making it preferable in terms of achieving good adhesion.

Furthermore, by suppressing deformation, photoelastic birefringence generated due to tension, etc., at the bonding interface between the reflective polarizer and the resin lens can also be suppressed, which is preferable. The glass transition temperature (Tg) of the resin composition is more preferably 120° C. or higher, even more preferably 125° C. or higher, and most preferably 130° C. or higher.

On the other hand, when the glass transition temperature (Tg) of the resin composition is 160° C. or lower, melt processing at an extremely high temperatures can be avoided to thereby reduce thermal decomposition of the resin or the like, enabling the provision of favorable products. The glass transition temperature (Tg) is preferably 155° C. or lower, more preferably 150° C. or lower, and even more preferably 140° C. or lower, because these ranges provide enhanced effects as described above.

When the glass transition temperature exceeds 160° C., in the injection molding process described later, although the mold temperature needs to be kept high to reduce birefringence of the resin lens, it becomes necessary to lengthen the cooling time to suppress deformation such as sink marks when removing the resin lens, which prolongs the cycle time; in addition, the large temperature difference from room temperature leads to rapid cooling, which may leave residual strain in the resin lens, which is undesirable from the viewpoint of sufficiently reducing birefringence.

### ——Flexural Strength ——

The resin composition forming the resin lens undergoes expansion or contraction due to heat or moisture absorption by each of the resin lens and the reflective polarizer, and during this time, bending stress is generated due to differences in dimensional change. This may cause cracks or fractures in the resin lens of the reflective polarizer bonded lens. To prevent such defects, high flexural strength is preferable. The flexural strength of the resin composition is preferably 65 MPa or more. The flexural strength is more preferably 75 MPa or more, and even more preferably 85 MPa or more. When the flexural strength is within this range, cracks or other defects are less likely to occur in the resin lens even when the reflective polarizer bonded lens is subjected to a reliability test.

Note that the flexural strength is a value measured in accordance with ISO 178 and can be specifically measured by the method described in the examples below.

### —Flexural Modulus—

The resin composition used in the present embodiment undergoes expansion or contraction due to heat or moisture absorption by the resin lens and the reflective polarizer, and during this time, bending stress is generated due to differences in dimensional change. This may cause the resin lens of the reflective polarizer bonded lens to deform and not maintain the intended shape according to the optical design. To prevent such defects, a high flexural modulus is preferable. The flexural modulus is preferably 2500 MPa or more. The flexural modulus is more preferably 3000 MPa or more, and even more preferably 3300 MPa or more. When the flexural modulus is within this range, the surface shape of the resin lens is less likely to be altered by bending stress even when the reflective polarizer bonded lens is subjected to a reliability test.

Note that the flexural modulus is a value measured in accordance with ISO 178 and can be specifically measured by the method described in the examples below.

### [Method for Producing Resin Lens of Reflective Polarizer Laminated Lens]

The resin lens of the reflective polarizer bonded lens of the present embodiment is formed by molding the above-described resin composition. As the method for producing the resin lens of the present embodiment, a molding method such as injection molding, compression molding, or extrusion molding can be used. Among these, from a viewpoint of productivity, injection molding is preferable.

Typically, the injection molding method includes (1) an injection step of melting a resin and filling the cavity in a temperature-controlled mold with the molten resin; (2) a pressure maintaining step of applying a pressure to the cavity until the gate is sealed, and injecting an additional resin in the amount corresponding to the volume of contraction of the molten resin which was filled in the injection step, the contraction being induced by cooling of the resin when brought into contact with the mold; (3) a cooling step of the maintained pressure is released and then holding the shaped article until the resin is cooled; and (4) a step of opening the mold and taking out the shaped article that has been cooled.

In the method for producing the resin lens, it is preferable that the temperature setting from the nozzle tip to the center of the cylinder of the injection molding machine is in the range of Tg+100° C. to Tg+180° C., more preferably in the range of Tg+110° C. to Tg+160° C., and even more preferably in the range of Tg+120° C. to Tg+150° C., based on the glass transition temperature (Tg) of the methacrylic resin composition used.

Here, the molding temperature refers to the control temperature of a band heater wound around an injection nozzle. By setting the above temperature range, it becomes possible to perform molding under a condition in which the molten resin flows sufficiently and degradation due to thermal decomposition of the resin is suppressed. The higher the molding temperature, the higher the fluidity of the resin becomes, making it less likely for orientation birefringence to occur. However, under high temperatures, the thermal decomposition of the resin adversely affects hue, transmittance, and haze, and also generates gas during injection molding, which fills the mold cavity, and the gas pushed into uneven portions during resin filling is not discharged, thereby hindering resin filling and resulting in poor mold transferability. The molding temperature should be appropriately selected while observing the condition of the resin lens.

The mold temperature is preferably within the range of Tg−70° C. to Tg, and more preferably within the range of Tg−50° C. to Tg−20° C., based on the glass transition temperature (Tg) of the resin composition.

By raising the mold temperature to around Tg, birefringence of the resin lens can be reduced; however, on the other hand, the resin is more likely to adhere to the mold, which may cause deterioration in surface accuracy of the lens or delays in the process due to resin chipping or cracking at the gate portion caused by adhesion, thus the mold temperature should be appropriately selected.

Further, the injection rate can be appropriately selected depending on the thickness and the dimensions of the resin lens to be produced, and can be appropriately selected from the range of 2 to 1000 mm/sec, for example. Further, the maintained pressure can be appropriately selected depending on the shape of the resin lens to be produced, and can be appropriately selected from the range of 30 to 120 MPa, for example.

Here, the maintained pressure refers to a pressure maintained by a screw which feeds an additional molten resin from the gate after filling of the molten resin.

In addition, in order to relieve residual stress caused by injection molding and to reduce the phase difference of the resin lens, an annealing step may be performed. The annealing temperature is preferably in the range of Tg−50° C. to Tg, and more preferably in the range of Tg−30° C. to Tg−10° C., based on the glass transition temperature (Tg) of the resin composition.

### —Provision of Phase Difference Layer to Resin Lens—

A phase difference layer may be provided on the surface of the resin lens. For example, a phase difference layer for a desired wavelength can be provided by coating a liquid crystal polymer. Preferred coatings for forming the phase difference layer include linearly photopolymerizable polymer (LPP) materials and liquid crystal polymer (LCP) materials as described in US 2002/0180916 A1, US 2003/028048 B1, and US 2005/0072959 A1.

### (Method for Producing Resin Composition)

The method for producing the resin composition that forms the resin lens is not particularly limited as long as the resulting composition satisfies the requirements of the present disclosure. Examples include, for example, a method of kneading using a kneading machine such as an extruder, a heating roller, a kneader, a roller mixer, or a Banbury mixer. Kneading by an extruder is preferable in terms of productivity. The kneading temperature may be set in accordance with the preferable processing temperature of the polymer forming the methacrylic resin and any other resins mixed therewith. As a guideline, the kneading temperature may be within a range of 140° C. to 300° C., and preferably a range of 180° C. to 280° C. Moreover, it is preferable that the extruder includes a vent port in order to reduce volatile content.

Whichever method is selected, the composition is preferably produced after reducing the contents of oxygen and water as much as possible.

For example, the concentration of dissolved oxygen in a polymerization solution in solution polymerization is preferably less than 300 ppm in the polymerization step, and in a production method in which an extruder or the like is used, the oxygen concentration inside the extruder is preferably less than 1 volume %, and more preferably less than 0.8 volume %. The water content in the methacrylic resin is adjusted to preferably 1,000 ppm by mass or less, and more preferably 500 ppm by mass or less.

Values within any of the ranges set forth above are beneficial in that it becomes relatively easy to produce a composition that satisfies the requirements of this disclosure.

### <Method for Manufacturing Reflective Polarizer Bonded Lens>

The method for producing the reflective polarizer bonded lens according to the present embodiment is a method for producing a reflective polarizer bonded lens in which a reflective polarizer is bonded to a resin lens,
the resin lens being a resin lens made of a resin composition having a glass transition temperature (Tg) of 115° C. to 160° C.,
the resin lens having a first surface and a second surface on opposite sides, the method comprising:
forming a silane coupling reagent layer on at least one of the resin lens and the reflective polarizer;
providing an adhesive layer on at least one of the resin lens and the reflective polarizer; and
bonding the reflective polarizer to the resin lens.

According to the above-described method for producing a reflective polarizer bonded lens, a reflective polarizer bonded lens can be produced in which at least one delamination or cracking of the reflective polarizer is suppressed even after a reliability test under a severe high-temperature and high-humidity environment.

In the above-described production method, the bonding the reflective polarizer to the resin lens is preferably performed in a temperature range of Tg_{film}−40° C. to Tg_{film}+120° C. based on the glass transition temperature Tg_{film} of the substrate film. By setting the temperature for bonding the reflective polarizer to the resin lens within this range, good adhesion between the reflective polarizer and the resin lens can be maintained, and further, defects such as wrinkles in the reflective polarizer or bubbles entering the bonding surface with the resin lens are less likely to occur. Furthermore, bonding within the above temperature range improves the adhesion between the resin lens and/or the silane coupling reagent layer and the adhesive layer.

The glass transition temperature Tg_{film} of the substrate film can be measured using a dynamic viscoelasticity measuring apparatus.

The descriptions of the resin lens, the reflective polarizer bonded lens, the silane coupling reagent layer, and the adhesive layer in the reflective polarizer bonded lens can be applied to descriptions of those in the method for producing the reflective polarizer bonded lens.

In the forming the silane coupling reagent layer on at least one of the resin lens and the reflective polarizer, the silane coupling reagent layer may be formed on both the resin lens and the reflective polarizer.

In the method for producing a reflective polarizer bonded lens according to the present embodiment, examples of the bonding method of the reflective polarizer and the resin lens include bonding using a vacuum bonding apparatus and a method of obtaining the lens by injection molding on the film using a film insert molding process. Among them, the bonding method using a vacuum bonding apparatus is preferable because it allows bonding with a good appearance without causing wrinkles or the like in the reflective polarizer and enables the use of lenses with excellent surface accuracy. In the case where a film insert molding process is used, it is necessary to balance between molding conditions advantageous for bonding and methods advantageous for reducing surface accuracy and birefringence, and since the molding condition range becomes narrow, it is difficult to maintain good surface accuracy and birefringence properties of the lens.

In order to facilitate the bonding of the reflective polarizer with the resin lens, the reflective polarizer may be processed into a predetermined shape by heat molding before the bonding step.

Specifically, by heating the reflective polarizer to softene it and layering it on a mold of the desired shape, a reflective polarizer of the desired shape can be obtained. At this time, in order to achieve shape accuracy, the molding may be performed by sandwiching it between a male and female mold.

The unprocessed reflective polarizer or the reflective polarizer processed into the desired shape can then be bonded to the resin lens by vacuum lamination or a film insert molding process.

In the method for producing the reflective polarizer bonded lens according to the present embodiment, it is preferable that the resin lens used is manufactured by injection molding.

The processing temperature of the vacuum bonding apparatus is preferably set according to the glass transition temperature (Tg_{film}) of the substrate film of the reflective polarizer to be bonded to the resin lens. The processing temperature of the vacuum bonding apparatus can be set within the range of, for example, Tg_{film}−40° C. to Tg_{film}+120° C. The processing temperature of the vacuum bonding apparatus is set within the range of more preferably Tg_{film}−20° C. to Tg_{film}+100° C., even more preferably Tg_{film}−10° C. to Tg_{film}+95° C., and still more preferably Tg_{film} to Tg_{film}+90° C. By setting the processing temperature of the vacuum bonding apparatus within this range, good adhesion between the reflective polarizer and the resin lens can be maintained, and further, defects such as wrinkles in the reflective polarizer or bubbles entering the bonding surface with the resin lens are less likely to occur. Furthermore, performing bonding within the above temperature range improves the adhesion between the resin lens and/or the silane coupling reagent layer and the adhesive layer.

When bonding the reflective polarizer using a vacuum bonding apparatus, it is preferable that the bonding surface of the reflective polarizer to the resin lens is subjected to adhesive treatment.

The adhering agent is preferably an adhering agent that has high followability to deformation such as shrinkage/expansion due to heat or water absorption of the resin lens and is relatively soft.

As the substrate of the reflective polarizer, in order to follow the deformation due to water absorption of the resin lens, it is preferable to minimize the absolute value of the difference between the saturated water absorption rate of the reflective polarizer and saturated water absorption rate of the resin lens at the time of bonding using the vacuum bonding apparatus.

The specific range of the difference is as described in the section “—Difference in Saturated Water Absorption Rate between Resin Lens and Reflective Polarizer—”.

Before bonding the reflective polarizer to the resin lens, the reflective polarizer may be processed to have a phase difference (for example, a phase difference of a quarter wavelength at a specific wavelength) by bonding or coating a phase difference film. Regarding the imparting of phase difference by coating, the content described in “—Provision of Phase Difference Layer to Resin Lens—” can be utilized.

However, in order to ensure good adhesion between the reflective polarizer and the resin lens, and also from the viewpoint of maintaining the specular property (flatness) and surface accuracy of the reflective surface, it is preferable to directly bond the reflective polarizer and the resin lens.

### <Polarization Conversion Element>

The polarization conversion element of the present embodiment includes the reflective polarizer bonded lens of the present embodiment described above.

Since the polarization conversion element of the present embodiment comprises the reflective polarizer bonded lens of the present embodiment, degradation of optical performance under high-temperature and high-humidity environments is suppressed, and clear images can be obtained when used as a component of an image display device.

The polarization conversion element of the present embodiment can be manufactured by a conventionally known method, for example, by the method described in JP 2012-118430 A.

### <Head-Mounted Display>

The head-mounted display of the present embodiment includes the reflective polarizer bonded lens of the present embodiment.

Since the head-mounted display of the present embodiment comprises the reflective polarizer bonded lens of the present embodiment, degradation of optical performance under high-temperature and high-humidity environments is suppressed, and further, delamination of the reflective polarizer does not occur even after an environmental test under a harsh high-temperature and high-humidity environment (85° C. and 85% RH for 500 hours), resulting in excellent performance and durability.

The head-mounted display of the present embodiment can be produced by a known method, for example, by the method described in JP 2023-184603 A.

### EXAMPLES

The following provides a description of specific examples and comparative examples. However, the present disclosure is not limited to the following examples.

### (Evaluation of Properties of Resin Composition)

The following describes the measurement method for the properties of the resin composition.

### <Measurements of Flexural Strength and Flexural Modulus>

Pellets of the resin composition prepared in the production examples described later were dried at 80 to 100° C. for 24 hours, and A-type dumbbell test specimens (ISO 3167) with a thickness of 4.0 mm were prepared by injection molding according to JIS K 6717 using an injection molding machine (model: EX-100SX, manufactured by Toshiba Machine Co., Ltd.). The central portion of this test specimen was cut out, and a molded piece with a length of 80 mm, a width of 10 mm, and a thickness of 4.0 mm was prepared. a tensile test was conducted using a universal testing machine for low loads (manufactured by Instron) at a test temperature of 23° C., a test speed of 2 mm/min, and a span of 64 mm according to ISO 178. The measurements were performed six times, and the respective average values were calculated to use as the flexural strength (MPa) and flexural modulus (MPa).

### (Measurement and Evaluation of Properties of Resin Lens and Reflective Polarizer Laminated Lens)

The following describes the measurement methods for the properties of the resin lens and the reflective polarizer bonded lens composed of the resin composition.

### <Analyses of Structural Units>

The resin lens portions of the reflective polarizer bonded lenses prepared in the examples and comparative examples described later were cut into small pieces. The structural units in the cut pieces were identified by ¹H-NMR measurement and ¹³C-NMR measurement, unless otherwise specified, and the amount of each structural unit was calculated. The conditions for the ¹H-NMR and ¹³C-NMR measurements were as follows.
Measuring instrument: JNM-ECZ400S manufactured by JEOL Ltd.
Measurement solvents: CDCl₃, DMSO-d₆, or o-C₆D₄Cl₂
Measurement temperature: 40° C.

In the case where the ring structure included in the main chain of a methacrylic resin is a lactone ring structure, this structure was confirmed by the methods described in JP 2001-151814 A and JP 2007-297620 A. From the ratio of the integral values of CH and CH₂, it was confirmed that a predetermined amount of an olefin and cyclotetracyclo[4.4.0.1^{2,5}.1^{7,10}]-3-dodecene were copolymerized.

### <Measurement of Glass Transition Temperature of Resin Composition Forming Resin Lens>

The glass transition temperature (Tg) (° C.) of the resin composition forming the resin lens was measured according to JIS K 7121. First, after the reflective polarizer bonded lenses prepared in the examples and comparative examples described later were conditioned under standard conditions (23° C. and 50% RH) by being left at 23° C. for one week, four samples (four locations), each of about 10 mg, were cut from the resin lens portion as test specimens. A DSC curve was then plotted using a differential scanning calorimeter (Diamond DSC manufactured by PerkinElmer Japan) under a nitrogen gas flow rate of 25 mL/min while heating the specimen from room temperature (23° C.) to 200° C. at 10° C./min (primary heating), holding the specimen at 200° C. for 5 minutes to completely melt the specimen, cooling the specimen from 200° C. to 40° C. at 10° C./min, holding the specimen at 40° C. for 5 minutes, and then reheating the specimen under the same heating conditions (secondary heating). The glass transition temperature (Tg) (° C.) was then measured according to JIS K 7121 as the intersection point (glass transition temperature of the methacrylic resin composition) of a stair-shaped change section of the DSC curve during the secondary heating and a straight line that was equidistant in a vertical axis direction from each extrapolated baseline. A DSC curve was plotted using a differential scanning calorimeter (DSC 8000 manufactured by PerkinElmer Japan) under a nitrogen gas flow rate of 25 mL/min while heating the specimen from room temperature (23° C.) to 200° C. at 10° C./min (primary heating), holding the specimen at 200° C. for 5 minutes to completely melt the specimen, cooling the specimen from 200° C. to 40° C. at 10° C./min, holding the specimen at 40° C. for 5 minutes, and then reheating the specimen under the same heating conditions (secondary heating). The glass transition temperature (Tg) (° C.) was then measured as the intersection point (mid-point glass transition temperature) of a stair-shaped change section of the DSC curve during the secondary heating and a straight line that was equidistant in a vertical axis direction from each extrapolated baseline. Four points were measured per sample and the arithmetic mean (rounded to nearest whole number beyond the decimal point) was taken to be the measured value.

### <Measurement of Glass Transition Temperature (Tg_{film}) of Substrate Film Forming Reflective Polarizer>

The glass transition temperature (Tg_{film}) of the substrate film forming the reflective polarizer was measured using a dynamic viscoelasticity measuring apparatus (EPLEXOR II 500N, manufactured by NETZSCH) under the conditions of ISO 6721-1. When measuring the Tg_{film} of the substrate film forming the reflective polarizer, about 10 mg was cut from the substrate film and the cut sample was used in the measurement.

If multiple Tg_{film}s were identified in the substrate film forming the reflective polarizer, the lower Tg_{film} was used as the reference.

### <Measurement of Absolute Value of Photoelastic Coefficient>

The resin lens portions of the reflective polarizer bonded lenses prepared in the examples and comparative examples described later were cut into small pieces. The cut pieces were press-formed into press films using a vacuum compression molding machine and used as measurement samples.

Specifically, the sample was prepared by using a vacuum compression molding machine (SFV-30 manufactured by Shinto Metal Industries Corporation) to pre-heat the cut-out piece cut out from the resin lens for 10 minutes at 260° C. under vacuum (approximately 10 kPa) and subsequently compress the cut resin piece for 5 minutes at 260° C. and approximately 10 MPa, and by then releasing the vacuum and press pressure and transferring the cut-out piece to a compression molding machine for cooling in which the resin was cooled and solidified. The resultant pressed film was cured for at least 24 hours in a constant temperature and constant humidity chamber adjusted to a temperature of 23° C. and a humidity of 60%, and then a measurement specimen (thickness: approximately 150° m, width: 6 mm) was cut out therefrom. The photoelastic coefficient CR (Pa⁻¹) was measured using a birefringence measurement device that is described in detail in Polymer Engineering and Science 1999, 39, 2349-2357.

The film-shaped specimen was set in a film tensing device (manufactured by Imoto Machinery Co., Ltd.) set up in the same constant temperature and constant humidity chamber such that the chuck separation was 50 mm. Next, a birefringence measurement device (RETS-100 manufactured by Ostuka Electronics Co., Ltd.) was set up such that the laser light path of the device was positioned in a central portion of the film. The birefringence of the specimen was measured while applying tensile stress with a strain rate of 50%/min (chuck separation: 50 mm, chuck movement speed: 5 mm/min).

The photoelastic coefficient (CR) (Pa⁻¹) was calculated by making a least squares approximation of the relationship between the measured birefringence (Δn) and the tensile stress (6R) and then determining the gradient of the resultant straight line. This calculation was performed using data in a tensile stress range of 2.5 MPa≤σR≤10 MPa.

$$CR = Δ n / σ R$$

Note that the birefringence (Δn) is a value determined below:

$$Δ n = n x - n y$$

where nx is the refractive index in the stretching direction, and ny is the refractive index in the in-plane direction orthogonal to the stretching direction.
<Phase Difference within Effective Diameter of Resin Lens>

The surface distribution of the phase difference of the lens of obtained in the examples and comparative examples were measured using a birefringence evaluation system PA-300-L manufactured by Photonic Lattice Inc., at a wavelength of 520 nm from the optical axis direction. The effective diameter of 41 mm was specified for the lenses. The average absolute value (nm) of the phase difference was determined.

<Transmittance (Total Light Transmittance) within Effective Diameter of Resin Lens>

The transmittance (%) of the resin lenses obtained in the examples and comparative examples were measured at every 10 nm in the wavelength range of 400 to 700 nm under D65 light source at a field of view of 2° using a spectrocolorimeter and haze meter (model: COH7700, manufactured by Nippon Denshoku Industries Co., Ltd.), with the light source aligned along the optical axis of the lens, to obtain the measured value of total light transmittance (%). The average value of three resin lenses molded under the same conditions was determined to be used as the total light transmittance (%).

### <Evaluation of Contrast and Observed Image in Pancake Lens>

For each lens fabricated, with reference to the disclosure of JP 2024-4491 A, a lens was prepared by bonding a wire grid polarizer or a laminated-type reflective polarizer to the protruding surface, and the contrast in a pancake lens configuration was evaluated using the lens.

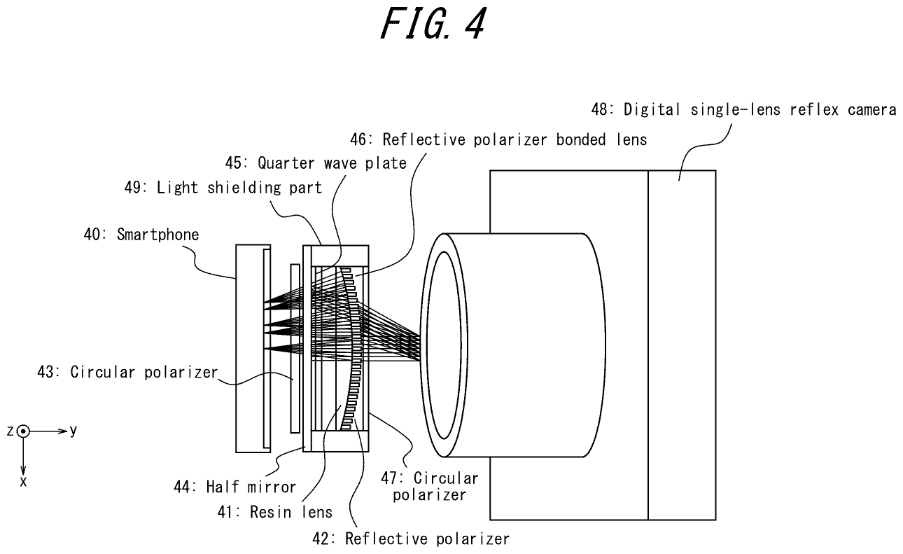

A mock device simulating the principle of a head-mounted display with a pancake lens configuration illustrated in FIG. 4 was fabricated in a dark room and used. The optical data used as the basis for fabricating the device are summarized in Tables 1 to 4. The values in Table 1 were used for the configuration of FIG. 4, and when the values in Tables 2 to 4 were used, the distances between elements were adjusted. In the tables, the “Type” column indicates the surface shape, n_{d} indicates the refractive index at the d-line, νd indicates the Abbe number based on the d-line, and “thickness” indicates the distance between each surface. In the “Type” column, “SPH” indicates the surface shape was spherical, and “ASP” indicates the surface shape was aspherical, and the radius of curvature R, conic constant k, and even-order aspherical coefficients D, E, F, G represent the surface shape using the aspherical calculation formula of formula I. A curvature radius of “Infinity” indicates a flat surface. The surface number assumes the pupil position as surface 1, and the image formation is regarded as reverse ray tracing from the virtual image position to the image display element surface.

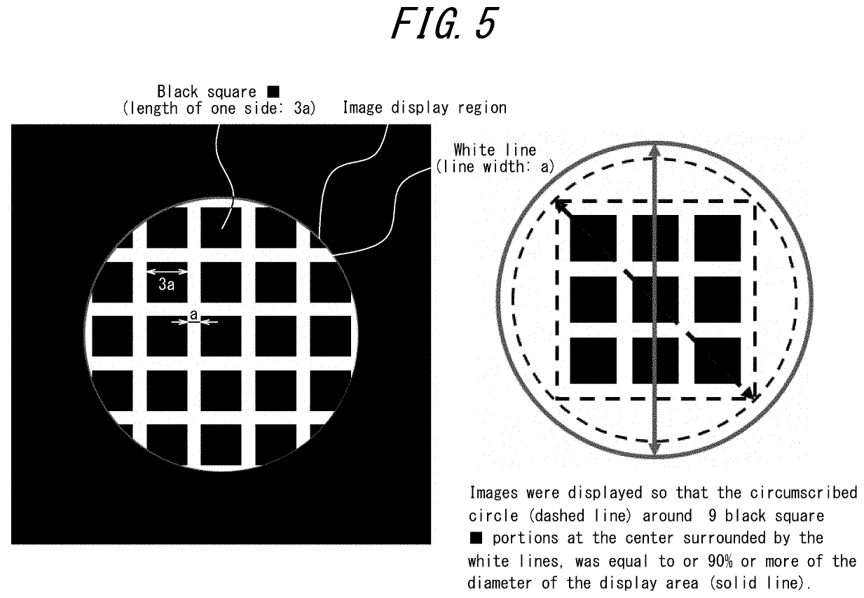

In the mock device, a smartphone 40 (AQUOS sense6, SH-M19, manufactured by Sharp Corporation) was disposed to output images. The displayed image was a grid-like pattern with black squares surrounded by white lines, as illustrated in FIG. 5. At this time, the image was displayed such that the diameter of the circumscribed circle of the region composed of nine black areas and the surrounding white lines coincided with the effective diameter of the image display region, or the diameter of the circumscribed circle was at 90% or more of the effective diameter of the image display region.

Next, the image light passed through a circular polarizer 43 (a combination of an absorptive linear polarizer and a quarter wave plate bonded together, 49S ZX C-PL, manufactured by Kenko Tokina Co., Ltd.) with the linear polarizer side facing the smartphone 40, and was converted into circular polarized light (for example, left-handed circular polarized light as viewed from the direction of propagation). Then, the light passed through a half mirror 44 (incident surface had an anti-reflection coating, exit surface was a dielectric multilayer film half mirror, with a ratio of transmittance: reflectance=50%:50%). Thereafter, the light passed through a quarter wave plate 45 (manufactured by Nippon Kayaku Co., Ltd., using an element where a WA140T element with 40 mmΦ was sandwiched by a 0.7 mm thick glass plate with an AR coating on one side, with the AR coating facing outward) and was converted into linear polarized light (first linear polarized light). At this time, whether the light was converted into linear polarized light through the combination of the above-described circular polarizer 43 and the quarter wave plate 45 can be confirmed separately by checking whether the light was blocked using a linear polarizer. Also, outside the quarter wave plate 45, a light-shielding part 49 is provided to block stray light due to reflection or other unnecessary light.

Next, the reflective polarizer bonded lens 46 was arranged so that the image light entered from the resin lens 41 side and was bonded and fixed to the lens barrel. At this time, by setting the axis of the incident linear polarized light to coincide with the reflection axis of the reflective polarizer 42, the light, after passing through the resin lens 41, was reflected by the reflective polarizer 42, and the optical path was folded back. The light then passed again through the resin lens 41 and the quarter wave plate 45, was converted into circular polarized light (e.g., left-handed circular polarized light as viewed from the propagation direction), then reflected by the half-mirror 44, converted into circular polarized light (e.g., right-handed circular polarized light as viewed from the propagation direction), and after passed through the quarter wave plate 45, converted into a second linear polarized light of which axis was rotated by 90 degrees relative to the first linear polarized light, passed through the resin lens 41. At the reflective polarizer 42, since the light was converted into polarized light aligned with the transmission axis, it transmitted.

Furthermore, a circular polarizer 47 (a combination of an absorptive linear polarizer (not illustrated) and a quarter wave plate (not illustrated) bonded together) was arranged with the surface to which the linear polarizer had been bonded facing the reflective polarizer bonded lens 46 side, so that the second linear polarized light transmitted.

Images were captured by using a camera (model: EOS RP manufactured by Canon Inc., using standard zoom lens RF 24-105 mm F4-F7.1 IS STM), as a digital single-lens reflex camera 48. If the image was out of focus, the position of the smartphone 40 was adjusted within a range of 1 to 3 mm. The shooting conditions were as follows: ISO-8000, a focal length of 31 mm, an exposure time of 1/250 second, and an aperture value of f/5.6.

For the captured images in which square black portions were captured at the center, the luminance of the square black portions and the adjacent white lines were substituted into formula II below to calculate the contrast. The average contrast value of the nine square black portions and the adjacent white lines was taken as the image contrast in the evaluation of the present disclosure.

The luminance values of the image were obtained using ImageJ.

$$Image contrast = ( average luminance of white lines adjacent to square black portions - average luminance of square black portions ) / ( average luminance of white lines adjacent to square black portions + average luminance of square portions ) \qquad Formula II$$

Furthermore, for the captured images, whether double images and flares caused by ghosts were present or not was evaluated based on the following criteria:
A: There was no effect from double images and flares
B: There was a slight effect from double images and flares
C: Shadow due to double images was observed, and the image appeared whitish due to flare
D: Double images were clearly observed, the image appeared whitish due to flare

TABLE 1

| | | Thick- | Radius of | | Refrac- | Abbe | Conic | D | E | F | G | H |
|---|---|---|---|---|---|---|---|---|---|---|---|---|
| | | ness | curvature | | tive | number | constant | 4th | 6th | 8th | 10th | 12th |
| Surface | Element name | (mm) | R (mm) | Type | index n_{d} | v_{d} | k | order | order | order | order | order |
| 0 | Virtual image plane | −1000 | Infinity | SPH | | | | | | | | |
| 1 | Aperture (pupil) | 13 | Infinity | SPH | | | | | | | | |
| 2 | Linear polarizer | 1 | Infinity | SPH | 1.517 | 64 | | | | | | |
| 3 | | 2.5 | Infinity | SPH | | | | | | | | |
| 4 | Wire grid polarizer bonded lens | 4.2 | 66.9 | ASP | 1.502 | 53 | −1.608 | — | — | — | — | — |
| 5 | | 3.5 | Infinity | SPH | | | | | | | | |
| 6 | Quarter wave plate | 1.5 | Infinity | SPH | 1.517 | 64 | | | | | | |
| 7 | | 1 | Infinity | SPH | | | | | | | | |
| 8 | Half mirror (reflective surface) | −1 | Infinity | SPH | 1.517 | 64 | | | | | | |
| 9 | Quarter-wave plate | −1.5 | Infinity | SPH | 1.517 | 64 | | | | | | |
| 10 | | −3.5 | Infinity | SPH | | | | | | | | |
| 11 | Wire grid polarizer bonded lens | −4.2 | Infinity | SPH | 1.502 | 53 | | | | | | |
| 12 | Reflective surface | 4.2 | 66.9 | ASP | 1.502 | 53 | −1.608 | — | — | — | — | — |
| 13 | | 3.5 | Infinity | SPH | | | | | | | | |
| 14 | Quarter-wave plate | 1.5 | Infinity | SPH | 1.517 | 64 | | | | | | |
| 15 | | 1 | Infinity | SPH | | | | | | | | |
| 16 | Half mirror (reflective surface) | 2 | Infinity | SPH | 1.517 | 64 | | | | | | |
| 17 | | 1 | Infinity | SPH | | | | | | | | |
| 18 | circular polarizer | 2 | Infinity | SPH | 1.517 | 64 | | | | | | |
| 19 | | 6.6 | Infinity | SPH | | | | | | | | |
| 20 | Image display element surface | — | Infinity | SPH | | | | | | | | |

TABLE 2

| | | Thick- | Radius of | | Refrac- | Abbe | Conic | D | E | F | G | H |
|---|---|---|---|---|---|---|---|---|---|---|---|---|
| | | ness | curvature | | tive | number | constant | 4th | 6th | 8th | 10th | 12th |
| Surface | Element name | (mm) | R (mm) | Type | index n_{d} | v_{d} | k | order | order | order | order | order |
| 0 | Virtual image plane | −1000 | Infinity | SPH | | | | | | | | |
| 1 | Aperture (pupil) | 12 | Infinity | SPH | | | | | | | | |
| 2 | Pol | 1 | Infinity | SPH | 1.517 | 64 | | | | | | |
| 3 | | 2.5 | Infinity | SPH | | | | | | | | |
| 4 | Wire grid polarizer bonded lens | 7 | 68 | ASP | 1.502 | 53 | −2.916 | — | — | — | — | — |
| 5 | | 1.17 | −95 | ASP | | | −1.125 | — | — | — | — | — |
| 6 | Quarter-wave plate | 1.5 | Infinity | SPH | 1.517 | 64 | | | | | | |
| 7 | | 0.5 | Infinity | SPH | | | | | | | | |
| 8 | Half mirror (reflective surface) | −0.5 | Infinity | SPH | 1.517 | 64 | | | | | | |
| 9 | Quarter-wave plate | 1.5 | Infinity | SPH | 1.517 | 64 | | | | | | |
| 10 | | −1.17 | Infinity | SPH | | | | | | | | |
| 11 | Wire grid polarizer bonded lens | −7 | −95 | ASP | 1.502 | 53 | −1.125 | — | — | — | — | — |
| 12 | Reflective surface | 7 | 68 | ASP | 1.502 | 53 | −2.916 | — | — | — | — | — |
| 13 | | 1.17 | −95 | ASP | | | −1.125 | — | — | — | — | — |
| 14 | Quarter-wave plate | 1.5 | Infinity | SPH | 1.517 | 64 | | | | | | |
| 15 | | 0.5 | Infinity | SPH | | | | | | | | |
| 16 | Half mirror (reflective surface) | 2 | Infinity | SPH | 1.517 | 64 | | | | | | |
| 17 | | 2.5 | Infinity | SPH | | | | | | | | |
| 18 | circular polarizer | 2 | Infinity | SPH | 1.517 | 64 | | | | | | |
| 19 | | 3.89 | Infinity | SPH | | | | | | | | |
| 20 | Image display element surface | — | Infinity | SPH | | | | | | | | |

TABLE 3

| | | Thick- | Radius of | | Refrac- | Abbe | Conic | D | E | F | G | H |
|---|---|---|---|---|---|---|---|---|---|---|---|---|
| | | ness | curvature | | tive | number | constant | 4th | 6th | 8th | 10th | 12th |
| Surface | Element name | (mm) | R (mm) | Type | index n_{d} | v_{d} | k | order | order | order | order | order |
| 0 | Virtual image plane | −1000 | Infinity | SPH | | | | | | | | |
| 1 | Aperture (pupil) | 13 | Infinity | SPH | | | | | | | | |
| 2 | Pol | 1 | Infinity | SPH | 1.517 | 64 | | | | | | |
| 3 | | 2.5 | Infinity | SPH | | | | | | | | |
| 4 | Wire grid polarizer | 3.2 | 92.5 | ASP | 1.502 | 53 | −1.259 | 2.316E−07 | −2.959E−10 | −9.218E−14 | — | — |
| | bonded lens | | | | | | | | | | | |
| 5 | | 3.5 | Infinity | SPH | | | | | | | | |
| 6 | Quarter-wave plate | 1.5 | Infinity | SPH | 1.517 | 64 | | | | | | |
| 7 | | 1 | Infinity | SPH | | | | | | | | |
| 8 | Half mirror (reflective | −1 | Infinity | SPH | 1.517 | 64 | | | | | | |
| | surface) | | | | | | | | | | | |
| 9 | Quarter-wave plate | −1.5 | Infinity | SPH | 1.502 | 53 | | | | | | |
| 10 | | −3.5 | Infinity | SPH | | | | | | | | |
| 11 | Wire grid polarizer | −3.2 | Infinity | SPH | 1.502 | 53 | | | | | | |
| | bonded lens | | | | | | | | | | | |
| 12 | Reflective surface | 3.2 | 92.5 | ASP | 1.517 | 64 | −1.259 | 2.316E−07 | −2.959E−10 | −9.218E−14 | — | — |
| 13 | | 3.5 | Infinity | SPH | | | | | | | | |
| 14 | Quarter-wave plate | 1.5 | Infinity | SPH | 1.517 | 64 | | | | | | |
| 15 | | 1 | Infinity | SPH | | | | | | | | |
| 16 | Half mirror (reflective | 2 | Infinity | SPH | 1.517 | 64 | | | | | | |
| | surface) | | | | | | | | | | | |
| 17 | | 1 | Infinity | SPH | | | | | | | | |
| 18 | circular polarizer | 2 | Infinity | SPH | 1.517 | 64 | | | | | | |
| 19 | | 14.16 | Infinity | SPH | | | | | | | | |
| 20 | Image display element | — | Infinity | SPH | | | | | | | | |
| | surface | | | | | | | | | | | |

TABLE 4

| | | Thick- | Radius of | | Refrac- | Abbe | Conic |
|---|---|---|---|---|---|---|---|
| | | ness | curvature | | tive | number | constant |
| Surface | Element name | (mm) | R (mm) | Type | index n_{d} | v_{d} | k |
| 0 | Virtual image plane | −1000 | Infinity | SPH | | | |
| 1 | Aperture (pupil) | 13 | Infinity | SPH | | | |
| 2 | Pol | 1 | Infinity | SPH | 1.517 | 64 | |
| 3 | | 2.5 | Infinity | SPH | | | |
| 4 | Wire grid polarizer | 5 | 43.1 | ASP | 1.502 | 53 | −1.387 |
| | bonded lens | | | | | | |
| 5 | | 0.5 | Infinity | SPH | | | |
| 6 | Quarter-wave plate | 1.5 | Infinity | SPH | 1.517 | 64 | |
| 7 | | 0.5 | Infinity | SPH | | | |
| 8 | Half mirror (reflective | −0.5 | Infinity | SPH | 1.517 | 64 | |
| | surface) | | | | | | |
| 9 | Quarter-wave plate | −1.5 | Infinity | SPH | 1.517 | 64 | |
| 10 | | −0.5 | Infinity | SPH | | | |
| 11 | Wire grid polarizer | −5 | Infinity | SPH | 1.502 | 53 | |
| | bonded lens | | | | | | |
| 12 | Reflective surface | 5 | 43.1 | ASP | 1.502 | 53 | −1.387 |
| 13 | | 0.5 | Infinity | SPH | | | |
| 14 | Quarter-wave plate | 1.5 | Infinity | SPH | 1.517 | 64 | |
| 15 | | 0.5 | Infinity | SPH | | | |
| 16 | Half mirror (reflective | 2 | Infinity | SPH | 1.517 | 64 | |
| | surface) | | | | | | |
| 17 | | 0.5 | Infinity | SPH | | | |
| 18 | circular polarizer | 2 | Infinity | SPH | 1.517 | 64 | |
| 19 | | 3.535 | Infinity | SPH | | | |
| 20 | Image display element | — | Infinity | SPH | | | |
| | surface | | | | | | |

| | D | E | F | G | H |
|---|---|---|---|---|---|
| | 4th | 6th | 8th | 10th | 12th |
| Surface | order | order | order | order | order |
| 0 | | | | | |
| 1 | | | | | |
| 2 | | | | | |
| 3 | | | | | |
| 4 | −1.320E−06 | 1.020E−08 | −3.730E−11 | 6.150E−14 | −3.370E−17 |
| 5 | | | | | |
| 6 | | | | | |
| 7 | | | | | |
| 8 | | | | | |
| 9 | | | | | |
| 10 | | | | | |
| 11 | | | | | |
| 12 | −1.320E−06 | 1.020E−08 | −3.730E−11 | 6.150E−14 | −3.370E−17 |
| 13 | | | | | |
| 14 | | | | | |
| 15 | | | | | |
| 16 | | | | | |
| 17 | | | | | |
| 18 | | | | | |
| 19 | | | | | |
| 20 | | | | | |

<Evaluation of Appearance after Reliability Test (Presence or Absence of Delamination and Cracks)>

Using five reflective polarizer bonded lenses obtained in the examples and comparative examples, durability under high-temperature and high-humidity conditions was evaluated. The reflective polarizer bonded lenses were placed in a constant temperature and humidity chamber (model: PL-4KP, manufactured by ESPEC Corp.) maintained at 85° C. and 85% RH. After being held at 85° C. and 85% RH for 500 hours, the reflective polarizer bonded lenses were taken out and the appearance of five reflective polarizer bonded lenses was evaluated in terms of the presence or absence of peeling and cracks in the lenses.

The evaluation results are summarized in Tables 5 to 8. The tables indicate the number of lenses with delamination and the number of lenses with cracks out of the five lenses.

<Evaluation of Appearance after Cold Heat Cycle Test>

Ten reflective polarizer bonded lenses obtained in the examples and comparative examples were subjected to a cold heat cycle test using a constant temperature and humidity chamber (low-temperature constant temperature and humidity chamber model PL-2J manufactured by ESPEC Corp.), with one cycle of −30° C. for 1 hour and 85° C. for 1 hour, for a total of 20 cycles. The appearance of the reflective polarizer bonded lenses was evaluated based on the following criteria, and the number of defective lenses was counted. The results are summarized in Tables 5 to 8. The number of defective lenses counted was evaluated based on the following criteria, and the number of defective lenses was recorded.

Non-defective: The appearance was good without wrinkles, bubbles, delamination, etc.

Defective: Cracks in the lens, wrinkles in the reflective polarizer, bubbles, or delamination were observed

### [Raw Materials]

Raw materials that were used in the subsequently described examples and comparative examples were as follows.

### —Monomers Forming Methacrylic Resin—

Methyl methacrylate (MMA) manufactured by Asahi Kasei Corporation
N-phenylmaleimide (PMI) manufactured by Nippon Shokubai Co., Ltd.
N-cyclohexylmaleimide (CMI) manufactured by Nippon Shokubai Co., Ltd.
Styrene manufactured by Fujifilm Wako Pure Chemical Corporation
Methyl 2-(hydroxymethyl)acrylate (MHMA) manufactured by Combi-Blocks Inc.

### —Organic Solvent—

Metaxylene (mXy) manufactured by Mitsubishi Gas Chemical Company, Inc.
Methyl isobutyrate manufactured by Kanto Chemical Co., Inc.
Toluene manufactured by Fujifilm Wako Pure Chemical Corporation

### —Polymerization Initiator—

1,1-di(t-butylperoxy)cyclohexane manufactured by NOF Corporation
t-Amyl peroxy-2-ethylhexanoate: “Luperox 575” manufactured by Arkema Yoshitomi Co., Ltd.
t-Amyl peroxyisononanoate: manufactured by Arkema Yoshitomi Co., Ltd.

### —Chain Transfer Agent—

n-Octyl mercaptan manufactured by Chevron Phillips Chemical Company
n-Dodecyl mercaptan manufactured by Fujifilm Wako Pure Chemical Corporation

Among the above-listed raw materials, N-phenylmaleimide and N-cyclohexylmaleimide were stored in a storage room adjusted to a temperature range of 20 to 30° C. from the time of delivery, and raw materials delivered within three months were used.

Before use, the raw materials were dissolved in metaxylene, followed by liquid-liquid extraction using pure water, and the acid components were quantified using the aqueous layer. From N-phenylmaleimide, a large amount of maleic acid was confirmed, and a total of 950 ppm of acid components was confirmed. On the other hand, from N-cyclohexylmaleimide, a total of 110 ppm of acid components was confirmed. When the amount of maleic acid exceeded 1000 ppm, maleimide was purified by washing with water and dehydration by the method described in JP 2021-92767 A, and then used for the production of methacrylic resin.

### (Preparation of Resin Composition)

### Synthesis Example 1 (Methacrylic Resin Composition A)

A mixed monomer solution was prepared by measuring out 318.7 kg of methyl methacrylate (hereinafter, denoted as “MMA”), 35.5 g of N-phenylmaleimide (hereinafter, denoted as “PMI”), 63.7 kg of N-cyclohexylmaleimide (hereinafter, denoted as “CMI”), 0.341 kg of n-octyl mercaptan as a chain transfer agent, and 225.1 kg of meta-xylene (hereinafter, denoted as “mXy”), adding these materials into a 1.25 m³ reactor equipped with a stirring blade and a temperature controller functioning through use of a jacket, and then stirring these materials.

Then, 116.9 kg of mXy was weighed in the first tank as a subsequently added solvent.

Further, 104.5 kg of MMA and 85.5 kg of mXy were weighed in the second tank, and mixed and stirred to prepare an MMA solution for subsequent addition.

The liquid contained in the reactor was subjected to 1 hour of nitrogen bubbling at a rate of 30 mL/min, and the liquid in each of the first and second tanks was subjected to 30 minutes of nitrogen bubbling at a rate of 10 L/min, to remove dissolved oxygen.

Thereafter, the temperature of the solution in the reactor was raised to 125° C. by blowing steam into the jacket, and then the contents of the reactor were stirred at 50 rpm while adding a polymerization initiator solution containing 0.457 kg of 1,1-di(t-butylperoxy)cyclohexane dissolved in 2.67 kg of mXy at a rate of 1 kg/hour to initiate polymerization. The temperature of the solution inside the reactor during polymerization was controlled to 125±2° C. through temperature adjustment using the jacket. The rate to add the polymerization initiator solution was reduced to 0.25 kg/hour after 30 minutes from the start of polymerization, and mXy was added from the first tank over 3.5 hours at 29.24 kg/hour.

The rate to add the polymerization initiator solution was then increased to 0.75 kg/hour after 4 hours from the start of polymerization, and the MMA solution for subsequent addition was added at 95 kg/hour for 2 hours from the second tank.

Moreover, the rate to add the polymerization initiator solution was reduced to 0.25 kg/hour after 6 hours from the start of polymerization, and addition was stopped after 7 hours from the start of polymerization.

After 8 hours from the start of polymerization, a polymer solution containing a methacrylic resin was yielded. To this solution, 0.261 kg of Irganox 1010 and 0.784 kg of Irgafos 168 as antioxidants, and 0.784 kg of RIKEMAL H-100 as a mold-releasing agent were added.

Next, the resultant polymerization solution was fed into a concentrating device comprising a tubular heat exchanger and an evaporator which had been pre-heated to 250° C. for devolatilization. The condition of degree of vacuum in the evaporator was 10 to 15 Torr. The resin flowing down the evaporator was discharged with a screw pump, extruded through a strand die, cooled with water, and pelletized to obtain methacrylic resin composition A having N-substituted maleimide structural units.

The obtained methacrylic resin composition A had a Tg of 133° C., flexural strength of 66 MPa, and flexural modulus of 3400 MPa. Other properties are summarized in Tables 5 to 8.

### Synthesis Example 2 (Methacrylic Resin Composition B)

A monomer composition containing 75.000 mol % MMA, 24.998 mol % styrene, and 0.002 mol % t-amyl peroxy-2-ethylhexanoate as a polymerization initiator was continuously supplied to a 10 L fully stirred tank equipped with a helical ribbon impeller at 1 kg/hour, and continuous polymerization was performed with an average residence time of 2.5 hours at a polymerization temperature of 150° C. The liquid level in the polymerization tank was maintained constant by continuous withdrawal from the bottom, and the withdrawn material was supplied to a concentration unit composed of a tubular heat exchanger and evaporator for devolatilization. The condition of degree of vacuum in the evaporator was 10 to 15 Torr. The resin flowing down the evaporator was discharged with a screw pump, extruded through a strand die, cooled with water, pelletized, and then introduced into a devolatilization apparatus to obtain pelletized methyl methacrylate-styrene copolymer.

This copolymer was dissolved in methyl isobutyrate to prepare a 10 mass % methyl isobutyrate solution. Into a 1000 mL autoclave apparatus, 500 parts by mass of the 10 mass % methyl isobutyrate solution of the copolymer, and 1 part by mass of 10 mass % Pd/C (manufactured by Nippon Ketjen Co., Ltd.) as a hydrogenation catalyst were charged, and the aromatic double bonds of the styrene portion of the copolymer were hydrogenated by maintaining at a hydrogen pressure of 9 MPa and 200° C. for 15 hours. The hydrogenation catalyst was removed by filtration, and 0.04 parts by mass of RIKEMAL H-100 was added and mixed into the polymer solution, followed by supplying to a concentration apparatus composed of a tubular heat exchanger and an evaporator for devolatilization. The condition of degree of vacuum in the evaporator was 10 to 15 Torr. The resin that flowed down in the evaporator was discharged with a gear pump, was extruded from a strand die, and was pelletized after water cooling to obtain pellets of a methacrylic resin composition B.

The obtained pellets had a Tg of 118° C., a flexural strength of 95 MPa, and a flexural modulus of 3170 MPa. Other properties are summarized in Tables 5 to 8.

### Synthesis Example 3 (Methacrylic Resin Composition C)

In a 30 L reaction vessel equipped with a stirring device having paddle blades, a temperature sensor, a cooling pipe, and a nitrogen introduction tube, 2.25 kg of methyl methacrylate, 0.32 kg of 2-(hydroxymethyl) methacrylate, 0.024 kg of styrene, 0.025 parts by mass of n-dodecyl mercaptan per 100 parts by mass of total monomers finally charged into the reaction vessel as chain transfer agent, 0.025 parts of ADK STAB 2112, and 5.39 kg of toluene were charged, while passing nitrogen and stirring, the temperature was raised to 105° C.

A solution containing 0.20 kg of toluene and 0.014 kg of t-amyl peroxyisononanoate as an initial initiator was dropped into the polymerization tank over 10 minutes, and polymerization was performed at 105 to 110° C. Then, after 10 minutes, a solution containing 0.26 kg of toluene and 0.017 kg of t-amyl peroxyisononanoate was dropped over 3 hours, and simultaneously with the addition of this initiator solution, a solution containing 2.75 kg of methyl methacrylate, 0.40 kg of 2-(hydroxymethyl) methacrylate, and 0.24 kg of styrene was also dropped over 3 hours, and polymerization was carried out at 105 to 110° C., followed by aging for 2 hours. To the obtained polymer solution, a mixed solution of 4.5 g of stearyl phosphate/distearyl phosphate mixture and 72 g of toluene was added, and a ring-closing condensation reaction was performed at 90 to 110° C. for 1.5 hours. Thereafter, 0.10 parts by mass of RIKEMAL H-100 per 100 parts by mass of total monomers finally charged into the reaction vessel was added and mixed by stirring.

A ϕ42 mm devolatilization extruder having four front vents and one rear vent was used to perform cyclocondensation reaction and devolatilization treatment of the resultant polymerization solution at barrel temperature of 220° C., 120 rpm, and 5 kg/hour in terms of amount of resin, and to obtain pellets of a methacrylic resin composition C.

The obtained pellets had a Tg of 127° C., a flexural strength of 98 MPa, and a flexural modulus of 3600 MPa.

### Synthesis Example 4 (Methacrylic Resin Composition D)

An MS resin (copolymer of MMA and α-methylstyrene) was polymerized according to the method for producing Copolymer (A) described in the [Examples]section of JP 2003-231785 A. Polymerization was performed by changing the mass ratio of MMA and styrene charged into the autoclave and by adding 0.15 parts by mass of RIKEMAL H-100 when the total monomer weight during polymerization was taken as 100 parts by mass to obtain a precursor resin (MMA: α-methylstyrene=88 mass %:12 mass %). The MS resin obtained by the above polymerization was fed at 20 kg/hour from the hopper to a co-rotating twin-screw extruder with a screw diameter of 40 mm in which the cylinder temperature of the extruder was set to 275° C., the screw rotation speed to 150 rpm, while nitrogen was flowed into the extruder at a rate of 200 mL/min. After the resin was made to be molten and filled by a kneading block, 2.2 parts by mass of monomethylamine relative to 100 parts by mass the raw material resin was injected from the nozzle to thereby cause an imidization reaction.

A reverse flight was disposed at the end of the reaction zone (upstream to the vent port) to fill the resin. Any by-products and excess monomethylamine after the reaction were removed by reducing the degree of vacuum in the vent port to 30 Torr. The resin which was discharged as strands from the dice disposed at the outlet of the extruder was cooled in a water tank and then pelletized by a pelletizer, to thereby produce an imide resin.

Thereafter, the resultant imide resin was fed at 20 kg/hour to a co-rotating twin screw extruder having a screw diameter of 40 mm, a cylinder temperature of the extruder set at 255° C., and a screw rotation speed set at 150 rpm. After the resin was made to be molten and filled by a kneading block, a mixed solution of dimethyl carbonate and triethylamine as esterifying agents was injected from a nozzle to decrease the amount of carboxylic acid groups in the resin. The amounts of dimethyl carbonate and triethylamine were 2.6 parts by mass and 0.2 parts by mass, respectively, per 100 parts by mass of the imide resin. Any by-products and excess dimethyl carbonate after the reaction were removed by reducing the pressure in the vent port to 30 Torr. The resin which was discharged as strands from the dice disposed at the outlet of the extruder was cooled in a water tank and then pelletized by a pelletizer, to thereby obtain pellets of a methacrylic resin composition D having a glutarimide structure.

The obtained pellets had a Tg of 134° C., a flexural strength of 117 MPa, and a flexural modulus of 3500 MPa.

### Synthesis Example 5 (Methacrylic Resin Composition E)

A mixed monomer solution was prepared by measuring out 270.1 kg of MMA, 83.8 kg of PMI, 167.5 kg of CMI, 0.11 kg of n-octyl mercaptan as a chain transfer agent, and 247.0 kg of mXy, adding these materials into a 1.25-m³ reactor equipped with a stirring blade and a temperature controller functioning through use of a jacket, and then stirring these materials.

Then, 123.0 kg of mXy was weighed and added to a first tank. Further, a mixed monomer solution for subsequent addition was prepared by weighing out 110.0 kg of MMA and 80.0 kg of mXy, charging these materials into a second tank, and then stirring these materials. The liquid contained in the reactor was subjected to 1 hour of nitrogen bubbling at a rate of 30 mL/min, and the liquid in each of the first and second tanks was subjected to 30 minutes of nitrogen bubbling at a rate of 10 L/min, to remove dissolved oxygen.

Thereafter, the temperature of the solution in the reactor was raised to 124° C. by blowing steam into the jacket, and then the contents of the reactor were stirred at 50 rpm while adding a polymerization initiator solution containing 0.35 kg of 1,1-di(t-butylperoxy)cyclohexane dissolved in 4.652 kg of mXy at a rate of 1 kg/hour to initiate polymerization. In addition, the mixed monomer solution for subsequent addition was added from the first tank over 4 hours at 30.75 kg/hour. The temperature of the solution inside the reactor during polymerization was controlled to 124±2° C. through temperature adjustment using the jacket.

The monomer solution containing MMA was then added from the second tank at a rate of 95 kg/hour during a time duration between 4 hours and 6 hours thereafter.

Moreover, the addition rate of the polymerization initiator solution was reduced to 0.25 kg/hour, 0.75 kg/hour, and 0.5 kg/hour after 0.5 hours, 4 hours, and 6 hours had passed after the start of polymerization, respectively, and the addition of the polymerization initiator solution was stopped after 7 hours had passed after the start of polymerization. The polymerization reaction was continued for further 3 hours to yield a polymerization solution containing a methacrylic resin having a cyclic structure in the main chain thereof.

To this polymerization solution, 0.83 kg of ADK STAB PEP-36, 0.28 kg of Irgafos 168, 0.44 kg of Irganox 1076, and 1.10 kg of RIKEMAL H-100 were added under stirring.

Next, the obtained polymerization solution was supplied to a concentration apparatus composed of a tubular heat exchanger and an evaporator preheated to 260° C. for devolatilization. The condition of degree of vacuum in the evaporator was 10 to 15 Torr. The resin flowing down the evaporator was discharged with a screw pump, extruded from a strand die, cooled with water, and pelletized to obtain pellets of a methacrylic resin E having N-substituted maleimide structural units. The obtained pellets had a Tg of 154° C., a flexural strength of 59 MPa, and a flexural modulus of 3500 MPa.

### Synthesis Example 6 (Methacrylic Resin Composition F)

In a 1.25 m³ reaction vessel equipped with a stirring device having paddle blades, a temperature sensor, a cooling pipe, and a nitrogen introduction tube, 432.3 kg of methyl methacrylate (MMA), 25.4 kg of N-cyclohexylmaleimide (CMI), 450.0 kg of metaxylene, and 0.28 kg of n-octyl mercaptan were charged, dissolved, and a raw material solution was prepared. The raw material solution was mixed and simultaneously heated to 125° C. with nitrogen passing in.

On the other hand, 0.23 kg of Perhexa C-75 and 1.82 kg of meta-xylene were mixed, so as to prepare an initiator feed solution. Once the raw material solution reached 127° C., feeding (addition) of the initiator feed solution (polymerization initiator mixed solution) as in (1) to (6) of the following profile was started.
(1) 0.0 to 0.5 hours: feed rate: 1.00 kg/hour
(2) 0.5 to 1.0 hours: feed rate: 0.50 kg/hour
(3) 1.0 to 2.0 hours: feed rate: 0.42 kg/hour
(4) 2.0 to 3.0 hours: feed rate: 0.35 kg/hour
(5) 3.0 to 4.0 hours: feed rate: 0.14 kg/hour
(6) 4.0 to 7.0 hours: feed rate: 0.13 kg/hour

After the initiator had been fed for 7 hours (time B=7 hours), the reaction was proceed for 1 hour, and the polymerization reaction was performed until 8 hours after initiation of initiator addition.

During the polymerization reaction, the internal temperature was controlled at 127±2° C. The polymerization solution obtained in the above was subjected to devolatilization treatment at 140 rpm and 10 kg/hour in terms of resin amount by using a b42 mm devolatilizing extruder having four front vents and one rear vent, so as to obtain pellets of a methacrylic resin composition F.

The obtained pellets had a Tg of 118° C., a flexural strength of 103 MPa, and a flexural modulus of 3200 MPa.

### Synthesis Example 7 (Methacrylic Resin Composition G)

A raw material solution was prepared by charging 430.8 kg of methyl methacrylate (MMA), 33.4 kg of N-phenylmaleimide (PMI), 41.5 kg of N-cyclohexylmaleimide (CMI), 5.4 kg of acrylonitrile (AN), 450.0 kg of meta-xylene, and 0.055 kg of n-octyl mercaptan into a 1.25 m³ reaction tank equipped with a stirring device having a paddle impeller, a temperature sensor, a cooling tube, and a nitrogen introduction tube. The raw material solution was mixed and simultaneously heated to 120° C. with nitrogen passing in. An initiator feed solution A was prepared by mixing 0.18 kg of Perhexa 25B and 0.73 kg of meta-xylene, and an initiator feed solution B was separately prepared by mixing 0.061 kg of Perhexa 25B and 0.24 kg of meta-xylene. Once the raw material solution temperature reached 130° C., the initiator feed liquid A was fed for 10 minutes at a feed rate of 5.5 kg/hour. After 2 hours, the temperature in the reaction chamber was reduced to 115° C. over 0.5 hours, the initiator feed liquid B was fed for 10 minutes at a feed rate of 1.8 kg/hour (B hr=2.83 hr) once the temperature reached 115° C., and then the reaction was continued. The polymerization reaction was implemented for a total of 13 hours to end the reaction. A b42 mm twin screw devolatilization extruder having four front vents and one rear vent was used to perform devolatilization treatment of the resultant polymerization solution at 140 rpm and 10 kg/hour in terms of amount of resin, and to obtain pellets of a methacrylic resin composition G.

The obtained pellets had a Tg of 125° C., a flexural strength of 110 MPa, and a flexural modulus of 3200 MPa.

### Synthesis Example 8 (Methacrylic Resin Composition H)

Using a co-rotating twin-screw extruder with a screw diameter of 40 mm, the cylinder temperature of the extruder was set to 275° C., the screw rotation speed to 150 rpm, and polymethyl methacrylate having a weight average molecular weight of 108,000 and containing 0.1 parts by mass of RIKEMAL H-100 per 100 parts by mass of the entire polymer was fed at 20 kg/hour from the hopper, while nitrogen was flowed into the extruder at a rate of 200 mL/min. After the resin was made to be molten and filled by a kneading block, 1.8 parts by mass of monomethylamine relative to 100 parts by mass of the raw material resin was injected from the nozzle to thereby cause an imidization reaction. A reverse flight was disposed at the end of the reaction zone (upstream to the vent port) to fill the resin. Any by-products and excess monomethylamine after the reaction were removed by reducing the pressure in the vent port to 50 Torr. The resin which was discharged as strands from the dice disposed at the outlet of the extruder was cooled in a water tank and then pelletized by a pelletizer, to thereby produce an imide resin.

Thereafter, the resultant imide resin was fed at 20 kg/hour to a co-rotating twin screw extruder having a screw diameter of 40 mm, a cylinder temperature of the extruder set at 255° C., and a screw rotation speed set at 150 rpm. After the resin was made to be molten and filled by a kneading block, a mixed solution of dimethyl carbonate and triethylamine as esterifying agents was injected from a nozzle to decrease the amount of carboxylic acid groups in the resin. The amounts of dimethyl carbonate and triethylamine were 3.2 parts by mass and 0.8 parts by mass, respectively, per 100 parts by mass of the imide resin. Any by-products and excess dimethyl carbonate after the reaction were removed by reducing the pressure in the vent port to 50 Torr. The resin which was discharged as strands from the dice disposed at the outlet of the extruder was cooled in a water tank and then pelletized by a pelletizer, to thereby produce pellets of a methacrylic resin composition H having a glutarimide structure.

The obtained pellets had a Tg of 123° C., a flexural strength of 127 MPa, and a flexural modulus of 3570 MPa.

### Synthesis Example 9 (Methacrylic Resin Composition I)

In a 30 L reaction vessel equipped with a stirring device having paddle blades, a temperature sensor, a cooling pipe, and a nitrogen introduction tube, 2.25 kg of methyl methacrylate, 1.25 kg of 2-(hydroxymethyl) methacrylate, 0.025 parts by mass of n-dodecyl mercaptan per 100 parts by mass of total monomers as chain transfer agent, 0.025 parts of ADK STAB 2112, and 6.25 kg of toluene were charged, and while passing nitrogen and stirring, the temperature was raised to 105° C. Under reflux, 0.05 parts by mass of t-amyl peroxyisononanoate per 100 parts by mass of total monomers was added to the polymerization vessel, and additionally, 0.1 parts by mass of t-amyl peroxyisononanoate was dropped over 2 hours under reflux at a polymerization temperature of 105 to 110° C., followed by a polymerization reaction for 6 hours.

Next, 6.3 g of a stearyl phosphate/distearyl phosphate mixture was added to the resultant polymer solution, and a cyclocondensation reaction was carried out for 5 hours at 90° C. to 110° C. Thereafter, 0.15 parts by mass of RIKEMAL H-100 per 100 parts by mass of total monomers was added and mixed by stirring. A b42 mm devolatilization extruder having four front vents and one rear vent was used to perform cyclocondensation reaction and devolatilization treatment of the resultant polymerization solution at 120 rpm and 2.2 kg/hour in terms of amount of resin, and to obtain pellets of a methacrylic resin composition I.

The obtained pellets had a Tg of 133° C., a flexural strength of 71 MPa, and a flexural modulus of 3600 MPa.

### Synthesis Example 10 (Resin Composition J of Cycloolefin Copolymer)

First, VO(OC₂H₅)Cl₂ was diluted with cyclohexane to prepare a vanadium catalyst having a vanadium concentration of 6.7 mmol/L-cyclohexane. Ethylaluminum sesquichloride (Al(C₂H₅)_{1.5}Cl_{1.5}) was diluted with cyclohexane to prepare an organoaluminum compound catalyst with an aluminum concentration of 107 mmol/L-hexane. Next, using a stirred polymerizer (with an inner diameter 500 mm and a reaction volume of 100 L), a copolymerization reaction of ethylene and tetracyclo[4.4.0.1^{2,5}.1^{7,10}]-3-dodecene (tetracyclododecene) was continuously performed. Here, ethylene was supplied into the polymerizer together with hydrogen gas. In performing this copolymerization reaction, the vanadium catalyst prepared by the above method was supplied into the polymerizer so that the concentration of the vanadium catalyst relative to the cyclohexane in the polymerizer used as the polymerization solvent was 0.6 mmol/L. In addition, the organoaluminum compound ethylaluminum sesquichloride was supplied into the polymerizer in an amount such that Al/V=18.0. The polymerization temperature was set to 8° C., and the polymerization pressure was set to 1.8 kg/cm²G, and the copolymerization reaction was continuously carried out.

To the copolymer solution of ethylene and tetracyclo[4.4.0.1^{2,5}.1^{7,10}]-3-dodecene withdrawn from the polymerizer, water and an aqueous sodium hydroxide solution with a concentration of 25 mass % as a pH adjuster were added to stop the polymerization reaction. Also, the catalyst residues present in the copolymer were removed (demetallation) from this copolymer solution. To the cyclohexane solution (with a polymer concentration of 7.7 mass %) of the copolymer of ethylene and tetracyclo[4.4.0.1^{2,5}.1^{7,10}]-3-dodecene subjected to the above demetallation treatment, Irganox 1010 was added as a stabilizer at an addition amount of 0.4 parts by mass per 100 parts by mass of the copolymer. Next, before starting the flash drying step, mixing was performed for 1 hour using a stirred tank with an effective volume of 1.0 m³.

Using a double-tube heater (witn an outer tube diameter of 2B, an inner tube diameter of 3/4B, a length of 21 m) that uses steam of 20 kg/cm²G as a heat source, the above copolymer cyclohexane solution with a polymer concentration adjusted to 5 mass % was fed at a rate of 150 kg/hour and heated to 180° C.

Using a double-tube flash dryer (with an outer tube diameter of 2B, an inner tube diameter of 3/4B, a length of 27 m) and a flash hopper (with a volume of 200 L), using steam of 25 kg/cm²G as the heat source, the cyclohexane solvent and most of the unreacted monomers were removed from the above heated copolymer cyclohexane solution to obtain a flash-dried random copolymer of ethylene and tetracyclo[4.4.0.1^{2,5}.1^{7,10}]-3-dodecene (cycloolefin copolymer) in a molten state.

Pentaerythritol distearate (a fatty acid ester, trade name “Unistar H-476D”, manufactured by NOF Corporation) in a molten state after being heated at 100° C. for 4 hours was directly charged into a twin-screw kneading extruder equipped with a vent at a ratio of 2.1 parts by mass per 100 parts by mass of the cycloolefin copolymer (A-1), and kneaded with the cycloolefin copolymer charged from the resin feed section of the extruder. Then, pelletizing was performed using an underwater pelletizer attached to the extruder outlet, and the obtained pellets were dried with hot air at 100° C. for 4 hours to obtain pellets of a cycloolefin copolymer resin composition J. In this resin composition, the proportion of the ring backbone structural unit was 38 mol %.

The obtained pellets had a Tg of 137° C., a flexural strength of 77 MPa, and a flexural modulus of 3350 MPa.

### Synthesis Example 11 (Cycloolefin-Based Resin Composition K)

In a dried and nitrogen-substituted polymerization reactor, 7 parts (1% relative to the total amount of monomers used for the polymerization) of a monomer mixture including 65 mol % of tetracyclo[9.2.1.0^{2,10}.0^{3,8}]tetradeca-3,5,7,12-tetraene (methanotetrahydrofluorene), 30 mol % of tetracyclododecene, and 5 mol % of bicyclo(2.2.1)hept-2-ene (norbornene), 1600 parts of dehydrated cyclohexane, 1.5 parts of 1-docosene as a molecular weight regulator, 1.3 parts of diisopropyl ether, 0.33 parts of isobutyl alcohol, 0.84 parts of triisobutylaluminum, and 30 parts of a 0.66% cyclohexane solution of tungsten hexachloride were charged and stirred at 55° C. for 10 minutes. Next, while maintaining the reaction system at 55° C. and stirring, 693 parts of the monomer mixture having a similar composition and 72 parts of the 0.66% cyclohexane solution of tungsten hexachloride were continuously dropped into the polymerization reactor over 150 minutes, followed by stirring for 30 minutes after completion of the addition. Then, 1.0 part of isopropyl alcohol was added to stop the polymerization reaction. When the polymerization reaction solution was analyzed by gas chromatography, the conversion rate of the monomers was 100%. Next, 300 parts of the above polymerization reaction solution were transferred to an autoclave equipped with a stirrer, and 100 parts of cyclohexane and 2.0 parts of a diatomaceous earth-supported nickel catalyst (trade name “T8400RL”, manufactured by JGC Catalysts and Chemicals Ltd., nickel loading rate: 58%) were added. After replacing the inside of the autoclave with hydrogen, a hydrogenation reaction was carried out at 180° C. and a hydrogen pressure of 4.5 MPa for 6 hours.

To the reaction solution obtained by the hydrogenation reaction, diatomaceous earth (trade name “Radiolite® #500” (Radiolite is a registered trademark in Japan, other countries, or both), manufactured by Showa Chemical Industry Co., Ltd.) was used as a filtration bed, and pressure filtration was performed at 0.25 MPa using a pressure filter (trade name “Fundafilter” manufactured by IHI Corporation) to obtain a colorless and transparent solution. Next, to the obtained solution, 0.5 part per 100 parts of the hydrogenated product of an antioxidant [pentaerythritol tetrakis[3-(3,5-di-tert-butyl-4-hydroxyphenyl)propionate](trade name “Irganox® 1010” (Irganox is a registered trademark in Japan, other countries, or both), manufactured by Ciba Specialty Chemicals)] was added and dissolved. This solution was filtered through a filter (trade name “Zeta Plus® 30H” (Zeta Plus is a registered trademark in Japan, other countries, or both), manufactured by CUNO Filter, pore size: 0.5 to 1 μm), and then the filtrate was further filtered through a metal fiber filter (manufactured by Nichidai Co., Ltd., pore size: 0.4 μm) to remove foreign matter.

Next, the filtrate obtained above was fed into a cylindrical concentration dryer (trade name “Contro”, manufactured by Hitachi, Ltd.), and at a temperature of 260° C. and a pressure below 1 kPa, the solvent cyclohexane and other volatile components were removed from the solution, and the molten product was extruded as strands from a die directly connected to the concentrator, cooled with water, and cut with a pelletizer (trade name “OSP-2”, manufactured by Nagata Seisakusho Co., Ltd.) to obtain pellets of a cycloolefin-based resin composition K.

The obtained pellets had a Tg of 143° C., a flexural strength of 115 MPa, and a flexural modulus of 2410 MPa.

### Example 1

### [Molding of Resin Lens]

Injection molding was performed using the methacrylic resin composition A obtained in Synthesis Example 1, with an injection molding machine (model: S-2000i50B, manufactured by FANUC Corporation). As the mold, a biconvex lens with an optical axis thickness of 7.0 mm and a diameter of $41 mm was used. In the finished states, the first surface was a convex surface including the optical axis, had an aspherical shape with a radius of curvature R of 95 mm, a conic constant k of −1.125, and no even-order coefficients were set. The second surface was also a convex surface including the optical axis, with a radius of curvature R of 68 mm, a conic constant of −2.916, and no even-order constants were set. (When the second surface is taken as positive, it can be described as a spherical surface with a radius of curvature R of −68 mm.) Additionally, a flange for protrusion outside the lens surface was provided, and the entire lens had a diameter of $45 mm. The cylinder temperature was set to Tg+135° C. of the resin composition used, and the mold temperature was set to Tg−15° C. of the resin composition used. The holding pressure was set to 100 MPa for 5 seconds in the first stage, and to 80 MPa for 4 seconds in the second stage to relieve residual stress inside the molded product. Also, the injection speed was set to 20 mm/s for molding, and the resin lens according to Example 1 was obtained.

### [Formation Step of Silane Coupling Reagent Layer]

In the formation step of the silane coupling reagent layer, a silane coupling reagent layer was formed on the bonding surface of the resin lens in accordance with JP 2022-151518 A, so that the silane coupling reagent layer was present between the adhesive layer for bonding the resin lens and the wire grid reflective polarizer WGF (manufactured by Asahi Kasei Corporation) and the resin lens.

In the formation of the silane coupling reagent layer on the resin lens, after plasma treatment was performed using a capacitively coupled high-frequency plasma device, a silane coupling reagent layer was formed. First, the reaction chamber was evacuated to 5 to 10 Pa using a vacuum means. Then, water vapor gas was introduced into the chamber to achieve a pressure of 100 Pa. To generate plasma, water vapor plasma irradiation was performed for 3 minutes at 50 W using high-frequency power of 13.56 MHz. Thereafter, vapor of 3-(trimethoxysilyl)propyl methacrylate was introduced into the chamber and reacted with the bonding surface of the resin lens to form a silane coupling reagent layer. The contact angle of water before and after formation of the silane coupling reagent layer on the resin lens was measured using a contact angle meter DMs-401 (manufactured by Kyowa Interface Science Co., Ltd.). Based on the fact that the contact angle of water changed before and after the formation of the silane coupling reagent layer, it was confirmed that the silane coupling reagent layer was formed on the bonding surface of the resin lens.

### [Production of Resin Substrate Having Lattice-Shaped Protruding Portions for Fabricating Reflective Polarizer Master]

A nickel stamper having a surface with a protruding and recessed lattice with a pitch of 230 nm and a lattice height of 230 nm was prepared. This protruding and recessed lattice was manufactured by patterning using a laser interference exposure method, had a sinusoidal cross-sectional shape, and the shape from the top view was a striped lattice shape. The planar dimensions were 500 mm in both length and width. Using this nickel stamper, a protruding and recessed lattice shape was transferred onto the surface of a 0.5 mm-thick cycloolefin resin (hereinafter abbreviated as COP) plate with dimensions of 520 mm×520 mm by thermal press molding to produce a COP plate with a transferred protruding and recessed lattice shape.

Next, this COP plate with the transferred protruding and recessed lattice shape was cut into a rectangle of 520 mm×460 mm and used as a COP plate for stretching as a stretchable member. At this time, the plate was cut so that the longitudinal direction (520 mm) of the 520 mm×460 mm size and the extension direction of the protruding and recessed lattice were approximately parallel.

Next, silicone oil was applied to the surface of the COP plate for stretching by spraying, and the plate was left for 30 minutes in a circulating air oven at approximately 80° C. Then, 10 mm at both ends in the longitudinal direction of the COP plate for stretching was fixed with chucks of a stretching machine, and in that state, the plate was left for 10 minutes in a circulating air oven adjusted to a temperature of 113±1° C. Thereafter, the stretching was completed when the distance between the chucks was stretched by 2.7 times at a speed of 250 mm/min, and the stretched COP plate (stretched COP plate) was taken out into room temperature atmosphere 20 seconds later and cooled while maintaining the distance between the chucks. Approximately 40% of the central portion of this stretched COP plate was uniformly necked down, and the length of the most narrowed portion was 280 mm. When the surface and cross section of the stretched COP plate were observed under a field emission scanning electron microscope (FE-SEM), the pitch and height of the fine protruding and recessed lattice were 140 nm/130 nm (pitch/height), respectively. The cross-sectional shape was sinusoidal, and the shape viewed from the top surface formed a striped lattice. It was found to be substantially similar to, and a scaled-down version of, the pre-stretched protruding and recessed lattice shape.

### (Fabrication of Nickel Stamper)

Gold was sputter-coated as a conductive treatment at a thickness of 30 nm on the surface of the obtained stretched COP plate with a pitch of 140 nm, and then nickel was electroplated to fabricate a nickel stamper having a thickness of 0.2 mm, a length of 270 mm, and a width of 220 mm, with a fine protruding and recessed lattice on the surface thereof. The nickel stamper was fabricated so that the longitudinal direction thereof was approximately perpendicular to the extension direction of the fine protruding and recessed lattice.

### (Fabrication of Roll Stamper)

The above nickel stamper was processed into a cylindrical shape with the fine protruding and recessed lattice on the outer circumference side, and then welding was performed to obtain a roll stamper. At this time, the joining was done so that the longitudinal direction of the nickel stamper became the circumferential direction of the roll stamper. Next, a NITOFLON adhesive tape manufactured by Nitto Denko Corporation with a width of 13 mm and a thickness of 80 μm was attached in the circumferential direction near the center of the roll stamper.

### (Preparation of Substrate Film Roll)

To a roll (film length 300 m) of triacetyl cellulose film (hereinafter, TAC film, oxygen weight ratio is 50 wt %, Tg_{film}=130° C.) having a width of 250 mm and a thickness of 80 μm, knurling was performed using a disk-shaped mold having protrusions on the surface thereof so that the average height from the substrate film surface in a range of 1 to 15 mm from the edge in the width direction would be 50 μm.

### (Fabrication of Fine Protruding and Recessed Lattice Transfer Film Roll)

To the above TAC film roll subjected to knurling, an ultraviolet-curable resin was continuously coated at approximately 2 μm within the region inward in the width direction from the knurled portion, excluding the position where the NITOFLON tape was attached. The coated surface was brought into contact with the fine protruding and recessed lattice on the roll stamper surface having a 140 nm pitch so that the extension direction of the fine protruding and recessed lattice and the width direction of the TAC film were parallel. Ultraviolet light with a central wavelength of 365 nm was irradiated from the film side using an ultraviolet lamp at 1000 mJ/cm² to continuously transfer the fine protruding and recessed lattice of the roll stamper, and then the film was wound into a roll. Hereinafter, this roll will be referred to as the master roll. The obtained fine protruding and recessed lattice transfer film was observed under FE-SEM, and it was confirmed that the film had a sinusoidal cross-sectional shape and the top-view shape had a striped lattice shape.

### (Drying of Master Roll)

To dry the moisture contained in the master roll obtained as described above, the master roll was placed in a vacuum chamber equipped with three 200 W infrared heaters, and the film was unwound under vacuum and run at 2 m/min, and after heating, it was wound into a roll. The degree of vacuum when the film was stopped was 0.03 Pa, and the degree of vacuum during film transport (during drying) was 0.15 Pa. Also, in order to know the surface temperature of the TAC film after passing the heater, a Thermolabel® (Thermolabel is a registered trademark in Japan, other countries, or both) was previously attached to the TAC film. The surface temperature of the TAC film after passing the heater was between 60° C. and 70° C.

### (Formation of Metal Nanowires)

After the dried master roll was left in the vacuum chamber of the dryer for 12 hours, the temperature of the film dropped to 23° C. After that, the master roll was transferred to a vacuum chamber for metal wire formation. Next, a silicon nitride layer was provided on the fine protruding and recessed lattice surface by reactive AC magnetron sputtering. Specifically, two silicon targets with dimensions 127 mm×750 mm×10 mm (thick) were arranged, and with a substrate-to-target distance of 80 mm, argon gas flow rate of 200 sccm, nitrogen gas flow rate of 300 sccm, power of 11 kW, frequency of 37.5 kHz, and feed speed of 5 m/min, the master roll was unwound and fed toward the take-up roll by the film conveying roll, and then wound into a roll. The tension during sputtering was 30 N, the main roller temperature was 30° C., the background vacuum degree before starting sputtering was 0.005 Pa, and the vacuum degree during sputtering was 0.38 Pa. Under the same conditions, silicon nitride was deposited on an Si chip, and the thickness of the silicon nitride layer was measured to be 3 nm by ellipsometry.

After sputtering was completed, the temperature of the master roll was measured using an infrared thermometer and found to be 24° C. After the silicon nitride was formed as a thin film layer on the lattice-shaped protrusion transfer surface of the master roll by sputtering, the film was fed in the reverse direction from sputtering by the main roller, and metal nanowires were formed by resistance heating vapor deposition, and the film was wound into a roll. Aluminum (Al) was used as the metal. At this time, an oblique deposition method was used for Al deposition, and a mask was placed so that the angle between the surface normal of the substrate and the deposition source in the plane perpendicular to the longitudinal direction of the lattice was 320 at the start and ended at 15°. The mask opening width was 60 mm, and the distance between the center of the mask opening and the deposition boat was 400 mm. The degree of vacuum before heating the deposition boat was 0.005 Pa. The tension was 30 N, and the main roller temperature was 30° C. Under the above conditions, while the lattice-shaped protruding and recessed transfer film roll was fed with a film feed speed of 3.5 m/min, pure aluminum wires with a purity of 99.9% or more and a wire diameter of 1.7 mm were fed at a feed rate of 200 mm/min onto the heated boat to deposit aluminum. The degree of vacuum during deposition was 0.007 Pa.

### (Measurement of Film Thickness of Aluminum)

A film portion deposited in the latter part of the deposition was cut out from the wire grid polarizing plate obtained by the above-mentioned deposition, and the film thickness of aluminum was calculated from the fluorescence intensity of X-rays. The thickness was determined to be 130 nm for both.

### (Etching of Aluminum)

The wire grid polarizing plate film roll with Al metal nanowires formed thereon was unwound and passed through a 0.5 wt % NaOH aq. bath at 23° C. for 65 seconds, then washed with water and air-dried to obtain a roll of wire grid polarizing plate having the desired optical properties.

### (Extraction of Wire Grid Polarizer for Bonding)

After the etched wire grid polarizing plate roll was left to stand in the environment described later for a predetermined time, it was cut into sheets of 270 mm length to obtain wire grid polarizers for bonding. The sheets were placed on a white backlight, and their appearance was visually inspected. The appearance was uniform, and no delamination or other defects were observed on the shadows or metal wire sections.

A double-sided adhesive sheet was bonded on the support substrate 21 side of the 80 μm-thick wire grid reflective polarizer (TAC substrate) obtained by the above step.

The plano-convex resin lens obtained by injection molding was placed on the bonding base (lower chamber) of a vacuum bonding apparatus using a jig for holding the lens, such that the spherical surface (R=68 mm) to be bonded was on the upper side and the aspherical surface (R=95 mm) was on the lower side.

The wire grid was fixed in the vacuum molding apparatus having upper and lower chambers so as to partition the space, and both the upper and lower chambers were evacuated. At this time, the surface of the wire grid polarizer having a fine protruding and recessed structure was fixed facing the upper chamber. Then, the wire grid polarizer was heated by a heater inside the apparatus, and the temperature of the element was measured using an infrared monitor. After heating to approximately 210° C., the resin lens fixed in the lower chamber was pressed against the wire grid polarizer. Subsequently, air was gently leaked into the upper chamber, followed by leaking into the lower chamber. Through the above procedure, a wire grid polarizer having a curved shape was obtained. The desired curved portion was cut out by laser cutting, thereby obtaining a reflective polarizer bonded lens according to Example 1. The evaluation results are summarized in Table 5.

### Example 2

Molding and bonding of the wire grid polarizer were performed under conditions similar to those in Example 1 except that the adhesive sheet was bonded to the lattice-shaped protruding portion 23 side of the wire grid polarizer when the wire grid polarizer is bonded to the resin lens obtained in Example 1. The evaluation results are summarized in Table 5.

### Example 3

Injection molding was performed using the methacrylic resin composition A obtained in Synthesis Example 1, with an injection molding machine (model: S-2000i50B, manufactured by FANUC Corporation). A meniscus lens with an optical axis thickness of 3.2 mm was used as the mold. In the finished state, the first surface was a convex surface including the optical axis, having an aspherical shape with a radius of curvature R of 92.5 mm, conic constant k of −1.259, and even-order aspherical coefficients D of 2.316×10⁻⁷, E=−2.959×10⁻¹⁰, F=−9.218×10⁻¹⁴, and the second surface was a flat surface.

The cylinder temperature was set to Tg+125° C. of the resin composition used, and the mold temperature was set to Tg−20° C. of the resin composition used for molding. The holding pressure was set to 90 MPa for 5 seconds in the first stage, and to 70 MPa for 4 seconds in the second stage to relieve residual stress inside the molded product. The injection speed was set to 6 m/s, and molding was carried out to obtain a resin lens similar to the resin lens according to Example 1. The shape of the lens was measured using NH-3SPs (manufactured by Mitaka Kohki Co., Ltd.), and molding conditions were appropriately adjusted to obtain the lens with the desired shape.

The bonding of the wire grid polarizer to the resin lens similar to that obtained in Example 1 was performed under conditions similar to those in Example 1 except that the surface to be bonded was a spherical surface (R=92.5 mm). The evaluation results are summarized in Table 5.

### Example 4

Injection molding was performed using the methacrylic resin composition A obtained in Synthesis Example 1, with an injection molding machine (model: S-2000i50B, manufactured by FANUC Corporation). A meniscus lens with an optical axis thickness of 5 mm was used as the mold. In the finished state, the first surface was a convex surface including the optical axis, having an aspherical shape with a radius of curvature R of 43.1 mm, conic constant k of −1.387, and even-order aspherical coefficients D of −1.32×10⁻⁶, E=1.02×10⁻⁸, F=−3.73×10⁻¹¹, G=6.15×10⁻¹⁴, H=−3.37×10⁻¹⁷, and the second surface was a flat surface.

The cylinder temperature was set to Tg+125° C. of the resin composition used, and the mold temperature was set to Tg−20° C. of the resin composition used for molding. The holding pressure was set to 90 MPa for 5 seconds in the first stage, and to 70 MPa for 4 seconds in the second stage to relieve residual stress inside the molded product. The injection speed was set to 6 m/s, and molding was carried out to obtain a resin lens similar to the resin lens according to Example 1. The shape of the lens was measured using NH-3SPs (manufactured by Mitaka Kohki Co., Ltd.), and molding conditions were appropriately adjusted to obtain the lens with the desired shape.

The bonding of the wire grid polarizer to the resin lens similar to that obtained in Example 1 was performed under conditions similar to those in Example 1 except that the surface to be bonded was a spherical surface (R=43.1 mm). The evaluation results are summarized in Table 5.

### Example 5

Injection molding was performed using the methacrylic resin composition A obtained in Synthesis Example 1, with an injection molding machine (model: S-2000i50B, manufactured by FANUC Corporation). A meniscus lens with an optical axis thickness of 4.2 mm was used as the mold. In the finished state, the first surface was a convex surface including the optical axis, having an aspherical shape with a radius of curvature R of 66.9 mm, conic constant k of −1.608, and no even-order aspherical coefficients set, and the second surface was a flat surface.

The cylinder temperature was set to Tg+125° C. of the resin composition used, and the mold temperature was set to Tg−20° C. of the resin composition used for molding. The holding pressure was set to 90 MPa for 5 seconds in the first stage, and to 70 MPa for 4 seconds in the second stage to relieve residual stress inside the molded product. The injection speed was set to 6 m/s, and molding was carried out to obtain a resin lens similar to the resin lens according to Example 1. The shape of the lens was measured using NH-3SPs (manufactured by Mitaka Kohki Co., Ltd.), and molding conditions were appropriately adjusted to obtain the lens with the desired shape.

The bonding of the wire grid polarizer to the resin lens similar to that obtained in Example 1 was performed under conditions similar to those in Example 1 except that the surface to be bonded was a spherical surface (R=66.9 mm). The evaluation results are summarized in Table 5.

### Example 6

Molding and bonding of the wire grid polarizer were performed under conditions similar to those in Example 5 except that the methacrylic resin composition B obtained in Synthesis Example 2 was used. The evaluation results are summarized in Table 5.

### Example 7

Molding and bonding of the wire grid polarizer were performed under conditions similar to those in Example 5 except that the methacrylic resin composition C obtained in Synthesis Example 3 was used. The evaluation results are summarized in Table 5.

### Example 8

Molding and bonding of the wire grid polarizer were performed under conditions similar to those in Example 5 except that the methacrylic resin composition D obtained in Synthesis Example 4 was used. The evaluation results are summarized in Table 5.

### Example 9

Molding and bonding of the wire grid polarizer were performed under conditions similar to those in Example 5 except that except that the thermoplastic resin composition E obtained in Synthesis Example 5 was used. The evaluation results are summarized in Table 6.

### Example 10

Molding and bonding of the wire grid polarizer were performed under conditions similar to those in Example 5 except that the methacrylic resin composition F obtained in Synthesis Example 6 was used. The evaluation results are summarized in Table 6.

### Example 11

Molding and bonding of the wire grid polarizer were performed under conditions similar to those in Example 5 except that the methacrylic resin composition G obtained in Synthesis Example 7 was used. The evaluation results are summarized in Table 6.

### Example 12

Molding and bonding of the wire grid polarizer were performed under conditions similar to those in Example 5 except that the methacrylic resin composition G obtained in Synthesis Example 8 was used. The evaluation results are summarized in Table 6.

### Example 13

Molding and bonding of the wire grid polarizer were performed under conditions similar to those in Example 5 except that the methacrylic resin composition I obtained in Synthesis Example 9 was used. The evaluation results are summarized in Table 6.

### Example 14

Molding and bonding of the wire grid polarizer were performed under conditions similar to those in Example 5 except that the cyclic olefin copolymer resin composition J obtained in Synthesis Example 10 was used.

The evaluation results are summarized in Table 6.

### Example 15

Molding and bonding of the wire grid polarizer were performed under conditions similar to those in Example 5 except that the cycloolefin-based resin composition K obtained in Synthesis Example 11 was used. The evaluation results are summarized in Table 6.

### Example 16

Molding and bonding of the wire grid polarizer were conducted under conditions similar to the conditions in Example 1 except that, after forming a silane coupling reagent layer using the same method as for the resin lens, a double-sided adhesive sheet was also attached to the side of the support substrate 21 of the wire grid reflective polarizer (WGF) (TAC substrate) so that silane coupling reagent layers were provided both between the resin lens and the adhesive layer and between the adhesive layer and the wire grid reflective polarizer. The evaluation results are summarized in Table 6.

### Example 17

### [Fabrication of Laminated Type Reflective Polarizer]

Two multilayer optical packets were co-extruded with each packet composed of 325 alternating layers of polyethylene naphthalate (PEN) and low-refractive-index isotropic layers, which were produced using a blend of polycarbonate and copolyester (PC:coPET) with a refractive index of about 1.57 and with substantially isotropic properties in the uniaxial direction. The molar ratio of PC:coPET was approximately 42.5 mol % PC and 57.5 mol % coPET, and the Tg was 105° C. This isotropic material was selected to remain substantially matched with the refractive index of the birefringent material in the non-stretch direction after stretching in two directions, while maintaining a substantial mismatch in refractive index between the birefringent and non-birefringent layers in the stretching direction. The PEN and PC/coPET polymers were fed from separate extruders into a multilayer co-extrusion feedblock and assembled into packets consisting of 325 alternating optical layers (referred to as “packet 1” and “packet 2,” respectively). A thicker protective boundary layer of PC/coPET was added to the outside of the bonded optical packet, resulting in a total number of layers of 652. The film was substantially uniaxially stretched using a parabolic tenter as disclosed in U.S. Pat. No. 6,916,440 B (to Jackson et al.). The film was stretched to a stretch ratio of approximately 6 at a temperature of about 150° C.

A double-sided adhesive sheet was bonded to a 68 μm laminated-type reflective polarizer obtained by the above step.

A plano-convex resin lens, on which a silane coupling reagent layer had been formed, was placed on the bonding base (lower chamber) of a vacuum bonding apparatus using a jig to hold the lens, with the surface to be bonded positioned such that the spherical surface (R=68 mm) was on the top and the aspherical surface (R=95 mm) was on the bottom.

The laminated-type reflective polarizer was fixed so as to partition the inside of a vacuum molding apparatus having upper and lower chambers, and both chambers inside the apparatus were evacuated. At this time, the surface of the laminated-type reflective polarizer having a fine protruding and recessed structure was fixed facing the upper chamber. Then, the laminated-type reflective polarizer was heated with the heater in the apparatus, and the temperature of the element was monitored with an infrared monitor; after reaching approximately 160° C., the resin lens fixed in the lower chamber was brought into contact with the laminated-type reflective polarizer. Subsequently, air was gently leaked into the upper chamber, followed by leaking into the lower chamber. Through the above process, a laminated-type reflective polarizer having a curved shape was obtained. The portion provided with the desired curve was cut out by laser cutting, thereby obtaining a reflective polarizer bonded lens according to Example 17. The evaluation results are summarized in Table 6.

### Comparative Example 1

Molding and bonding of the wire grid polarizer were performed under conditions similar to those in Example 1 except that the procedure in [Step of Forming Silane Coupling Reagent Layer] in the method of Example 1 was not performed. The evaluation results are summarized in Table 7.

### Comparative Example 2

Molding and bonding of the wire grid polarizer were performed under conditions similar to those in Example 2 except that the procedure in [Step of Forming silane coupling reagent layer] in the method of Example 2 was not performed. The evaluation results are summarized in Table 7.

### Comparative Example 3

Molding and bonding of the wire grid polarizer were performed under conditions similar to those in Example 3 except that the procedure in [Step of Forming Silane Coupling Reagent Layer] in the method of Example 3 was not performed. The evaluation results are summarized in Table 7.

### Comparative Example 4

Molding and bonding of the wire grid polarizer were performed under conditions similar to those in Example 4 except that the procedure in [Step of Forming Silane Coupling Reagent Layer] in the method of Example 4 was not performed. The evaluation results are summarized in Table 7.

### Comparative Example 5

Molding and bonding of the wire grid polarizer were performed under conditions similar to those in Example 1 except that a methacrylic resin L (DELPET LP-1, manufactured by Asahi Kasei Corporation) was used. The evaluation results are summarized in Table 7.

### Comparative Example 6

Molding and bonding of the wire grid polarizer were performed under conditions similar to those in Example 6 except that the procedure in [Step of Forming Silane Coupling Reagent Layer] in the method of Example 6 was not performed. The evaluation results are summarized in Table 7.

### Comparative Example 7

Molding and bonding of the wire grid polarizer were performed under conditions similar to those in Example 7 except that the procedure in [Step of Forming Silane Coupling Reagent Layer] in the method of Example 7 was not performed. The evaluation results are summarized in Table 7.

### Comparative Example 8

Molding and bonding of the wire grid polarizer were performed under conditions similar to those in Example 8 except that the procedure in [Step of Forming Silane Coupling Reagent Layer] in the method of Example 8 was not performed. The evaluation results are summarized in Table 8.

### Comparative Example 9

Molding and bonding of the wire grid polarizer were performed under conditions similar to those in Example 9 except that the procedure in [Step of Forming Silane Coupling Reagent Layer] in the method of Example 9 was not performed. The evaluation results are summarized in Table 8.

### Comparative Example 10

Molding and bonding of the wire grid polarizer were performed under conditions similar to those in Example 10 except that the procedure in [Step of Forming Silane Coupling Reagent Layer] in the method of Example 10 was not performed. The evaluation results are summarized in Table 8.

### Comparative Example 11

Molding and bonding of the wire grid polarizer were performed under conditions similar to those in Example 11 except that the procedure in [Step of Forming Silane Coupling Reagent Layer] in the method of Example 11 was not performed. The evaluation results are summarized in Table 8.

### Comparative Example 12

Molding and bonding of the wire grid polarizer were performed under conditions similar to those in Example 12 except that the procedure in [Step of Forming Silane Coupling Reagent Layer] in the method of Example 12 was not performed. The evaluation results are summarized in Table 8.

### Comparative Example 13

Molding and bonding of the wire grid polarizer were performed under conditions similar to those in Example 13 except that the procedure in [Step of Forming Silane Coupling Reagent Layer] in the method of Example 13 was not performed. The evaluation results are summarized in Table 8.

### Comparative Example 14

Molding and bonding of the wire grid polarizer were performed under conditions similar to those in Example 14 except that the procedure in [Step of Forming Silane Coupling Reagent Layer] in the method of Example 14 was not performed. The evaluation results are summarized in Table 8.

### Comparative Example 15

Molding and bonding of the wire grid polarizer were performed under conditions similar to those in Example 15 except that the procedure in [Step of Forming Silane Coupling Reagent Layer] in the method of Example 15 was not performed. The evaluation results are summarized in Table 8.

### (Comparative Example 16)

Molding and bonding of the laminated-type reflective polarizer were performed under conditions similar to those in Example 17 except that the procedure in [Step of Forming Silane Coupling Reagent Layer] in the method of Example 17 was not performed. The evaluation results are summarized in Table 8.

TABLE 5

| | | | Example 1 | Example 2 | Example 3 | Example 4 |
|---|---|---|---|---|---|---|
| Resin Composition | | — | A | A | A | A |
| Silane coupling | Between resin lens and adhesive layer | — | Present | Present | Present | Present |
| agent layer | Between adhesive layer and polarizer | — | Absent | Absent | Absent | Absent |

| | | | | | |
|---|---|---|---|---|---|
| Flexural strength | MPa | 66 | 66 | 66 | 66 |
| Flexural modulus | MPa | 3400 | 3400 | 3400 | 3400 |
| Glass transition temperature (Tg) | ° C. | 133 | 133 | 133 | 133 |
| Absolute value of photoelastic coefficient | ×10¹² Pa⁻¹ | 0.2 | 0.2 | 0.2 | 0.2 |
| Phase difference within effective diameter of resin lens | nm | 5 | 5 | 5 | 5 |
| Effective diameter internal transmittance of resin lens | % | 93.5 | 95.2 | 95.3 | 94.2 |
| Types of reflective polarizers | — | Wire grid | Wire grid | Wire grid | Wire grid |
| Bonding surface of reflective polarizer | — | Surface of | Lattice convex | Surface of | Surface of |
| | | support sub. | surface | support sub. | support sub. |
| Radius of curvature of lens spherical surface | mm | 68 | 68 | 92.5 | 43.1 |
| Lens thickness | mm | 7 | 7 | 3.2 | 5 |
| Observed image | — | A | A | A | A |
| Image contrast | — | 0.74 | 0.74 | 0.8 | 0.73 |
| Number of lens with delamination after reliability test | of 5 lens | 0 | 0 | 0 | 2 |
| Number of lens with cracks after reliability test | of 5 lens | 0 | 1 | 0 | 0 |
| Appearance after cold heat cycle test | of 10 lens | 1 | 2 | 0 | 1 |

| | | | Example 5 | Example 6 | Example 7 | Example 8 |
|---|---|---|---|---|---|---|
| Resin Composition | | — | A | B | C | D |
| Silane coupling | Between resin lens and adhesive layer | — | Present | Present | Present | Present |
| agent layer | Between adhesive layer and polarizer | — | Absent | Absent | Absent | Absent |

| | | | | | |
|---|---|---|---|---|---|
| Flexural strength | MPa | 66 | 95 | 98 | 117 |
| Flexural modulus | MPa | 3400 | 3170 | 3600 | 3500 |
| Glass transition temperature (Tg) | ° C. | 133 | 119 | 127 | 134 |
| Absolute value of photoelastic coefficient | ×10¹² Pa⁻¹ | 0.2 | 5.1 | 3.3 | 5.9 |
| Phase difference within effective diameter of resin lens | nm | 3 | 6 | 4 | 10 |
| Effective diameter internal transmittance of resin lens | % | 95.3 | 95.7 | 95.3 | 94.7 |
| Types of reflective polarizers | — | Wire grid | Wire grid | Wire grid | Wire grid |
| Bonding surface of reflective polarizer | — | Surface of | Surface of | Surface of | Surface of |
| | | support sub. | support sub. | support sub. | support sub. |
| Radius of curvature of lens spherical surface | mm | 66.9 | 66.9 | 66.9 | 66.9 |
| Lens thickness | mm | 4 | 4 | 4 | 4 |
| Observed image | — | A | A | A | A |
| Image contrast | — | 0.78 | 0.78 | 0.77 | 0.7 |
| Number of lens with delamination after reliability test | of 5 lens | 0 | 1 | 0 | 0 |
| Number of lens with cracks after reliability test | of 5 lens | 1 | 1 | 1 | 0 |
| Appearance after cold heat cycle test | of 10 lens | 2 | 1 | 1 | 0 |

TABLE 6

| | | | Exam- | Exam- | Exam- | Exam- | Exam- |
|---|---|---|---|---|---|---|---|
| | | | ple 9 | ple 10 | ple 11 | ple 12 | ple 13 |
| Resin Composition | | — | E | F | G | H | I |
| Silane coupling | Between resin lens and adhesive layer | — | Present | Present | Present | Present | Present |
| agent layer | Between adhesive layer and polarizer | — | Absent | Absent | Absent | Absent | Absent |

| | | | | | | |
|---|---|---|---|---|---|---|
| Flexural strength | MPa | 59 | 103 | 110 | 127 | 71 |
| Flexural modulus | MPa | 3500 | 3200 | 3200 | 3570 | 3600 |
| Glass transition temperature (Tg) | ° C. | 154 | 118 | 125 | 123 | 133 |
| Absolute value of photoelastic coefficient | ×10¹² Pa⁻¹ | 5.3 | 4.8 | 0.1 | 3.3 | 15 |
| Phase difference within effective diameter of resin lens | nm | 8 | 7 | 8 | 5 | 29 |
| Effective diameter internal transmittance of resin lens | % | 94.3 | 95.2 | 95.4 | 95.7 | 95.3 |
| Types of reflective polarizers | — | Wire grid | Wire grid | Wire grid | Wire grid | Wire grid |
| Bonding surface of reflective polarizer | — | Surface of | Surface of | Surface of | Surface of | Surface of |
| | | support sub. | support sub. | support sub. | support sub. | support sub. |
| Radius of curvature of lens spherical surface | mm | 66.9 | 66.9 | 66.9 | 66.9 | 66.9 |
| Lens thickness | mm | 4 | 4 | 4 | 4 | 4 |
| Observed image | | A | B | B | B | C |
| Image contrast | | 0.73 | 0.72 | 0.73 | 0.75 | 0.6 |
| Number of lens with delamination after reliability test | of 5 lens | 0 | 1 | 1 | 0 | 0 |
| Number of lens with cracks after reliability test | of 5 lens | 0 | 0 | 0 | 0 | 0 |
| Appearance after cold heat cycle test | of 10 lens | 0 | 2 | 2 | 5 | 0 |

| | | | Exam- | Exam- | Exam- | Exam- |
|---|---|---|---|---|---|---|
| | | | ple 14 | ple 15 | ple 16 | ple 17 |
| Resin Composition | | — | J | K | A | A |
| Silane coupling | Between resin lens and adhesive layer | — | Present | Present | Present | Present |
| agent layer | Between adhesive layer and polarizer | — | Absent | Absent | Present | Absent |

| | | | | | |
|---|---|---|---|---|---|
| Flexural strength | MPa | 77 | 115 | 66 | 66 |
| Flexural modulus | MPa | 3350 | 2410 | 3400 | 3400 |
| Glass transition temperature (Tg) | ° C. | 137 | 143 | 133 | 133 |
| Absolute value of photoelastic coefficient | ×10¹² Pa⁻¹ | 9.4 | 6.5 | 0.2 | 0.2 |
| Phase difference within effective diameter of resin lens | nm | 2.7 | 39 | 5 | 5 |
| Effective diameter internal transmittance of resin lens | % | 93.7 | 92.1 | 93.5 | 93.5 |
| Types of reflective polarizers | — | Wire grid | Wire grid | Wire grid | Laminated type |
| Bonding surface of reflective polarizer | — | Surface of | Surface of | Surface of | — |
| | | support sub. | support sub. | support sub. | |
| Radius of curvature of lens spherical surface | mm | 66.9 | 66.9 | 68 | 68 |
| Lens thickness | mm | 4 | 4 | 7 | 7 |
| Observed image | | B | D | A | A |
| Image contrast | | 0.78 | 0.55 | 0.74 | 0.79 |
| Number of lens with delamination after reliability test | of 5 lens | 2 | 2 | 0 | 0 |
| Number of lens with cracks after reliability test | of 5 lens | 2 | 3 | 1 | 1 |
| Appearance after cold heat cycle test | of 10 lens | 6 | 8 | 2 | 1 |

TABLE 7

| | | | Comp. | Comp. | Comp. | Comp. |
|---|---|---|---|---|---|---|
| | | | Ex. 1 | Ex. 2 | Ex. 3 | Ex. 4 |
| Resin Composition | | — | A | A | A | A |
| Silane coupling | Between resin lens and adhesive layer | — | Absent | Absent | Absent | Absent |
| agent layer | Between adhesive layer and polarizer | — | Absent | Absent | Absent | Absent |

| | | | | | |
|---|---|---|---|---|---|
| Flexural strength | MPa | 66 | 66 | 66 | 66 |
| Flexural modulus | MPa | 3400 | 3400 | 3400 | 3400 |
| Glass transition temperature (Tg) | | 133 | 133 | 133 | 133 |
| Absolute value of photoelastic coefficient | ×10¹² Pa⁻¹ | 0.2 | 0.2 | 0.2 | 0.2 |
| Phase difference within effective diameter of resin lens | nm | 5 | 5 | 5 | 5 |
| Effective diameter internal transmittance of resin lens | % | 93.5 | 95.2 | 95.3 | 94.2 |
| Types of reflective polarizers | — | Wire grid | Wire grid | Wire grid | Wire grid |
| Bonding surface of reflective polarizer | — | Surface of | Lattice convex | Surface of | Surface of |
| | | support sub. | surface | support sub. | support sub. |
| Radius of curvature of lens spherical surface | mm | 68 | 68 | 92.5 | 43.1 |
| Lens thickness | mm | 7 | 7 | 3.2 | 5 |
| Observed image | — | A | A | A | A |
| Image contrast | — | 0.74 | 0.74 | 0.8 | 0.73 |
| Number of lens with delamination after reliability test | of 5 lens | 5 | 5 | 5 | 5 |
| Number of lens with cracks after reliability test | of 5 lens | 1 | 3 | 0 | 1 |
| Appearance after cold heat cycle test | of 10 lens | 2 | 3 | 1 | 2 |

| | | | Comp. | Comp. | Comp. |
|---|---|---|---|---|---|
| | | | Ex. 5 | Ex. 6 | Ex. 7 |
| Resin Composition | | — | L | B | C |
| Silane coupling | Between resin lens and adhesive layer | — | Present | Absent | Absent |
| agent layer | Between adhesive layer and polarizer | — | Absent | Absent | Absent |

| | | | | |
|---|---|---|---|---|
| Flexural strength | MPa | 130 | 95 | 98 |
| Flexural modulus | MPa | 3300 | 3170 | 3600 |
| Glass transition temperature (Tg) | | 109 | 119 | 127 |
| Absolute value of photoelastic coefficient | ×10¹² Pa⁻¹ | 2.7 | 5.1 | 3.3 |
| Phase difference within effective diameter of resin lens | nm | 20 | 6 | 4 |
| Effective diameter internal transmittance of resin lens | % | 94.1 | 95.7 | 95.3 |
| Types of reflective polarizers | — | Wire grid | Wire grid | Wire grid |
| Bonding surface of reflective polarizer | — | Surface of | Surface of | Surface of |
| | | support sub. | support sub. | support sub. |
| Radius of curvature of lens spherical surface | mm | 66.9 | 66.9 | 66.9 |
| Lens thickness | mm | 4 | 4 | 4 |
| Observed image | — | C | A | A |
| Image contrast | — | 0.67 | 0.78 | 0.77 |
| Number of lens with delamination after reliability test | of 5 lens | 3 | 5 | 5 |
| Number of lens with cracks after reliability test | of 5 lens | 5 | 2 | 1 |
| Appearance after cold heat cycle test | of 10 lens | 4 | 2 | 2 |

TABLE 8

| | | | Comp. | Comp. | Comp. | Comp. | Comp. |
|---|---|---|---|---|---|---|---|
| | | | Ex. 8 | Ex. 9 | Ex. 10 | Ex. 11 | Ex. 12 |
| Resin Composition | | — | D | E | F | G | H |
| Silane coupling | Between resin lens and adhesive layer | — | Absent | Absent | Absent | Absent | Absent |
| agent layer | Between adhesive layer and polarizer | — | Absent | Absent | Absent | Absent | Absent |

| Flexural strength | MPa | 117 | 59 | 103 | 110 | 127 |
|---|---|---|---|---|---|---|
| Flexural modulus | MPa | 3500 | 3500 | 3200 | 3200 | 3570 |
| Glass transition temperature (Tg) | ° C. | 134 | 154 | 118 | 125 | 123 |
| Absolute value of photoelastic coefficient | ×10¹² Pa⁻¹ | 5.9 | 5.3 | 4.8 | 0.1 | 3.3 |
| Phase difference within effective diameter of resin lens | nm | 10 | 8 | 7 | 8 | 5 |
| Effective diameter internal transmittance of resin lens | % | 94.7 | 94.3 | 95.2 | 95.4 | 95.7 |
| Types of reflective polarizers | — | Wire grid | Wire grid | Wire grid | Wire grid | Wire grid |
| Bonding surface of reflective polarizer | — | Surface of | Surface of | Surface of | Surface of | Surface of |
| | | support sub. | support sub. | support sub. | support sub | support sub. |
| Radius of curvature of lens spherical surface | mm | 66.9 | 66.9 | 66.9 | 66.9 | 66.9 |
| Lens thickness | mm | 4 | 4 | 4 | 4 | 4 |
| Observed image | — | A | A | B | B | B |
| Image contrast | — | 0.7 | 0.73 | 0.72 | 0.73 | 0.75 |
| Number of lens with delamination after reliability test | of 5 lens | 5 | 5 | 5 | 4 | 5 |
| Number of lens with cracks after reliability test | of 5 lens | 0 | 0 | 1 | 0 | 0 |
| Appearance after cold heat cycle test | of 10 lens | 1 | 1 | 2 | 3 | 7 |

| | | | Comp. | Comp. | Comp. | Comp. |
|---|---|---|---|---|---|---|
| | | | Ex. 13 | Ex. 14 | Ex. 15 | Ex. 16 |
| Resin Composition | | — | I | J | K | A |
| Silane coupling | Between resin lens and adhesive layer | — | Absent | Absent | Absent | Absent |
| agent layer | Between adhesive layer and polarizer | — | Absent | Absent | Absent | Absent |

| Flexural strength | MPa | 71 | 77 | 115 | 66 |
|---|---|---|---|---|---|
| Flexural modulus | MPa | 3600 | 3350 | 2410 | 3400 |
| Glass transition temperature (Tg) | ° C. | 133 | 137 | 143 | 133 |
| Absolute value of photoelastic coefficient | ×10¹² Pa⁻¹ | 15 | 9.4 | 6.5 | 0.2 |
| Phase difference within effective diameter of resin lens | nm | 29 | 2.7 | 39 | 5 |
| Effective diameter internal transmittance of resin lens | % | 95.3 | 93.7 | 92.1 | 93.5 |
| Types of reflective polarizers | — | Wire grid | Wire grid | Wire grid | Laminated type |
| Bonding surface of reflective polarizer | — | Surface of | Surface of | Surface of | — |
| | | support sub. | support sub. | support sub. | |
| Radius of curvature of lens spherical surface | mm | 66.9 | 66.9 | 66.9 | 68 |
| Lens thickness | mm | 4 | 4 | 4 | 7 |
| Observed image | — | C | B | D | A |
| Image contrast | — | 0.6 | 0.78 | 0.55 | 0.79 |
| Number of lens with delamination after reliability test | of 5 lens | 5 | 5 | 5 | 5 |
| Number of lens with cracks after reliability test | of 5 lens | 0 | 2 | 3 | 1 |
| Appearance after cold heat cycle test | of 10 lens | 1 | 6 | 8 | 7 |

From Tables 5 to 8, it is evident that at least one of delamination and cracking of the reflective polarizer was suppressed even after a reliability test under a severe high-temperature and humidity-condition in the reflective polarizer bonded lens satisfying the requirements of the present disclosure.

This application claims priority to Japanese Patent Application No. 2024-125188 filed on July, 31, 2024, the entire contents of which are incorporated by reference herein.

### INDUSTRIAL APPLICABILITY

The reflective polarizer bonded lens according to the present disclosure can be suitably used as an eyepiece optical system for head-mounted displays, microscopes, electronic viewfinders, and the like.

### REFERENCE SIGNS LIST

11 Image display device
12 Circular polarizer
13 Half mirror
14 Lens
15 Quarter-wave plate
16 Reflective polarizer
21 Reflective polarizer bonded lens
22 Resin lens
23 Reflective polarizer
24 Adhesive layer
25 Silane coupling reagent layer
30 Wire grid reflective polarizer
31 Support substrate
32 Resin substrate
33 Lattice-shaped protruding portion
34 Substrate layer
36 Dielectric layer
37 Metal wire
39 Adhesive layer
40 Smartphone
41 Resin lens
42 Reflective polarizer
43 Circular polarizer
44 Half mirror
45 Quarter wave plate
46 Reflective polarizer bonded lens
47 Circular polarizer
48 Digital single-lens reflex camera
49 Light-shielding part

1. A reflective polarizer bonded lens comprising:
a resin lens having a first surface and a second surface on opposite sides;
a reflective polarizer bonded to at least one of the first surface and the second surface;
an adhesive layer provided between the resin lens and the reflective polarizer; and
a silane coupling reagent layer provided at least one of between the resin lens and the adhesive layer, and between the adhesive layer and the reflective polarizer,
wherein a glass transition temperature (Tg) of the resin composition that forms the resin lens is 115° C. to 160° C.

2. The reflective polarizer bonded lens according to claim 1, wherein the resin lens has an absolute value of a photoelastic coefficient of 10×10⁻¹² Pa⁻¹ or less.

3. The reflective polarizer bonded lens according to claim 1, wherein the resin lens is made of a thermoplastic resin composition having an aryl group or an alicyclic group in a main chain or side chain thereof.

4. The reflective polarizer bonded lens according to claim 1, wherein the surface at which the resin lens and the reflective polarizer are bonded is a convex or concave surface in a region including an optical axis, and an absolute value of a reference radius of curvature R is 10 mm or more and 500 mm or less.

5. The reflective polarizer bonded lens according to claim 1, wherein the resin composition includes a methacrylic resin.

6. The reflective polarizer bonded lens according to claim 5, wherein the methacrylic resin includes a methacrylic resin having a structural unit with a cyclic structure.

7. The reflective polarizer bonded lens according to claim 6, wherein the structural unit includes at least one structural unit selected from the group consisting of a structural unit derived from an N-substituted maleimide monomer, a glutarimide-based structural unit, an aromatic vinyl structural unit, an alicyclic vinyl structural unit, and a lactone ring structural unit.

8. The reflective polarizer bonded lens according to claim 7, wherein the structural unit includes a structural unit derived from an N-substituted maleimide monomer.

9. The reflective polarizer bonded lens according to claim 1, wherein the resin lens is made of a resin composition including a cyclic olefin copolymer that is a copolymer of ethylene or an α-olefin and a cyclic olefin.

10. The reflective polarizer bonded lens according to claim 9, wherein a proportion of the ring skeleton structural unit derived from the cyclic olefin in the main chain of the cyclic olefin copolymer is 36 mol % or more and 50 mol % or less.

11. The reflective polarizer bonded lens according to claim 10, wherein the structural unit derived from the cyclic olefin in the cyclic olefin copolymer is a structural unit derived from at least one compound selected from bicyclo[2.2.1]-2-heptene and tetracyclo[4.4.0.1^{2,5}.1^{7,10}]-3-dodecene.

12. The reflective polarizer bonded lens according to claim 1, wherein the resin lens is made of a resin composition including a hydrogenated product of a ring-opening polymer of a norbornene-based monomer.

13. The reflective polarizer bonded lens according to claim 12, wherein the resin composition including the hydrogenated product of the ring-opening polymer of the norbornene-based monomer contains 20 to 100 mol % of structural units derived from the norbornene-based monomer, and optionally, 0 to 80 mol % of structural units derived from another monomer copolymerizable with the norbornene-based monomer.

14. The reflective polarizer bonded lens according to claim 13, wherein the structural units derived from the norbornene-based monomer include 15 to 50 wt % of structural units derived from a tetracyclododecene-based monomer, 50 to 90 wt % of structural units derived from a methanotetrahydrofluorene-based monomer, and 1 to 15 wt % of structural units derived from a norbornene monomer, provided that a sum of the structural units derived from each monomer is 100 wt % or less.

15. The reflective polarizer bonded lens according to claim 1, wherein the resin composition that forms the resin lens has a flexural strength of 65 MPa or more.

16. The reflective polarizer bonded lens according to claim 1, wherein the reflective polarizer has only one reflective surface that contributes to polarization separation.

17. The reflective polarizer bonded lens according to claim 1, wherein the adhesive layer is an adhesive layer made of an adhering agent that contains no silane coupling reagent.

18. A head-mounted display comprising the reflective polarizer bonded lens according to claim 1.

19. A method for producing a reflective polarizer bonded lens in which a reflective polarizer is bonded to a resin lens,
the resin lens being a resin lens made of a resin composition having a glass transition temperature (Tg) of 115° C. to 160° C.,
the resin lens having a first surface and a second surface on opposite sides, the method comprising:
forming a silane coupling reagent layer on at least one of the resin lens and the reflective polarizer;
providing an adhesive layer on at least one of the resin lens and the reflective polarizer; and
bonding the reflective polarizer to the resin lens.

20. The method for producing a reflective polarizer bonded lens according to claim 19, wherein resin lens is produced by injection molding.

21. The method for producing a reflective polarizer bonded lens according to claim 19, wherein the bonding the reflective polarizer to the resin lens is performed, based on a glass transition temperature (Tg_{film}) of a substrate film forming the reflective polarizer, at a temperature from Tg_{film}−40° C. to Tg_{film}+120° C.
